(19) United States
(12) Patent Application Publication
(10) Pub. No.: US 2025/0183358 A1
(43) Pub. Date: Jun. 5, 2025

(54) INORGANIC SOLID ELECTROLYTE-CONTAINING COMPOSITION, SHEET FOR ALL-SOLID STATE SECONDARY BATTERY, AND ALL-SOLID STATE SECONDARY BATTERY, AND MANUFACTURING METHODS FOR SHEET FOR ALL-SOLID STATE SECONDARY BATTERY AND ALL-SOLID STATE SECONDARY BATTERY

(71) Applicant: FUJIFILM Corporation, Tokyo (JP)

(72) Inventors: Koji YASUDA, Kanagawa (JP); Ikuo KINOSHITA, Kanagawa (JP)

(73) Assignee: FUJIFILM Corporation, Tokyo (JP)

(21) Appl. No.: 19/053,382

(22) Filed: Feb. 13, 2025

Related U.S. Application Data
(63) Continuation of application No. PCT/JP2023/034786, filed on Sep. 25, 2023.

(30) Foreign Application Priority Data
Sep. 30, 2022 (JP) 2022-158086

(51) Int. Cl. H01M 10/056; H01M 10/0525; H01M 10/058

(52) U.S. Cl. CPC H01M 10/056; H01M 10/0525; H01M 10/058; H01M 2300/0091

(57) ABSTRACT

Provided are an inorganic solid electrolyte-containing composition containing an inorganic solid electrolyte, a polymer binder, a compound, and a dispersion medium, in which the inorganic solid electrolyte-containing composition satisfies Conditions (1) to (3); a sheet for an all-solid state secondary battery and an all-solid state secondary battery, which are formed of the inorganic solid electrolyte-containing composition; and manufacturing methods for a sheet for an all-solid state secondary battery and an all-solid state secondary battery.
Condition (1): a mass average molecular weight of polymer constituting polymer binder is 2,000 or more
Condition (2): the compound has at least one specific functional group
Condition (3): a molecular weight of the compound is less than 2.0×10³, and the compound is dissolved in the dispersion medium.

### CROSS-REFERENCE TO RELATED APPLICATIONS

This application is a Continuation of PCT International Application No. PCT/JP2023/034786 filed on Sep. 25, 2023, which claims priority under 35 U.S.C. § 119 (a) to Japanese Patent Application No. 2022-158086 filed in Japan on Sep. 30, 2022. Each of the above applications is hereby expressly incorporated by reference, in its entirety, into the present application.

### BACKGROUND OF THE INVENTION

### 1. Field of the Invention

The present invention relates to an inorganic solid electrolyte-containing composition, a sheet for an all-solid state secondary battery, and an all-solid state secondary battery, and manufacturing methods for a sheet for an all-solid state secondary battery and an all-solid state secondary battery.

### 2. Description of the Related Art

In an all-solid state secondary battery, all of a negative electrode, an electrolyte, and a positive electrode consist of solid, and the all-solid state secondary battery can greatly improve safety and reliability, which are said to be problems to be solved in a battery in which an organic electrolytic solution is used. It is also said to be capable of extending the battery life. Further, the all-solid state secondary battery can be allowed to have a structure in which the electrodes and the electrolyte are directly disposed in series. As a result, it becomes possible to increase the energy density to be high as compared with a secondary battery in which an organic electrolytic solution is used, and thus the application to electric vehicles, large-sized storage batteries, and the like is anticipated.

In an all-solid state secondary battery, as substances that form constitutional layers (a solid electrolyte layer, a negative electrode active material layer, a positive electrode active material layer, and the like), an inorganic solid electrolyte, an active material, a conductive auxiliary agent, and the like are used. In recent years, this inorganic solid electrolyte, particularly an oxide-based inorganic solid electrolyte or a sulfide-based inorganic solid electrolyte is expected as an electrolyte material having a high ion conductivity comparable to that of the organic electrolytic solution.

The constitutional layer formed of such an inorganic solid electrolyte is generally formed of a material (constitutional layer forming material) containing an inorganic solid electrolyte in consideration of improvement of productivity and the like. In this case, a technique of containing a dispersant of an inorganic solid electrolyte or the like for the purpose of improving the dispersibility of the inorganic solid electrolyte in the constitutional layer forming material, the battery performance, and the like is known. For example, JP2016-194759A describes a “material for a positive electrode, containing a positive electrode active material, an inorganic solid electrolyte having an ion conductivity of a metal belonging to Group 1 or Group 2 in the periodic table, a conductive auxiliary agent, and a dispersant containing a compound having at least one specific functional group”.

By the way, since the constitutional layers of the all-solid state secondary battery are formed of solid particles (inorganic solid electrolyte, active material, conductive auxiliary agent, and the like), generally, an interface contact state between the solid particles and an interface contact state between the solid particles and the collector are restricted, and as a result, an interface resistance is likely to increase, and the solid particles cannot be adhered to each other with firm adhesive force. The increase in the interface resistance causes not only an increase in a battery resistance of the all-solid state secondary battery (a decrease in the conductivity of ions or electrons) but also a deterioration in cycle characteristics. In addition, the adhesive force between the solid particles is not sufficient, which causes further deterioration in cycle characteristics. The increase in resistance that causes the deterioration of battery performance is caused not only by the interface contact state of the solid particles but also by the non-uniform presence (disposition) of the solid particles in the constitutional layer and a surface flatness of the constitutional layer. Therefore, in a case where the constitutional layer is formed of a constitutional layer forming material, the constitutional layer forming material is required to have characteristics of stably maintaining excellent dispersibility of the solid particles immediately after preparation (dispersion stability) and characteristics of having high fluidity due to having an appropriate viscosity, thereby being capable of forming a good coating film (handleability).

In order to improve the dispersibility and the adhesive force of the solid particles, it is effective to use a binder such as a polymer binder in combination with the constitutional layer forming material. However, since the binder generally has low conductivity of electrons and ions, in a case where the binder is used in combination, the resistance increases, and it is difficult to achieve both the dispersion stability of the constitutional layer forming material and the suppression of the increase in the resistance of the constitutional layer to be formed.

In such a situation, although JP2016-194759A has not studied from the above viewpoint, various studies have been conducted on a constitutional layer forming material containing an inorganic solid electrolyte and a polymer binder. For example, JP2021-157278A discloses an inorganic solid electrolyte-containing composition for an all-solid state secondary battery, which contains an inorganic solid electrolyte having ion conductivity of a metal belonging to Group 1 or Group 2 in a periodic table, a polymer binder, a metal element-containing compound, and a dispersion medium, in which the metal element-containing compound is a compound capable of supplying a metal element constituting a molecule as an ion to a polymer that forms a polymer binder, the polymer binder is dissolved in the dispersion medium, and the metal element-containing compound is present in a solid state. According to JP2021-157278A, it is described that an inorganic solid electrolyte-containing composition in which a metal element-containing compound that exhibits the above-described function is used in combination with a polymer binder can realize a constitutional layer having low resistance while exhibiting excellent dispersion stability and handleability.

### SUMMARY OF THE INVENTION

An object of the present invention is to provide an inorganic solid electrolyte-containing composition that exhibits excellent dispersion stability and handleability, and that enables the realization of an all-solid state secondary battery having low resistance and excellent cycle characteristics by being used as a constitutional layer forming material of an all-solid state secondary battery. In addition, another object of the present invention is to provide a sheet for an all-solid state secondary battery and an all-solid state secondary battery, and manufacturing methods for a sheet for an all-solid state secondary battery and an all-solid state secondary battery, in which the above inorganic solid electrolyte-containing composition is used.

As a result of repeated studies on an inorganic solid electrolyte-containing composition including an inorganic solid electrolyte and a polymer binder, the present inventors have found that, by using a compound (A) that has a specific functional group and a specific molecular weight and is soluble in a dispersion medium in combination with an inorganic solid electrolyte and a polymer binder having a specific mass average molecular weight, the polymer binder and the compound (A) can realize excellent dispersion stability and handleability by cooperating with each other. In addition, it was found that, by using this inorganic solid electrolyte-containing composition as a constitutional layer forming material, it is possible to realize a sheet for an all-solid state secondary battery, which has a constitutional layer of low resistance in which solid particles are firmly adhered (bound), and furthermore, an all-solid state secondary battery having low resistance and excellent cycle characteristics.

The present invention has been completed through further studies based on these findings.

That is, the above problems have been solved by the following means.

<1> An inorganic solid electrolyte-containing composition including: an inorganic solid electrolyte (SE) having an ion conductivity of a metal belonging to Group 1 or Group 2 in a periodic table; a polymer binder (B); a compound (A); and a dispersion medium (D), in which the inorganic solid electrolyte-containing composition satisfies Conditions (1) to (4),
Condition (1): a mass average molecular weight of a polymer constituting the polymer binder (B) is 2,000 or more,
Condition (2): the compound (A) has at least one functional group selected from the following Group (a) of functional group,
Condition (3): a molecular weight of the compound (A) is less than 2,000, and
Condition (4): the compound (A) is dissolved in the dispersion medium (D),

### [Group (a) of Functional Groups]

A hydroxy group, an amino group, a carboxy group, a sulfonic acid group, a phosphoric acid group, a phosphonic acid group, a cyano group, a thiol group, and a sulfinyl group.

<2> The inorganic solid electrolyte-containing composition according to <1>, in which a content of the compound (A) is 10 ppm or more and 2.0×10³ ppm or less with respect to 100% by mass of a solid content of the inorganic solid electrolyte-containing composition.

<3> The inorganic solid electrolyte-containing composition according to <1> or <2>, in which the polymer binder (B) is dissolved in the dispersion medium (D).

<4> The inorganic solid electrolyte-containing composition according to any one of <1> to <3>, in which a molecular weight of the compound (A) is less than 600.

<5> The inorganic solid electrolyte-containing composition according to any one of <1> to <4>, in which the compound (A) satisfies Condition (5),

Condition (5): a residue obtained by removing the functional group from the compound (A) has the same chemical structure as a terminal group bonded to a hetero linking group in a polymer that constitutes the polymer binder (B).

<6> The inorganic solid electrolyte-containing composition according to any one of <1> to <5>, in which the polymer binder (B) is a (meth)acrylic polymer.

<7> The inorganic solid electrolyte-containing composition according to any one of <1> to <6>, further including an active material (AC).

<8> A sheet for an all-solid state secondary battery, comprising a layer formed of the inorganic solid electrolyte-containing composition according to any one of <1> to <7>.

<9> An all-solid state secondary battery including, in the following order: a positive electrode active material layer; a solid electrolyte layer; and a negative electrode active material layer,
in which at least one of the positive electrode active material layer, the solid electrolyte layer, or the negative electrode active material layer is a layer formed of the inorganic solid electrolyte-containing composition according to any one of <1> to <7>.

<10> A manufacturing method for a sheet for an all-solid state secondary battery, the manufacturing method including: forming a film of the inorganic solid electrolyte-containing composition according to any one of <1> to <7>.

<11> A manufacturing method for an all-solid state secondary battery, the manufacturing method including: manufacturing an all-solid state secondary battery through the manufacturing method according to <10>.

The present invention can provide an inorganic solid electrolyte-containing composition that exhibits excellent dispersion stability and handleability and enables the realization of an all-solid state secondary battery having low resistance and excellent cycle characteristics. In addition, according to the present invention, it is possible to provide a sheet for an all-solid state secondary battery and an all-solid state secondary battery, which have a layer formed of this excellent inorganic solid electrolyte-containing composition. Further, according to the present invention, it is possible to provide manufacturing methods for a sheet for an all-solid state secondary battery and an all-solid state secondary battery, in which the above inorganic solid electrolyte-containing composition is used.

The above-described and other characteristics and advantages of the present invention will be further clarified by the following description with appropriate reference to the accompanying drawing.

### BRIEF DESCRIPTION OF THE DRAWINGS

FIG. 1 is a vertical cross-sectional view schematically illustrating an all-solid state secondary battery according to a preferred embodiment of the present invention.

FIG. 2 is a vertical cross-sectional view schematically illustrating a coin-type all-solid state secondary battery prepared in Examples.

### DESCRIPTION OF THE PREFERRED EMBODIMENTS

In the present invention, in a case where a numerical value range is shown to describe a content, physical properties, or the like of a component, any upper limit value and any lower limit value can be appropriately combined to obtain a specific numerical value range in a case where an upper limit value and a lower limit value of the numerical value range are described separately. On the other hand, in a case where a plurality of numerical value ranges represented by using “to” are set to make a description, the upper limit value and the lower limit value, which form each of the numerical value ranges, are not limited to a specific combination described before and after “to” as a specific numerical value range and can be set to a numerical value range obtained by appropriately combining the upper limit value and the lower limit value of each numerical value range. In the present invention, the numerical value range indicated by using “to” means a range including the numerical values before and after “to” as the lower limit value and the upper limit value, respectively.

In the present invention, an expression regarding a compound (for example, in a case where a compound is represented by an expression in which “compound” is attached to the end) is used to have a meaning including not only the compound itself but also a salt or an ion thereof. In addition, this expression has a meaning including a derivative obtained by modifying a part of the compound, for example, by introducing a substituent into the compound within a range where the effect of the present invention is not impaired.

In the present invention, (meth)acryl means one or both of acryl and methacryl. The same applies to (meth)acrylate.

In the present invention, a substituent, a linking group, or the like (hereinafter, referred to as a substituent or the like), which is not specified regarding whether to be substituted or unsubstituted, may have an appropriate substituent. Accordingly, even in a case where a YYY group is simply described in the present invention, this YYY group includes not only an aspect having a substituent but also an aspect not having a substituent. The same shall be applied to a compound which is not specified in the present specification regarding whether to be substituted or unsubstituted. Examples of a preferable substituent include a group selected from the substituent Z described below.

In the present invention, in a case where a plurality of substituents or the like represented by a specific reference numeral are present or a plurality of substituents or the like are simultaneously or alternatively defined, the respective substituents or the like may be the same as or different from each other. In addition, unless specified otherwise, in a case where a plurality of substituents or the like are adjacent to each other, the substituents may be linked or fused to each other to form a ring.

In the present invention, unless specified otherwise, “ppm” representing a content or the like is based on mass and represents “mass ppm”.

In the present invention, the polymer means a polymer; however, it has the same meaning as a so-called polymeric compound. In addition, a polymer binder (also simply referred to as a binder) means a binder constituted by a polymer, and it includes a polymer itself and a binder composed (formed) to contain a polymer.

In the present invention, the main chain of each of the polymer and the polymerized chain refers to a linear molecular chain in which all the molecular chains that constitute the polymer or the polymerized chain other than the main chain can be conceived as a branched chain or a pendant group with respect to the main chain. Although it depends on the mass average molecular weight of the branched chain regarded as a branched chain or pendant group, the longest chain among the molecular chains that constitute the polymer or the polymerized chain is typically the main chain. However, the main chain does not include a terminal group that is provided in the terminal of the polymer or the polymerized chain. In addition, side chains of the polymer refer to branched chains other than the main chain and include a short chain and a long chain.

### [Inorganic Solid Electrolyte-Containing Composition]

The inorganic solid electrolyte-containing composition according to the embodiment of the present invention contains an inorganic solid electrolyte (SE) having an ion conductivity of a metal belonging to Group 1 or Group 2 in the periodic table, a polymer binder (B), a compound (A), and a dispersion medium (D), and satisfies conditions (1) to (4) described later. This inorganic solid electrolyte-containing composition exhibits excellent dispersion stability and handleability, and an all-solid state secondary battery having a constitutional layer formed of this inorganic solid electrolyte-containing composition has low resistance and excellent cycle characteristics.

Although the details of the reason for the above are not yet clear, they are considered to be as follows.

In the inorganic solid electrolyte-containing composition, since the polymer binder (B) is constituted by a polymer having a specific molecular weight (Condition (1)), the molecular chain is likely to spread in the dispersion medium (D), and the adsorbed solid particles are repelled from each other to suppress (re)aggregation or sedimentation, whereby the dispersibility can be improved. In addition, since the compound (A) has a specific functional group (Condition (2)), it is considered that the compound (A) is adsorbed to solid particles such as an inorganic solid electrolyte and is dissolved in the dispersion medium (D) due to having a specific molecular weight (Condition (3) and Condition (4)), and thus an interaction with the polymer binder (B) is exhibited by a basic skeleton (a residue excluding the functional group) other than the functional group. As a result, it is presumed that the compound (A) reinforces the action of improving the dispersibility of the polymer binder (D) with respect to the solid particles in the dispersion medium (D), and the inorganic solid electrolyte-containing composition according to the embodiment of the present invention exhibits excellent initial dispersibility and dispersion stability and also exhibits appropriate fluidity due to the synergistic action of the polymer binder (B) and the compound (A), which suppresses (re)aggregation and precipitation of the solid particles immediately after the preparation and after a lapse of time.

In addition, in the inorganic solid electrolyte-containing composition exhibiting the above-described effect, in the film forming process, the direct contact between the solid particles (contact without the interposition of the binder) can be maintained without significantly impairing the firm adhesion between the solid particles. In addition, it is possible to form a constitutional layer in which unevenness on the surface caused by insufficient or excessive flow, unevenness on the surface caused by clogging in a discharge part during coating, and the like are suppressed while appropriately flowing (leveling) and suppressing uneven distribution of solid particles. Therefore, it is considered that the inorganic solid electrolyte-containing composition according to the embodiment of the present invention can form a constitutional layer in which the interface resistance is reduced by constructing a sufficient conduction path (an ion conduction path and an electron conduction path) over the entire constitutional layer while firmly adhering or binding the solid particles to each other and maintaining the contact between the solid particles while suppressing uneven distribution. This constitutional layer can hardly cause the occurrence of an overcurrent during charging and discharging of the all-solid state secondary battery, can also prevent the deterioration of the solid particles, and can suppress the deterioration of the battery characteristics of the all-solid state secondary battery with the passage of time.

In a case where the inorganic solid electrolyte-containing composition according to the embodiment of the present invention, which exhibits the above-described action, is used as a constitutional layer forming material, it is possible to manufacture a sheet for an all-solid state secondary battery, which has a constitutional layer of low resistance in which solid particles are firmly adhered, and furthermore, an all-solid state secondary battery that exhibits low resistance and excellent cycle characteristics.

In the inorganic solid electrolyte-containing composition according to the embodiment of the present invention, it is considered that the polymer binder (B) is adsorbed to the inorganic solid electrolyte (SE) and further to the active material (AC) and interposed between the solid particles to exhibit a function of dispersing the solid particles in the dispersion medium (D). Here, the adsorption of the polymer binder (B) to each of the solid particles is not particularly limited; however, it includes not only physical adsorption but also chemical adsorption (adsorption by chemical bond formation, adsorption by transfer of electrons, or the like). In addition, the compound (A) is considered to reinforce the adsorption between the polymer binder (B) and the solid particles, and the compound (A) may be present alone in the inorganic solid electrolyte-containing composition, but it is preferable that the compound (A) interacts with the polymer binder (B) or is adsorbed to the solid particles.

On the other hand, the polymer binder (B) functions in the constitutional layer as a binder that binds the solid particles. In addition, it may also function as a binder that binds a collector to solid particles. It is considered that the compound (A) reinforces the adsorption between the polymer binder (B) and the solid particles even in the constitutional layer, and thus the compound (A) may be present alone, but it is preferable that the compound (A) interacts with the polymer binder (B) or adsorbs to the solid particles.

In the inorganic solid electrolyte-containing composition according to the embodiment of the present invention and the constitutional layer, the compound (A) is considered to interact with the polymer binder (B) and to be adsorbed to the solid particles, thereby exhibiting a function of reinforcing the adsorption of the polymer binder (B) to the solid particles. Here, the adsorption of the compound (A) to the polymer binder (B) is not particularly limited; however, it includes physical adsorption and chemical adsorption (adsorption by intermolecular force, adsorption by transfer of electrons, and the like). In addition, the adsorption of the compound (A) to the solid particles is not particularly limited, but includes physical adsorption and chemical adsorption (adsorption by chemical bond formation, adsorption by transfer of electrons, and the like).

As described above, the inorganic solid electrolyte-containing composition according to the embodiment of the present invention satisfies the following Conditions (1) to (4). Each condition can also be said to be a condition that is satisfied by the compound (A) with respect to the inorganic solid electrolyte (SE), the polymer binder (B), and the dispersion medium (D).

Hereinafter, each of the conditions will be described.

Condition (1): a mass average molecular weight of a polymer constituting the polymer binder (B) is 2,000 or more.

In the inorganic solid electrolyte-containing composition according to the embodiment of the present invention, in a case where the Condition (1) is combined with the other conditions described later, the molecular chain (molecular structure) of the polymer (b) constituting the polymer binder (B) in the dispersion medium (D) is spread, and the aggregation of the solid particles is further suppressed, whereby the dispersion characteristics (initial dispersibility and dispersion stability) can be further improved. The mass average molecular weight of the polymer (b) is preferably 50,000 or more, more preferably 100,000 or more, and still more preferably 200,000 or more, from the viewpoint that further improvement of dispersion characteristics can be realized. On the other hand, the mass average molecular weight is preferably 1,000,000 or less, more preferably 800,000 or less, and still more preferably 600,000 or less, from the viewpoint that excessive coating of the surface of the solid particles can be suppressed and a sufficient conduction path can be constructed.

The mass average molecular weight of the polymer (b) can be appropriately adjusted by changing the kind, content, polymerization time, polymerization temperature, and the like of the polymerization initiator.

### Measurement of Molecular Weight

In the present invention, unless specified otherwise, molecular weights of the polymer, the polymer chain, the polymerized chain, and a macromonomer refer to a mass average molecular weight and number average molecular weight in terms of standard polystyrene conversion, which are determined by gel permeation chromatography (GPC). The measurement method thereof includes, basically, a method in which conditions are set to the following measurement condition 1 or the following measurement condition 2 (which is preferential). In this case, an appropriate eluent may be selected and used depending on the type of the polymer and the like.

### (Measurement Condition 1)

Column: two columns of TOSOH TSKgel Super AWM-H (product name, manufactured by Tosoh Corporation) are connected.
Carrier: 10 mM LiBr/N-methylpyrrolidone
Measurement temperature: 40° C.
Carrier flow rate: 1.0 ml/min
Sample concentration: 0.1% by mass
Detector: refractive index (RI) detector

### (Measurement Condition 2)

Column: a column obtained by connecting TOSOH TSKgel Super HZM-H, TOSOH TSKgel Super HZ4000, and TOSOH TSKgel Super HZ2000 (all of which are product names, manufactured by Tosoh Corporation) is used.
Carrier: tetrahydrofuran
Measurement temperature: 40° C.
Carrier flow rate: 1.0 ml/min
Sample concentration: 0.1% by mass
Detector: refractive index (RI) detector

Condition (2): the compound (A) has at least one functional group selected from the following Group (a) of functional groups.

### [Group (a) of Functional Groups]

A hydroxy group, an amino group, a carboxy group, a sulfonic acid group, a phosphoric acid group, a phosphonic acid group, a cyano group, a thiol group, and a sulfinyl group.

In the inorganic solid electrolyte-containing composition according to the embodiment of the present invention, in a case where the Condition (2) is combined with the other conditions, it is considered that the adsorption force of the compound (A) with respect to the solid particles is increased, the adsorptivity between the polymer binder (B) and the solid particles is reinforced, and the function of improving the dispersibility of the polymer binder (B) in the dispersion medium (D) can be further enhanced.

Details of the Condition (2) will be described later.

Condition (3): A Molecular Weight of the Compound (A) is Less than 2,000.

In the inorganic solid electrolyte-containing composition according to the embodiment of the present invention, it is considered that in a case where the Condition (3) is combined with the other conditions, the interaction with the polymer binder (B) is exhibited, and the function of improving the dispersibility of the polymer binder (B) in the dispersion medium (D) can be reinforced. From the viewpoint of further reinforcing the function of improving the dispersibility of the polymer binder (B), the molecular weight of the compound (A) is preferably 1,000 or less, more preferably less than 600, still more preferably less than 500, and particularly preferably 300 or less. The lower limit of the molecular weight of the compound (A) is not particularly limited and can be appropriately set. For example, the lower limit of the molecular weight of the compound (A) can be set to 100 or more and is preferably 150 or more.

In a case where the compound (A) is a polymer, the molecular weight thereof means the mass average molecular weight measured in the same manner as the polymer binder (B). In this case, the mass average molecular weight can be appropriately adjusted by changing the kind, content, polymerization time, polymerization temperature, and the like of the polymerization initiator.

### Condition (4): The Compound (A) is Dissolved in the Dispersion Medium (D).

The compound (A) contained in the inorganic solid electrolyte-containing composition according to the embodiment of the present invention exhibits a characteristic (solubility) of being dissolved in the dispersion medium (D). The compound (A) in the inorganic solid electrolyte-containing composition depends on the content of the dispersion medium (D), but is generally present in a state of being dissolved in the dispersion medium (D) in the inorganic solid electrolyte-containing composition.

In the inorganic solid electrolyte-containing composition according to the embodiment of the present invention, in a case where the Condition (4) is combined with the Conditions (1) to (3), the polymer binder (B) is easily adsorbed in the dispersion medium (D), and the function of improving the dispersibility of the polymer binder (B) can be reinforced.

In the present invention, the solubility of the compound (A) in the dispersion medium (D) can be appropriately imparted depending on the kind of the compound (A), the molecular weight of the compound (A), the kind or content of the functional group selected from the group (a) of functional groups described later, the combination with the dispersion medium (D), and the like.

In the present invention, the expression that the compound (A) is dissolved in the dispersion medium (D) means that the compound (A) is dissolved in the dispersion medium (D) in the inorganic solid electrolyte-containing composition, and for example, it means that the solubility is 10% by mass or more in the solubility measurement. On the contrary, the fact that the compound (A) is not dissolved (insoluble) in the dispersion medium (D) means that the solubility is less than 10% by mass in the solubility measurement.

A measuring method for solubility is as follows. That is, about 0.1 g of the compound (A) is precisely weighed, and the precisely weighed mass is defined as W0. Next, 10 g of a dispersion medium having the same composition as the dispersion medium (D) contained in the inorganic solid electrolyte-containing composition is put into a container together with the compound (A), and the mixture is mixed with a mix rotor (model number: VMR-5, manufactured by AS ONE Corporation) at a temperature of 25° C. and a rotation speed of 100 rpm for 48 hours. Then, the insoluble substance is filtered from the solution, the obtained solid is subjected to vacuum drying at 120° C. for 3 hours, and then the mass W1 of the insoluble substance is precisely weighed. Then, the solubility (%) in the dispersion medium (D) is calculated according to the following equation, and the obtained value is defined as the solubility of the compound (A) in the dispersion medium (D).

Solubility (%)=(W0−W1)/W0×100

The inorganic solid electrolyte-containing composition according to the embodiment of the present invention is preferably a slurry in which the inorganic solid electrolyte (SE) is dispersed in the dispersion medium (D).

The inorganic solid electrolyte-containing composition according to the embodiment of the present invention is preferably a non-aqueous composition. In the present invention, the non-aqueous composition includes not only an aspect including no watery moisture but also an aspect where the moisture content (also referred to as the “watery moisture content”) is preferably 500 ppm or less. In the non-aqueous composition, the moisture content is more preferably 200 ppm or less, still more preferably 100 ppm or less, and particularly preferably 50 ppm or less. In a case where the inorganic solid electrolyte-containing composition is a non-aqueous composition, it is possible to suppress the deterioration of the inorganic solid electrolyte. The water content refers to the water amount (the mass proportion to the inorganic solid electrolyte-containing composition) in the inorganic solid electrolyte-containing composition, and specifically, it is a value measured by carrying out filtration through a 0.02 μm membrane filter and then Karl Fischer titration.

The inorganic solid electrolyte-containing composition according to the embodiment of the present invention exhibits the above-described excellent characteristics, and thus can be preferably used as a material for forming a constitutional layer of a sheet for an all-solid state secondary battery and an all-solid state secondary battery. Among the constitutional layers, the solid electrolyte layer and the active material layer, in particular, the positive electrode active material layer and the negative electrode active material layer containing a negative electrode active material having a large expansion and contraction during charging and discharging can be preferably used as a material for forming the negative electrode active material layer.

The inorganic solid electrolyte-containing composition according to the embodiment of the present invention also includes an aspect in which an active material and the like are contained in addition to the inorganic solid electrolyte (the composition in this aspect may be referred to as the “electrode composition”).

Hereinafter, components that are contained and components that can be contained in the inorganic solid electrolyte-containing composition according to the embodiment of the present invention will be described.

### <Inorganic Solid Electrolyte>

The inorganic solid electrolyte-containing composition according to the embodiment of the present invention contains an inorganic solid electrolyte.

In the present invention, the inorganic solid electrolyte is an inorganic solid electrolyte, where the solid electrolyte refers to a solid-form electrolyte capable of migrating ions therein. The inorganic solid electrolyte is clearly distinguished from the organic solid electrolyte (the polymeric electrolyte such as polyethylene oxide (PEO) or the organic solid electrolyte salt such as lithium bis(trifluoromethanesulfonyl)imide (LiTFSI)) since it does not include any organic substance as a principal ion-conductive material. In addition, the inorganic solid electrolyte is solid in a steady state and thus, typically, is not dissociated or liberated into cations and anions. In terms of this fact, the inorganic solid electrolyte is also clearly distinguished from inorganic electrolyte salts of which cations and anions are dissociated or liberated in electrolytic solutions or polymers (LiPF₆, LiBF₄, lithium bis(fluorosulfonyl)imide (LiFSI), LiCl, and the like). The inorganic solid electrolyte is not particularly limited as long as it has an ion conductivity of a metal belonging to Group 1 or Group 2 in the periodic table and generally does not have electron conductivity.

As the inorganic solid electrolyte, a solid electrolyte material that is typically used for an all-solid state secondary battery can be appropriately selected and used. Examples of the inorganic solid electrolyte include (i) a sulfide-based inorganic solid electrolyte, (ii) an oxide-based inorganic solid electrolyte, (iii) a halide-based inorganic solid electrolyte, and (iv) a hydride-based inorganic solid electrolyte. The sulfide-based inorganic solid electrolytes are preferably used from the viewpoint that it is possible to form a more favorable interface between the active material and the inorganic solid electrolyte.

In a case where the all-solid state secondary battery according to the embodiment of the present invention is a lithium ion battery, the inorganic solid electrolyte preferably has a lithium ion conductivity.

### (i) Sulfide-Based Inorganic Solid Electrolyte

The sulfide-based inorganic solid electrolyte is preferably an electrolyte that contains a sulfur atom, has an ion conductivity of a metal belonging to Group 1 or Group 2 in the periodic table, and has electron-insulating properties. The sulfide-based inorganic solid electrolytes are preferably inorganic solid electrolytes which contain, as elements, at least Li, S, and P and have a lithium ion conductivity; however, the sulfide-based inorganic solid electrolytes may appropriately include elements other than Li, S, and P.

Examples of the sulfide-based inorganic solid electrolyte include an inorganic solid electrolyte having an ion conductivity of the lithium ion, which satisfies a composition represented by the following Formula (S1).

Lₐ₁M_{b1}P_{c1}S_{d1}Aₑ₁ (S1)

In Formula (S1), L represents an element selected from Li, Na, or K and is preferably Li. M represents an element selected from B, Zn, Sn, Si, Cu, Ga, Sb, Al, or Ge. A represents an element selected from I, Br, Cl, or F. a1 to e1 represent the compositional ratios between the respective elements, and a1:b1:c1:d1:e1 satisfies 1 to 12:0 to 5:1:2 to 12:0 to 10. a1 is preferably 1 to 9 and more preferably 1.5 to 7.5. b1 is preferably 0 to 3 and more preferably 0 to 1. d1 is preferably 2.5 to 10 and more preferably 3.0 to 8.5. e1 is preferably 0 to 5 and more preferably 0 to 3.

The compositional ratios among the respective elements can be controlled by adjusting the amounts of raw material compounds blended to manufacture the sulfide-based inorganic solid electrolyte as described below.

The sulfide-based inorganic solid electrolyte may be non-crystalline (glass) or crystallized (made into glass ceramic) or may be only partially crystallized. For example, it is possible to use Li—P—S-based glass containing Li, P, and S or Li—P—S-based glass ceramic containing Li, P, and S.

The sulfide-based inorganic solid electrolytes can be manufactured by a reaction of at least two or more raw materials of, for example, lithium sulfide (Li₂S), phosphorus sulfide (for example, diphosphorus pentasulfide (P₂S₅)), a phosphorus single body, a sulfur single body, sodium sulfide, hydrogen sulfide, lithium halides (for example, LiI, LiBr, and LiCl), or sulfides of an element represented by M described above (for example, SiS₂, SnS, and GeS₂).

The ratio between Li₂S and P₂S₅ in each of Li—P—S-based glass and Li—P—S-based glass ceramic is preferably 60:40 to 90:10 and more preferably 68:32 to 78:22 in terms of the molar ratio between Li₂S:P₂S₅. In a case where the ratio between Li₂S and P₂S₅ is set in the above-described range, it is possible to increase a lithium ion conductivity. Specifically, the lithium ion conductivity can be preferably set to 1×10⁻⁴ S/cm or more and more preferably set to 1×10⁻³ S/cm or more. The upper limit is not particularly limited; however, it is realistically 1×10⁻¹ S/cm or less.

As specific examples of the sulfide-based inorganic solid electrolytes, combination examples of raw materials will be described below. Examples thereof include Li₂S—P₂S₅, Li₂S—P₂S₅—LiCl, Li₂S—P₂S₅—H₂S, Li₂S—P₂S₅—H₂S—LiCl, Li₂S—LiI—P₂S₅, Li₂S—LiI—Li₂O—P₂S₅, Li₂S—LiBr—P₂S₅, Li₂S—Li₂O—P₂S₅, Li₂S—Li₃PO₄—P₂S₅, Li₂S—P₂S₅—P₂O₅, Li₂S—P₂S₅—SiS₂, Li₂S—P₂S₅—SiS₂—LiCl, Li₂S—P₂S₅—SnS, Li₂S—P₂S₅—Al₂S₃, Li₂S—GeS₂, Li₂S—GeS₂—ZnS, Li₂S—Ga₂S₃, Li₂S—GeS₂—Ga₂S₃, Li₂S—GeS₂—P₂S₅, Li₂S—GeS₂—Sb₂S₅, Li₂S—GeS₂—Al₂S₃, Li₂S—SiS₂, Li₂S—Al₂S₃, Li₂S—SiS₂—Al₂S₃, Li₂S—SiS₂—P₂S₅, Li₂S—SiS₂—P₂S₅—LiI, Li₂S—SiS₂—LiI, Li₂S—SiS₂—Li₄SiO₄, Li₂S—SiS₂—Li₃PO₄, and Li₁₀GeP₂Si₂. The mixing ratio between the individual raw materials does not matter. Examples of the method of synthesizing a sulfide-based inorganic solid electrolyte material using the above-described raw material compositions include an amorphorization method. Examples of the amorphorization method include a mechanical milling method, a solution method, and a melting quenching method. This is because treatments at a normal temperature become possible, and it is possible to simplify manufacturing processes.

### (ii) Oxide-Based Inorganic Solid Electrolyte

The oxide-based inorganic solid electrolyte is preferably an electrolyte that contains an oxygen atom, has an ion conductivity of a metal belonging to Group 1 or Group 2 in the periodic table, and has electron-insulating properties.

The ion conductivity of the oxide-based inorganic solid electrolyte is preferably 1×10⁻⁶ S/cm or more, more preferably 5×10⁻⁶ S/cm or more, and particularly preferably 1×10⁻⁵ S/cm or more. The upper limit is not particularly limited, but it is practically 1×10⁻¹ S/cm or less.

Specific examples of the compound include LiₓₐLa_{ya}TiO₃ (LLT) [xa satisfies 0.3≤xa≤0.7, and ya satisfies 0.3≤ya≤0.7]; Li_{xb}La_{yb}Zr_{zb}M^{bb}_{mb}O_{nb} (M^{bb} is one or more elements selected from Al, Mg, Ca, Sr, V, Nb, Ta, Ti, Ge, In, and Sn. xb satisfies 5≤xb≤10, yb satisfies 1≤yb≤4, zb satisfies 1≤zb≤4, mb satisfies 0≤mb≤2, and nb satisfies 5≤nb≤20); Li_{xc}B_{yc}M^{cc}_{zc}O_{nc} (M^{cc} is one or more elements selected from C, S, Al, Si, Ga, Ge, In, and Sn. xc satisfies 0<xc≤5, ye satisfies 0<yc≤1, zc satisfies 0<zc≤1, and nc satisfies 0<nc≤6); Li_{xd}(Al, Ga)_{yd}(Ti, Ge)_{zd}Si_{ad}P_{md}O_{nd} (xd satisfies 1≤xd≤3, yd satisfies 0≤yd≤1, zd satisfies 0≤zd≤2 ad satisfies 0≤ad≤1, md satisfies 1≤md≤7 and nd satisfies 3≤nd≤13.); Li₍₃₋₂ₓₑ)M^{ee}ₓₑD^{ee}O (xe represents a number of 0 or more and 0.1 or less, and M^{ee} represents a divalent metal atom. D^{ee} represents a halogen atom or a combination of two or more halogen atoms); Li_{xf}Si_{yf}O_{zf} (xf satisfies 1≤xf≤5, yf satisfies 0<yf≤3, zf satisfies 1≤zf≤10); Li_{xg}S_{yg}O_{zg} (xg satisfies 1≤xg≤3, yg satisfies 0<yg≤2, zg satisfies 1≤zg≤10); Li₃BO₃; Li₃BO₃—Li₂SO₄; Li₂O—B₂O₃—P₂O₅; Li₂O—SiO₂; Li₆BaLa₂Ta₂O₁₂; Li₃PO_{(4-3/2w)}N_{w} (w satisfies w<1); Li_{3.5}Zn_{0.25}GeO₄ having a lithium super ionic conductor (LISICON)-type crystal structure; La_{0.55}Li_{0.35}TiO₃ having a perovskite-type crystal structure; LiTi₂P₃O₁₂ having a natrium super ionic conductor (NASICON)-type crystal structure; Li_{1+xh+yh}(Al, Ga)ₓₕ(Ti, Ge)₂₋ₓₕSi_{yh}P_{3-yh}O₁₂ (xh satisfies 0≤xh≤1, and yh satisfies 0≤yh≤1); and Li₇La₃Zr₂O₁₂ (LLZ) having a garnet-type crystal structure.

In addition, a phosphorus compound containing Li, P, or O is also desirable. Examples thereof include lithium phosphate (Li₃PO₄); LiPON in which a part of oxygen elements in lithium phosphate are substituted with a nitrogen element; and LiPOD¹ (D¹ is preferably one or more elements selected from Ti, V, Cr, Mn, Fe, Co, Ni, Cu, Zr, Nb, Mo, Ru, Ag, Ta, W, Pt, and Au).

Furthermore, it is also possible to preferably use LiA¹ON (A¹ is one or more elements selected from Si, B, Ge, Al, C, and Ga).

(iii) Halide-Based Inorganic Solid Electrolytes

The halide-based inorganic solid electrolyte is preferably a compound that contains a halogen atom, has an ion conductivity of a metal belonging to Group 1 or Group 2 in the periodic table, and has electron-insulating properties.

The halide-based inorganic solid electrolyte is not particularly limited; however, examples thereof include LiCl, LiBr, LiI, and compounds such as Li₃YBr₆ or Li₃YCl₆ described in ADVANCED MATERIALS, 2018, 30, 1803075. In particular, Li₃YBr₆ or Li₃YCl₆ is preferable.

### (iv) Hydride-Based Inorganic Solid Electrolyte

The hydride-based inorganic solid electrolyte is preferably a compound that contains a hydrogen atom, has an ion conductivity of a metal belonging to Group 1 or Group 2 in the periodic table, and has electron-insulating properties.

The hydride-based inorganic solid electrolyte is not particularly limited; however, examples thereof include LiBH₄, Li₄(BH₄)₃I, and 3LiBH₄—LiCl.

The inorganic solid electrolyte preferably has a particulate shape in the inorganic solid electrolyte-containing composition. The shape of the particle is not particularly limited and may be a flat shape, an amorphous shape, or the like; however, a spherical shape or a granular shape is preferable. In a case where the inorganic solid electrolyte has a particulate shape, the particle diameter (volume average particle diameter) of the inorganic solid electrolyte is not particularly limited, but is preferably 0.01 μm or more and more preferably 0.1 μm or more. The upper limit is preferably 100 μm or less and more preferably 50 μm or less.

The particle diameter of the inorganic solid electrolyte is measured according to the following procedure. Using water (heptane in a case where the inorganic solid electrolyte is unstable in water), the particles of the inorganic solid electrolyte are diluted in a 20 mL sample bottle to prepare 1% by mass of a dispersion liquid. The diluted dispersion liquid sample is irradiated with 1 kHz ultrasonic waves for 10 minutes and is then immediately used for testing. Data collection is carried out 50 times using this dispersion liquid sample, a laser diffraction/scattering-type particle size distribution analyzer LA-920 (product name, manufactured by Horiba Ltd.), and a quartz cell for measurement at a temperature of 25° C. to obtain the volume average particle diameter. For other detailed conditions and the like, Japanese Industrial Standards (JIS) Z8828: 2013 “particle diameter Analysis-Dynamic Light Scattering” is referred to as necessary. Five samples per level are produced, and the average values therefrom are employed.

The method of adjusting the particle diameter is not particularly limited, and a publicly known method can be applied. Examples thereof include a method using a typical pulverizer or a classifier. As the pulverizer or a classifier, for example, a mortar, a ball mill, a sand mill, a vibration ball mill, a satellite ball mill, a planetary ball mill, a swirling airflow-type jet mill, or a sieve is suitably used. During pulverization, it is possible to carry out wet-type pulverization in which water or a dispersion medium such as methanol is allowed to be present together. In order to provide the desired particle diameter, classification is preferably carried out. The classification is not particularly limited and can be carried out using a sieve, a wind power classifier, or the like. Both the dry-type classification and the wet-type classification can be used.

One kind of inorganic solid electrolyte may be contained, or two or more kinds thereof may be contained.

The content of the inorganic solid electrolyte in the inorganic solid electrolyte-containing composition is not particularly limited. However, in terms of binding properties as well as in terms of dispersibility, it is preferably 50% by mass or more, more preferably 70% by mass or more, and still more preferably 90% by mass or more, in 100% by mass of the solid content. From the same viewpoint, the upper limit thereof is preferably 99.9% by mass or less, more preferably 99.5% by mass or less, and particularly preferably 99% by mass or less.

However, in a case where the inorganic solid electrolyte-containing composition contains an active material described later, regarding the content of the inorganic solid electrolyte in the inorganic solid electrolyte-containing composition, the total content of the active material and the inorganic solid electrolyte is preferably in the above-described range.

In the present invention, the solid content (solid component) refers to a component that does not volatilize or evaporate and disappear in a case where the inorganic solid electrolyte-containing composition is dried at 100° C. for 2 hours under atmospheric pressure (0.10 MPa). Typically, the solid content refers to a component other than the dispersion medium (D) described later. In addition, the content in the total solid content indicates the content in 100% by mass of the total mass of the solid content.

### <Polymer Binder (B)>

The polymer binder (B) contained in the inorganic solid electrolyte-containing composition according to the embodiment of the present invention is formed by containing a polymer that satisfies the above-described mass average molecular weight (Condition (1)). The polymer (also referred to as a binder forming polymer) that is contained in the polymer binder (B) and forms the polymer binder (B) is not particularly limited as long as the above-described mass average molecular weight (Condition (1)) is satisfied.

### (Constitutional Component of Binder Forming Polymer)

In a case of focusing on the constitutional components, the binder forming polymer preferably has one or two or more kinds of functional group-containing constitutional components (I). In a case where the binder forming polymer includes two or more kinds of the functional group-containing constitutional components (I), the upper limit of the number of kinds thereof is not particularly limited, and for example, it can be set to 5.

### —Functional Group-Containing Constitutional Component (I)—

The functional group-containing constitutional component (I) is a constitutional component having at least one functional group among the following group (I) of functional groups, and it allows a polymer binder (B) to exhibit adsorptivity or adhesiveness to solid particles such as an inorganic solid electrolyte.

The functional group-containing constitutional component (I) may have at least one (one kind) functional group, and it is preferable that the functional group-containing constitutional component (I) usually has 1 to 3 kinds of functional groups.

The functional group-containing constitutional component (I) has the functional group, directly or through a linking group, in a partial structure that is incorporated into the main chain of the binder forming polymer.

In the functional group-containing constitutional component (I), the partial structure that is incorporated into the main chain is not unambiguously determined depending on the kind of the binder forming polymer (main chain) but is appropriately selected. For example, in a case of a chain polymerization polymer, a carbon chain (a carbon-carbon bond) can be mentioned.

A linking group L^{P} that links the partial structure that is incorporated into the main chain to the functional group is not particularly limited. However, examples thereof include an alkylene group (preferably having 1 to 12 carbon atoms, more preferably 1 to 6 carbon atoms, and still more preferably having 1 to 3 carbon atoms), an alkenylene group (preferably having 2 to 6 carbon atoms and more preferably having 2 or 3 carbon atoms), an arylene group (preferably having 6 to 24 carbon atoms and more preferably having 6 to 10 carbon atoms), an oxygen atom, a sulfur atom, an imino group (—NR^{N}—: R^{N} represents a hydrogen atom, an alkyl group having 1 to 6 carbon atoms or an aryl group having 6 to 10 carbon atoms), a carbonyl group, a phosphate linking group (—O—P(OH)(O)—O—), a phosphonate linking group (—P(OH)(O)—O—), and a group involved in the combination thereof. As the linking group L^{P}, a group including a —CO—O— group or a —CO—N(R^{N})— group (R^{N} is as described above) and an alkylene group is preferable. However, it is preferable that the linking group L^{P} is not a group obtained by removing R^{I} from the functional group selected from the group (I) of functional groups.

In the present invention, the number of atoms constituting the linking group is preferably 1 to 36, more preferably 1 to 30, and still more preferably 1 to 24. The number of linking atoms of the linking group is preferably 16 or less, more preferably 12 or less, and still preferably 10 or less. The lower limit thereof is 1 or more. The number of linking atoms refers to the minimum number of atoms linking predetermined structural moieties. For example, in a case of —O—C(═O)—CH₂—CH₂—S—, the number of atoms that constitute the linking group is 10; however, the number of linking atoms is 5.

### <Group (I) of Functional Groups>

An ester group (—CO—O—R^{I} or —O—CO—R^{I}), a carboxy group (—CO—OH), a dicarboxylic acid group, a carbonate group (—O—CO—O—R^{I}), a thioester group (—CS—O—R^{I}, —CO—S—R^{I}, or —CS—S—R^{I}). a thiocarbonate group (a group in which at least one oxygen atom in —O—CO—O—R^{I} is substituted with a sulfur atom), an amide group (—CO—NR^{NI}—R^{I}), a urethane group (—NR^{NI}—CO—O—R^{I}), a urea (—NR^{NI}—CO—NR^{NI}—R^{I}), and an imide group

The chemical formulae described by enclosing the names of the above-described functional groups in parentheses indicate the chemical structures of the groups.

It is noted that although the ester group is included in the thiocarbonyl group and the urethane group, the —CO—O—R^{I} group included in the thiocarbonyl group and the urethane group is not interpreted as the ester group. In addition, although the amide group is included in the urea group, the —CO—NR^{NI}—R^{I} group included in the urea group is not interpreted as the amide group. Although a group obtained by the cleavage of the dicarboxylic acid group or the anhydride group thereof may include an ester group (—CO—O—R^{I}), a carboxy group, an amide group, and the like, these groups are integrally interpreted as a group obtained by the cleavage of the dicarboxylic acid group or the anhydride group thereof without being interpreted as a separate functional group.

In each of the above-described functional groups, R^{I} which serves as a terminal group represents a hydrogen atom, a substituent, or a polymerized chain. However, R^{I} in —CO—O—R^{I} represents a substituent or a polymerized chain. The substituent that can be adopted as R^{I} is not particularly limited. Examples of the substituent include a group selected from the substituent Z described later, and among the above, an alkyl group is preferable. In particular, R^{I} to be bonded to the ester group is preferably a combination of a short-chain alkyl group having 1 to 4 carbon atoms and a long-chain alkyl group having 5 to 24 carbon atoms. The polymerized chain that can be adopted as R^{I} is not particularly limited, and examples thereof include a polymerized chain P^{C} described later. The substituent or polymerized chain (constitutional component contained in the polymerized chain) that can be adopted as R^{I} may further have a substituent, and the substituent that may be further contained is not particularly limited, and examples thereof include a group selected from the substituent Z described later, and an alkoxy group, a hydroxy group, a carboxy group, a sulfonic acid group (sulfo group), a phosphoric acid group, and a phosphonic acid group are preferable.

R^{NI} in each of the above-described functional groups represents a hydrogen atom or a substituent. The substituent that can be adopted as R^{NI} is not particularly limited. Examples thereof include a group selected from the substituent Z described later, and among the above, an alkyl group is preferable. Two R^{NI}'s in the urea group may be the same or different from each other.

The carboxylic acid group is not particularly limited; however, it includes a group obtained by removing one or more hydrogen atoms from a dicarboxylic acid anhydride (for example, a group represented by Formula (2a)), and a constitutional component itself (for example, a constitutional component represented by Formula (2b)) obtained by copolymerizing a polymerizable dicarboxylic acid anhydride as a polymerizable compound, and it further includes a group obtained by allowing a dicarboxylic acid anhydride to react with an active hydrogen compound, thereby cleaving the anhydride group. The group obtained by removing one or more hydrogen atoms from a dicarboxylic acid anhydride is preferably a group obtained by removing one or more hydrogen atoms from a cyclic dicarboxylic acid anhydride. Examples the dicarboxylic acid anhydride include acyclic dicarboxylic acid anhydrides such as acetic acid anhydride, propionic acid anhydride, and benzoic acid anhydride; and cyclic dicarboxylic acid anhydrides such as maleic acid anhydride, phthalic acid anhydride, fumaric acid anhydride, succinic acid anhydride, itaconic acid anhydride, and the like. The polymerizable dicarboxylic acid anhydride is not particularly limited; however, examples thereof include a dicarboxylic acid anhydride having an unsaturated bond in the molecule, and a polymerizable cyclic dicarboxylic acid anhydride is preferable. Specific examples thereof include maleic acid anhydride and itaconic acid anhydride. Examples of the dicarboxylic acid anhydride group include a group represented by Formula (2a) and a constitutional component represented by Formula (2b); however, the present invention is not limited thereto. In each of the formulae, * represents a bonding position.

The active hydrogen compound is not particularly limited as long as it is a compound that reacts with a dicarboxylic acid anhydride group, and examples thereof include an alcohol compound, an amine compound, a thiol compound, and a compound having a polymerized chain P^{C} described later (for example, a reactant of a chain transfer agent and a polymerized chain P^{C}).

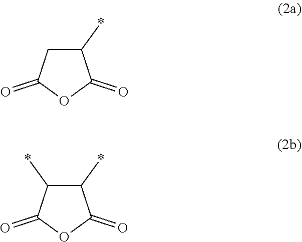 [SMILES: *C1CC(=O)OC1=O ; *C1C(=O)OC(=O)C1*]

The polymerized chain P^{C} is not particularly limited, and a typical polymer, for example, a chain consisting of a sequential polymerization polymer or a chain polymerized polymer which will be described later can be applied. In the present invention, a chain consisting of a chain polymerization polymer is preferable, a polymerized chain consisting of a (meth)acrylic polymer or a polymerized chain consisting of a vinyl polymer is more preferable, and a polymerized chain consisting of a (meth)acrylic polymer is still more preferable. In a case where the polymerized chain contains two or more constitutional components, the bonding mode of the constitutional components is not particularly limited and may be random, alternating, or block.

The polymerized chain consisting of a (meth)acrylic polymer is not particularly limited; however, it preferably has a constitutional component derived from the (meth)acrylic compound (M1) described later or a constitutional component derived from the vinyl compound (M2) described later. Among the above, it is more preferably a polymerized chain having a constitutional component derived from one or two or more (meth)acrylic acid ester compounds, and it is still more preferably a polymerized chain having a constitutional component derived from a (meth)acrylic acid alkyl ester compound. The (meth)acrylic acid alkyl ester compound preferably includes an ester compound of an alkyl group having 4 or more carbon atoms (preferably 6 or more carbon atoms) and can further include an ester compound of a short-chain alkyl group having 3 or less carbon atoms. The short-chain alkyl group may further have the above-described substituent.

The group bonded to the terminal of the polymerized chain P^{C} is not particularly limited, and an appropriate group can be adopted according to a polymerization method, a polymerization stopping method, or the like. Examples thereof include a hydrogen atom, an alkyl group, an aryl group, and a hydroxy group, as well as a chain transfer agent residue and an initiator residue. In terms of dispersion characteristics, preferred examples thereof include an alkyl group (the number of carbon atoms is preferably 1 to 20 and more preferably 4 to 20). This group may further have a substituent; however, it is preferably unsubstituted.

The number average molecular weight of the polymerized chain P^{C} is appropriately determined; however, it is preferably 200 or more, more preferably 1,000 to 100,000, still more preferably 1,000 to 50,000, and particularly preferably 2,000 to 20,000, in terms of the number average molecular weight (including the linking group P^{P}) in the measuring method described later.

It is preferable that the polymerized chain P^{C} is bonded to each of the above-described functional groups through the linking group P^{P}. That is, it is preferable that R^{I} is formed of the linking group P^{P} and the polymerized chain P^{C}. The linking group P^{P} is not particularly limited, and preferred examples thereof include the above-described linking group L^{P}. However, the linking group P^{P} is more preferably a group composed of a combination of an alkylene group, an arylene group, a carbonyl group, an oxygen atom, a sulfur atom, and an imino group, still more preferably a group composed of a combination of an alkylene group, an arylene group, a carbonyl group, an oxygen atom, and an imino group, and particularly preferably a group containing a —CO—O— group or a —CO—N(R^{N})— group (here, R^{N} is as described above), and an alkylene group.

Furthermore, preferred examples of the linking group P^{P} also include a linking group including a structural moiety derived from a chain transfer agent, a polymerization initiator, or the like, which is used for synthesizing the polymerized chain P^{C}. The chain transfer agent is not particularly limited; however, examples thereof include mercaptoacetic acid, 2-mercaptopropionic acid, 3-mercaptopropionic acid, 3-mercaptoisobutyric acid, 2-mercaptoethanol, 6-mercapto-1-hexanol, 2-amino, ethanethiol, and 2-aminoethanethiol hydrochloride. Examples of the functional group-containing constitutional component (I) having the polymerized chain P^{C} include a constitutional component in which a structural moiety derived from a chain transfer agent or the like is bonded to a structural moiety derived from the (meth)acrylic compound (M1) that reacts with the chain transfer agent, or a dicarboxylic acid group. Examples of the constitutional component in which a structural moiety derived from a chain transfer agent or the like is bonded to a structural moiety derived from the (meth)acrylic compound (M1) include a constitutional component (for example, a polymer M-6 synthesized in Examples) in which the polymerized chain P^{C} is bonded to a partial structure that is incorporated into the main chain, through a —CO—O-alkylene group-X—CO—(X)n-alkylene-S-group. Here, X represents an oxygen atom or —NH—, and n is 0 or 1. In addition, examples of the constitutional component in which a structural moiety derived from a chain transfer agent or the like is bonded to a structural moiety derived from the dicarboxylic acid include a constitutional component (for example, a polymer M-4 synthesized in Examples) in which the polymerized chain P^{C} is bonded to a partial structure that is incorporated into the main chain, through a dicarboxylic acid group that has been subjected to a ring-opening addition reaction with a chain transfer agent or the like.

The imide group is not particularly limited; however, examples thereof include a group in which the oxygen atom bonded to two carboxy groups in the dicarboxylic acid anhydride group is substituted with a nitrogen atom.

The carboxy group and the dicarboxylic acid group may form a salt. Examples of the salt include salts of various metal salts, a salt of ammonium or amine, and the like.

The compound from which the functional group-containing constitutional component (I) is derived (also referred to as a polymerizable compound having a functional group (I)) is not particularly limited, and examples thereof include a compound having at least one carbon-carbon unsaturated bond and at least one functional group. For example, the examples include a compound in which a carbon-carbon unsaturated bond and the functional group are directly bonded, a compound in which a carbon-carbon unsaturated bond and the functional group are bonded through a linking group L^{P}, as well as a compound (for example, the polymerizable cyclic carboxylic acid anhydride) in which the functional group itself contains a carbon-carbon unsaturated bond. Specific examples of the polymerizable compound having a functional group (I) include a (meth)acrylic compound (M1) or a vinyl compound (M2) described later, or a compound obtained by introducing the functional group (I) into the compound (M1) or (M2).

### —Constitutional Component (AM)—

It is also preferable that the binder forming polymer has one kind or two or more kinds of constitutional components (AM) derived from a (meth)acrylic acid ester compound.

The constitutional component (AM) is not particularly limited, and examples thereof include a constitutional component derived from a (meth)acrylic compound (M1) described later. The constitutional component (AM) is one kind of the functional group-containing constitutional component (I), and corresponds to the functional group-containing constitutional component directly bonded to the partial structure in which the ester group selected from the group (I) of functional groups is incorporated into the main chain.

### —Another Constitutional Component (Z)—

The binder forming polymer may have one kind or two or more kinds of constitutional components (referred to as “other constitutional component (Z)”) that do not correspond to any of the functional group-containing constitutional component (I) and the constitutional component (AM).

The other constitutional component (Z) is not particularly limited, and a constitutional component derived from a vinyl compound (M2) described later, and a constitutional component that is essential for forming a main chain of various polymers.

The content of each constitutional component in the binder forming polymer is not particularly limited, and it is determined by appropriately considering the physical properties and the like of the entire polymer, and is set, for example, in the following range.

The content of each constitutional component in the binder forming polymer is set, for example, in the following range such that the total content of all the constitutional components is 100% by mass.

It is noted that in a case where the binder forming polymer has a plurality of specific constitutional components, the content of the constitutional components is defined as the total content thereof.

The content of the functional group-containing constitutional component (I) is not particularly limited; however, it can be appropriately adjusted in consideration of dispersion characteristics and the like. The content of the functional group-containing constitutional component (I) is, for example, preferably 1% to 100% by mass, more preferably 10% to 100% by mass, and still more preferably 50% to 100% by mass with respect to the total content of all the constitutional components. It is noted that in a case where the binder forming polymer has the constitutional component (AM), the content of the constitutional component (AM) is also included for calculation in the content of the functional group-containing constitutional component (I).

The content of the constitutional component (AM) is not particularly limited; however, it is appropriately determined depending on the kind of the binder forming polymer. For example, in a case where the binder forming polymer is a (meth)acrylic polymer, the content thereof is 50% by mass or more with respect to the total content of all the constitutional components, and the preferred content thereof is as the (meth)acrylic polymer described later. On the other hand, in a case where the binder forming polymer is a polymer other than the (meth)acrylic polymer, the content of the constitutional component (AM) is preferably 1% to 49% by mass and more preferably 1% to 20% by mass with respect to the total content of all the constitutional components.

The content of the other constitutional component (Z) is not particularly limited; however, it can be set to a remainder obtained by subtracting the contents of the constitutional component (I) and the constitutional component (AM) from the total content of all the constitutional components, and for example, it is preferably 0% to 50% by mass and more preferably 0% to 20% by mass.

### (Form of Binder Forming Polymer)

The binder forming polymer is not particularly limited in terms of its form and type, and various known polymers can be used.

The primary structure (the bonding mode of the constitutional component) of the binder forming polymer is not particularly limited and any bonding mode such as a random structure, a block structure, an alternating structure, or a graft structure can be adopted.

Preferred examples of the binder forming polymer include a polymer having, in the main chain, at least one bond selected from a urethane bond, a urea bond, an amide bond, an imide bond, and an ester bond, or a polymerized chain of carbon-carbon double bonds. In the present invention, the polymerized chain of carbon-carbon double bonds refers to a polymerized chain that is obtained by polymerizing carbon-carbon double bonds (ethylenic unsaturated groups), and specifically, it refers to a polymerized chain obtained by polymerizing (homopolymerizing or copolymerizing) a monomer having a carbon-carbon unsaturated bond.

The above bond is not particularly limited as long as it is contained in the main chain of the polymer, and it may have any aspect in which it is contained in the constitutional component (the repeating unit) and/or an aspect in which it is contained as a bond that connects different constitutional components to each other). In addition, the above-described bond contained in the main chain is not limited to one type, it may be two or more types, and it is preferably one to six types and more preferably one to four types. In this case, the bonding mode of the main chain is not particularly limited. The main chain may randomly have two or more kinds of bonds and may be a main chain that is segmented to a segment having a specific bond and a segment having another bond.

Examples of the polymer having, among the above bonds, a urethane bond, a urea bond, an amide bond, an imide bond, or an ester bond in the main chain include sequential polymerization (polycondensation, polyaddition, or addition condensation) polymers such as polyurethane, polyurea, polyamide, polyimide, and polyester, polysiloxane, and copolymers thereof. The copolymer may be a block copolymer having each of the above polymers as a segment, or a random copolymer in which each constitutional component that constitutes two or more polymers among the above polymers is randomly bonded.

Examples of the polymer having a polymerized chain of carbon-carbon double bonds in the main chain include chain polymerization polymers such as a fluoropolymer (a fluorine-containing polymer), a hydrocarbon polymer, a vinyl polymer, and a (meth)acrylic polymer, where a (meth)acrylic polymer is preferable. The polymerization mode of these chain polymerization polymers is not particularly limited. The chain polymerization polymer may be any one of a block copolymer, an alternating copolymer, or a random copolymer; however, it is preferably a random copolymer.

Examples of the (meth)acrylic polymer include a polymer consisting of a (co)polymer containing 50% by mass or more of a constitutional component derived from a (meth)acrylic compound. Here, in a case where the above-described functional group-containing constitutional component (I) is a constitutional component (which includes a constitutional component of a monoester form obtained by allowing a dicarboxylic acid anhydride group to react with an active hydrogen-containing compound) which is derived from a (meth)acrylic compound, the content of each constitutional component is included for calculation in the content of the constitutional component derived from the (meth)acrylic compound. The content of the constitutional component derived from a (meth)acrylic compound can be set to be the same as the content of the above-described functional group-containing constitutional component (I); however, it is more preferably 60% by mass or more, and still more preferably 70% by mass or more. The upper limit content can be set to 100% by mass, but it can also be set to 97% by mass or less. Furthermore, the (meth)acrylic polymer is also preferably a copolymer with the vinyl compound (M2) other than the (meth)acrylic compound (M1). In this case, the content of the constitutional component derived from the vinyl compound (M2) is 50% by mass or less, and it is preferably 3% to 40% by mass and more preferably 3% to 30% by mass.

Examples of the hydrocarbon polymer include polyethylene, polypropylene, natural rubber, polybutadiene, polyisoprene, polystyrene, a styrene-butadiene copolymer, a styrene-based thermoplastic elastomer, polybutylene, an acrylonitrile-butadiene copolymer, or a hydrogenated polymer of these, as well as a copolymer with a copolymerizable compound such as the (meth)acrylic compound (M1) or the vinyl compounds (M2) and a copolymer containing the functional group-containing constitutional component (I). The styrene-based thermoplastic elastomer or the hydride thereof is not particularly limited. However, examples thereof include a styrene-ethylene-butylene-styrene block copolymer (SEBS), a styrene-isoprene-styrene block copolymer (SIS), a hydrogenated SIS, a styrene-butadiene-styrene block copolymer (SBS), a hydrogenated SBS, a styrene-ethylene-ethylene-propylene-styrene block copolymer (SEEPS), a styrene-ethylene-propylene-styrene block copolymer (SEPS), a styrene-butadiene rubber (SBR), a hydrogenated a styrene-butadiene rubber (HSBR), and furthermore, a random copolymer corresponding to each of the above-described block copolymers such as SEBS. In the present invention, the hydrocarbon polymer preferably has no unsaturated group (for example, a 1,2-butadiene constitutional component) that is bonded to the main chain from the viewpoint that the formation of chemical crosslink can be suppressed.

Examples of the fluoropolymer also include polytetrafluoroethylene (PTFE), polyvinylidene difluoride (PVDF), a copolymer of polyvinylidene difluoride and hexafluoropropylene (PVDF-HFP), and a copolymer (PVDF-HFP-TFE) of polyvinylidene difluoride, hexafluoropropylene, and tetrafluoroethylene, as well as a copolymer with a copolymerizable compound such as the (meth)acrylic compound (M1) or the vinyl compounds (M2) and a copolymer containing the functional group-containing constitutional component (I).

In PVDF-HFP, the copolymerization ratio [PVDF:HFP] (mass ratio) of PVDF to HFP is not particularly limited; however, it is preferably 9:1 to 4:6 and more preferably 9:1 to 7:3 from the viewpoint of adhesiveness. In PVDF-HFP-TFE, the copolymerization ratio [PVDF:HFP:TFE] (mass ratio) of PVDF, HFP, and TFE is not particularly limited; however, it is preferably 20 to 60:10 to 40:5 to 30, and more preferably 25 to 50:10 to 35:10 to 25.

Examples of the (meth)acrylic compound (M1) include a (meth)acrylic acid compound, a (meth)acrylic acid ester compound, a (meth)acrylamide compound, and a (meth)acrylonitrile compound. Among them, a (meth)acrylic acid ester compound is preferable. Examples of the (meth)acrylic acid ester compound include a (meth)acrylic acid alkyl ester compound and a (meth)acrylic acid aryl ester compound, where a (meth)acrylic acid alkyl ester compound is preferable. The number of carbon atoms of the alkyl group that constitutes the (meth)acrylic acid alkyl ester compound is not particularly limited; however, it can be set to, for example, 1 to 24, and it is preferably 3 to 20, more preferably 4 to 16, and still more preferably 6 to 14, in terms of dispersion characteristics and adhesiveness. The number of carbon atoms of the aryl group that constitutes the aryl ester is not particularly limited; however, it can be set to, for example, 6 to 24, and it is preferably 6 to 10 and more preferably 6. In the (meth)acrylamide compound, the nitrogen atom of the amide group may be substituted with an alkyl group or an aryl group.

The vinyl compound (M2) is not particularly limited. However, it is preferably a vinyl compound that is copolymerizable with the (meth)acrylic compound (M1), and examples thereof include an aromatic vinyl compound such as a styrylated compound, a vinyl naphthalene compound, a vinyl carbazole compound, a vinyl imidazole compound, or a vinyl pyridine compound, as well as an allyl compound, a vinyl ether compound, a vinyl ester compound (for example, a vinyl acetate compound), a dialkyl itaconate compound), and the above-described polymerizable cyclic dicarboxylic acid anhydride. Examples of the vinyl compound include the “vinyl monomer” described in JP2015-88486A.

The (meth)acrylic compound (M1) and the vinyl compound (M2) may have a substituent. The substituent is not particularly limited. Examples thereof include a group selected from the substituent Z described later, and preferred examples thereof include a preferable substituent which may be included in the substituent that can be adopted as R^{I}.

The binder forming polymer is preferably a polymer having a polymerized chain of carbon-carbon double bonds in the main chain, and from the viewpoint that the dispersion characteristics, the resistance, and the cycle characteristics can be balanced at a high level, a hydrocarbon polymer, a vinyl polymer, or a (meth)acrylic polymer is more preferable, and a (meth)acrylic polymer is still more preferable.

The binder forming polymer may have a substituent. The substituent is not particularly limited, but examples thereof preferably include a group selected from the following substituent Z, where a substituent that does not correspond to the functional group included in the above-described group (I) of functional groups is preferable.

### —Substituent Z—

The examples are an alkyl group (preferably an alkyl group having 1 to 20 carbon atoms, for example, methyl, ethyl, isopropyl, t-butyl, pentyl, heptyl, 1-ethylpentyl, benzyl, 2-ethoxyethyl, and 1-carboxymethyl); an alkenyl group (preferably an alkenyl group having 2 to 20 carbon atoms, such as vinyl, allyl, and oleyl); an alkynyl group (preferably an alkynyl group having 2 to 20 carbon atoms, for example, ethynyl; however, adynyl, and phenylethynyl); a cycloalkyl group (preferably a cycloalkyl group having 3 to 20 carbon atoms, such as cyclopropyl, cyclopentyl, cyclohexyl, and 4-methylcyclohexyl; in the present invention, the alkyl group generally has a meaning including a cycloalkyl group therein in a case where being referred to, however, it will be described separately here); an aryl group (preferably an aryl group having 6 to 26 carbon atoms, such as phenyl, 1-naphthyl, 4-methoxyphenyl, 2-chlorophenyl, and 3-methylphenyl); an aralkyl group (preferably an aralkyl group having 7 to 23 carbon atoms, for example, benzyl or phenethyl); and a heterocyclic group (preferably a heterocyclic group having 2 to 20 carbon atoms and more preferably a 5- or 6-membered heterocyclic group having at least one oxygen atom, one sulfur atom, or one nitrogen atom. The heterocyclic group includes an aromatic heterocyclic group and an aliphatic heterocyclic group. Examples thereof include a tetrahydropyran cyclic group, a tetrahydrofuran cyclic group, 2-pyridyl, 4-pyridyl, 2-imidazolyl, 2-benzimidazolyl, 2-thiazolyl, 2-oxazolyl, and a pyrrolidone group); an alkoxy group (preferably an alkoxy group having 1 to 20 carbon atoms, for example, methoxy, ethoxy, isopropyloxy, or benzyloxy); an aryloxy group (preferably an aryloxy group having 6 to 26 carbon atoms, for example, phenoxy, 1-naphthyloxy, 3-methylphenoxy, or 4-methoxyphenoxy); a heterocyclic oxy group (a group in which an —O— group is bonded to the above-described heterocyclic group); an alkoxycarbonyl group (preferably an alkoxycarbonyl group having 2 to 20 carbon atoms, for example, ethoxycarbonyl, 2-ethylhexyloxycarbonyl, or dodecyloxycarbonyl); an aryloxycarbonyl group (preferably an aryloxycarbonyl group having 7 to 26 carbon atoms, for example, phenoxycarbonyl, 1-naphthyloxycarbonyl, 3-methylphenoxycarbonyl, or 4-methoxyphenoxycarbonyl); a heterocyclic oxycarbonyl group (a group in which an —O—CO— group is bonded to the above-described heterocyclic group); an amino group (preferably an amino group having 0 to 20 carbon atoms, an alkylamino group, or an arylamino group, for example, amino (—NH₂), N,N-dimethylamino, N,N-diethylamino, N-ethylamino, or anilino); a sulfamoyl group (preferably a sulfamoyl group having 0 to 20 carbon atoms, for example, N,N-dimethylsulfamoyl group, or an N-phenylsulfamoyl group); an acyl group (an alkylcarbonyl group, an alkenylcarbonyl group, an alkynylcarbonyl group, an arylcarbonyl group, and a heterocyclic carbonyl group, preferably an acyl group having 1 to 20 carbon atoms, for example, acetyl, propionyl, butyryl, octanoyl, hexadecanoyl, acryloyl, methacryloyl, crotonoyl, benzoyl, naphthoyl, or nicotinoyl); an acyloxy group (an alkylcarbonyloxy group, an alkenylcarbonyloxy group, an alkynylcarbonyloxy group, and a heterocyclic carbonyloxy group, preferably an acyloxy group having 1 to 20 carbon atoms, for example, acetyloxy, propionyloxy, butyryloxy, octanoyloxy, hexadecanoyloxy, acryloyloxy, methacryloyloxy, crotonoyloxy, or nicotinoyloxy); an aryloyloxy group (preferably an aryloyloxy group having 7 to 23 carbon atoms, for example, benzoyloxy, or naphthoyloxy); a carbamoyl group (preferably a carbamoyl group having 1 to 20 carbon atoms, for example, N,N-dimethylcarbamoyl, or N-phenylcarbamoyl); an acylamino group (preferably an acylamino group having 1 to 20 carbon atoms, for example, acetylamino, or benzoylamino); an alkylthio group (preferably an alkylthio group having 1 to 20 carbon atoms, for example, methylthio, ethylthio, isopropylthio, or benzylthio); an arylthio group (preferably an arylthio group having 6 to 26 carbon atoms, for example, phenylthio, 1-naphthylthio, 3-methylphenylthio, or 4-methoxyphenylthio); a heterocyclic thiol group (a group in which an —S— group is bonded to the above-described heterocyclic group); an alkylsulfonyl group (preferably an alkylsulfonyl group having 1 to 20 carbon atoms, for example, methylsulfonyl or ethylsulfonyl); an arylsulfonyl group (preferably an arylsulfonyl group having 6 to 22 carbon atoms, for example, benzenesulfonyl); an alkylsilyl group (preferably an alkylsilyl group having 1 to 20 carbon atoms, for example, monomethylsilyl, dimethylsilyl, trimethylsilyl, or triethylsilyl); an arylsilyl group (preferably an arylsilyl group having 6 to 42 carbon atoms, for example, triphenylsilyl); an alkoxysilyl group (preferably an alkoxysilyl group having 1 to 20 carbon atoms, for example, monomethoxysilyl, dimethoxysilyl, trimethoxysilyl, or triethoxysilyl); an aryloxysilyl group (preferably an aryloxysilyl group having 6 to 42 carbon atoms, for example, triphenyloxysilyl); a phosphoryl group (preferably a phosphate group having 0 to 20 carbon atoms, for example, —OP(═O)(R^{P})₂); a phosphonyl group (preferably a phosphonyl group having 0 to 20 carbon atoms, for example, —P(═O)(R^{P})₂); a phosphinyl group (preferably a phosphinyl group having 0 to 20 carbon atoms, for example, —P(R^{P})₂); a phosphonate group (preferably a phosphonate group having 0 to 20 carbon atoms, for example, —PO(OR^{P})₂); a sulfo group (a sulfonate group); a carboxy group; a hydroxy group; a sulfanyl group; a cyano group; and a halogen atom (for example, a fluorine atom, a chlorine atom, a bromine atom, or an iodine atom). R^{P} represents a hydrogen atom or a substituent (preferably a group selected from the substituent Z).

In addition, each group exemplified in the substituent Z may be further substituted with the substituent Z.

The alkyl group, the alkylene group, the alkenyl group, the alkenylene group, the alkynyl group, the alkynylene group, and/or the like may be cyclic or chained, may be linear or branched.

The binder forming polymer can be synthesized by selecting a raw material compound and polymerizing the raw material compound by a publicly known method.

The method of incorporating each functional group is not particularly limited, and examples thereof include a method of copolymerizing a compound having a functional group, a method of using a polymerization initiator having (generating) the above-described functional group or a chain transfer agent, a method of using a polymeric reaction, an ene reaction or ene-thiol reaction with a double bond, and an atom transfer radical polymerization (ATRP) method using a copper catalyst. In addition, a functional group can be introduced by using a functional group that is present in the main chain, the side chain, or the terminal of the polymer, as a reaction point. For example, a functional group can be introduced by various reactions with a dicarboxylic acid anhydride group in a polymerized chain using a compound having a functional group.

Specific examples of the binder forming polymer include each of polymers synthesized in Examples; however, the present invention is not limited thereto.

### —Physical Properties, Characteristics, or Like of Binder Forming Polymer or Polymer Binder—

The polymer binder or the binder forming polymer, which is used in the present invention, preferably has the following physical properties or characteristics.

The polymer binder preferably has a characteristic (solubility) of being dissolved in the dispersion medium (D) contained in the inorganic solid electrolyte-containing composition according to the embodiment of the present invention. The polymer binder (B) in the inorganic solid electrolyte-containing composition generally is present in a state of being dissolved in a dispersion medium in the inorganic solid electrolyte-containing composition, which depends on the content thereof. In this manner, the effect of improving the dispersibility of the solid particles can be further enhanced, and the dispersion characteristics, the handleability, the low resistance, and the cycle characteristics can be improved in a well-balanced manner.

In the present invention, the polymer binder (B) being dissolved in the dispersion medium (D) means that the polymer binder (B) is dissolved in the dispersion medium (D) in the inorganic solid electrolyte-containing composition, and for example, it means that the solubility of the polymer binder (B) is 50% or more in the following solubility measurement. The polymer binder (B) is not limited to an aspect in which all of the polymer binder (B) is dissolved in the dispersion medium (D) in the inorganic solid electrolyte-containing composition, and includes an aspect in which a part of the polymer binder (B) is present in an insoluble form. On the other hand, the description that the polymer binder is not dissolved (is insoluble) in a dispersion medium means that the solubility in the solubility measurement is less than 50% by mass.

The method of measuring the solubility is the same as the method of measuring the solubility in the compound (A), except that the polymer binder (B) (solid) is used instead of the compound (A).

In the present invention, the solubility of the polymer binder (B) in the dispersion medium (D) can be appropriately imparted by the kind of the binder forming polymer, the composition of the binder forming polymer (the kind and the content of the constitutional component), the mass average molecular weight of the binder forming polymer, the kind of the above-described functional group, the combination with the dispersion medium, and the like.

In a case where the polymer binder (B) is not dissolved in the dispersion medium, the polymer binder (B) is typically dispersed in a particulate shape. The shape of the polymer binder at this time is not particularly limited, and may be a flat shape, an amorphous shape, or the like; however, a spherical shape or a granular shape is preferable. In this case, in the inorganic solid electrolyte-containing composition, the particle diameter of the particles of the polymer binder having a particulate shape is not particularly limited, but is preferably 1 nm or more, more preferably 10 nm or more, and still more preferably 30 nm or more. The upper limit value thereof is preferably 5 μm or less, more preferably 1 μm or less, and still more preferably 500 nm or less. The particle diameter of the polymer binder can be measured in the same manner as the particle diameter of the inorganic solid electrolyte. The particle diameter of the polymer binder can be adjusted by, for example, the kind of the dispersion medium, the composition of the binder forming polymer, and the like.

The moisture concentration of the binder (the binder forming polymer) is preferably 100 ppm (in terms of mass) or less. In addition, as this binder, a polymer may be crystallized and dried, or a binder liquid may be used as it is.

It is preferable that the binder forming polymer is noncrystalline. In the present invention, the description that a polymer is “noncrystalline” typically refers to that no endothermic peak due to crystal melting is observed in a case where the measurement is carried out at the glass transition temperature.

The binder forming polymer may be a non-crosslinked polymer or a crosslinked polymer. In addition, in a case where the crosslinking of the polymer progresses due to heating or voltage application, the molecular weight may be higher than the above-described molecular weight. Preferably, the binder forming polymer has a mass average molecular weight in the above-described range at the start of use of the all-solid state secondary battery.

The binder forming polymer, which is contained in the polymer binder, may be one type or two or more types. In addition, the polymer binder may contain another polymer as long as the action of the binder forming polymer is not impaired. As another polymer, a polymer that is generally used as a binder for an all-solid state secondary battery can be used without particular limitation.

The inorganic solid electrolyte-containing composition may contain one kind or two or more kinds of polymer binders.

The content of the polymer binder in the inorganic solid electrolyte-containing composition is not particularly limited, but from the viewpoint of dispersion characteristics, ion conductivity, and binding properties, it is preferably 0.1% to 6.0% by mass, more preferably 0.3% to 5.0% by mass, and still more preferably 0.4% to 2.5% by mass with respect to 100% by mass of the solid content.

In the present invention, the mass ratio [(the mass of the inorganic solid electrolyte+the mass of the active material)/(the total mass of the polymer binder)] of the total mass (total amount) of the inorganic solid electrolyte and the active material to the mass of the polymer binder in the solid content of 100% by mass is preferably in a range of 1,000 to 1. Further, this ratio is more preferably 500 to 2 and still more preferably 100 to 10.

### <Compound (A)>

The compound (A) contained in the inorganic solid electrolyte-containing composition according to the embodiment of the present invention has at least one functional group selected from the group (a) of functional groups described later (Condition (2)).

As described above, the compound (A) is considered to exhibit a function of reinforcing the adsorptivity between the polymer binder (B) and the solid particles.

The kind of the functional group contained in the compound (A) is not particularly limited, and is one kind or two or more kinds; however, it is preferable that the compound (A) contains one kind of the functional group from the viewpoint that the compound (A) can be stably adsorbed to the solid particles. In addition, the number of functional groups contained in the compound (A) is not particularly limited, and for example, it can be 1 to 4, and from the viewpoint that the compound (A) can be stably adsorbed to the solid particles, the number of functional groups is preferably 1 or 2 and more preferably 1. The compound (A) is particularly preferably a compound having one kind of functional group.

### [Group (a) of Functional Groups]

A hydroxy group, an amino group, a carboxy group, a sulfonic acid group (—S(═O)₂OR^{C}), a phosphoric acid group (—OP(═O)(OR^{C})₂), a phosphonic acid group (—P(═O)(OR^{C})₂), a cyano group, a thiol group (—SH), and a sulfinyl group (—S(═O)R^{C})

R^{C} in the functional group represents a hydrogen atom or a substituent, and a hydrogen atom is preferable. The substituent that can be adopted as R^{C} is not particularly limited, and examples thereof include a group selected from the above-described substituent Z, where a hydrocarbon group such as an alkyl group, an alkenyl group, an alkynyl group, or an aryl group is preferable. Two R^{C}'s each contained in the phosphate group and the phosphonate group may be the same as or different from each other.

The amino group, the sulfonic acid group (sulfo group), the phosphoric acid group (phosphoryl group), and the phosphonic acid group are not particularly limited, but each have the same meaning as the corresponding group of the substituent Z described above. However, the amino group more preferably has 0 to 12 carbon atoms, still more preferably 0 to 6 carbon atoms, and particularly preferably 0 to 2 carbon atoms. The hydroxy group, the amino group, the carboxy group, and the thiol group may form a salt, and the sulfo group, the phosphate group, the phosphonate group, and the sulfanyl group may form a salt in a case where Re takes a hydrogen atom. However, it is preferable that each functional group included in the group (a) of functional groups does not have a metal element, and for example, in a case where each of the above-described functional groups forms a salt, examples of the cation include an organic cation, and specifically, an ammonium cation, an alkylammonium cation, and the like.

It is noted that an amino group that does not constitute an amide group together with a carbonyl group is preferable.

Among the above, the functional group contained in the compound (A) is preferably a hydroxy group, a carboxy group, a sulfonic acid group, a phosphonic acid group, or a thiol group, and more preferably a thiol group.

The compound (A) may be an inorganic compound such as polysiloxane or an organic compound such as an aliphatic compound or an aromatic compound, and is preferably an aliphatic compound. The aliphatic compound and the aromatic compound may each have at least one heteroatom such as oxygen, nitrogen, sulfur, or phosphorus, but are preferably an aliphatic hydrocarbon compound and an aromatic hydrocarbon compound. In addition, the aliphatic compound and the aromatic compound may each have any of a linear structure, a branched structure, or a cyclic structure (including a monocyclic structure and a polycyclic structure), or a structure in which these structures are combined, but it is preferable that the cyclic structure is not included in the molecule, and the linear structure or the branched structure is more preferable. The cyclic structure includes a monocyclic structure and a polycyclic structure. In addition, the compound (A) may be a polymeric compound such as a polymer, but is preferably a low-molecular-weight compound that is not a polymer.

In the compound (A), the basic skeleton (a residue obtained by removing the functional group from the compound (A)) to which the functional group is bonded is not particularly limited, and an appropriate group can be selected. The residue may be any of a group derived from an inorganic compound, an aliphatic group, or an aromatic group, may be a monovalent group or a divalent or higher valent group, and is preferably a monovalent group. Examples of the monovalent residue include an alkyl group, an alkenyl group, an alkynyl group, an aryl group (preferably having 6 to 24 carbon atoms and more preferably having 6 to 10 carbon atoms), a siloxane group (—Si(R^{S})₂—O—), a carbonyl group, a group related to a combination of these groups, and a group related to a combination of each of these groups with an oxygen atom, a sulfur atom, or an imino group (—NR^{N}—: R^{N} represents a hydrogen atom, an alkyl group having 1 to 6 carbon atoms, or an aryl group having 6 to 10 carbon atoms). Examples of the divalent or higher valent residue include a group obtained by removing a required number of hydrogen atoms from a monovalent residue, an oxygen atom, a sulfur atom, an imino group (—NR^{N}—: R^{N} represents a hydrogen atom, an alkyl group having 1 to 6 carbon atoms, or an aryl group having 6 to 10 carbon atoms), and the like. As the residue, an alkyl group, an alkenyl group, an alkynyl group, an aryl group, or a group related to a combination thereof is preferable, an alkyl group, an alkenyl group or an alkynyl group, or a group related to a combination thereof is more preferable, and an alkyl group is still more preferable.

Here, R^{S} in the siloxane group represents a hydrogen atom or a substituent, and a substituent is preferable. The substituent that can be adopted as R^{S} is not particularly limited, and examples thereof include a group selected from the above-described substituent Z, where an alkyl group or an aryl group is preferable.

Each of the alkyl group, the alkenyl group, and the alkynyl group may be a linear chain, a branched chain, or a cyclic chain, but is preferably a linear chain or a branched chain and more preferably a linear chain.

The number of carbon atoms constituting the alkyl group is not particularly limited and can be appropriately set, for example, to 1 to 24, and from the viewpoint of dispersion characteristics and adhesiveness, is preferably 3 to 20, more preferably 4 to 16, and still more preferably 6 to 14. The number of carbon atoms constituting the alkenyl group and the alkynyl group is not particularly limited and can be appropriately set, for example, to 2 to 24, and from the viewpoint of dispersion characteristics and adhesiveness, is preferably 3 to 20, more preferably 4 to 16, and still more preferably 6 to 14. It is particularly preferable that the number of carbon atoms constituting the alkyl group, the alkenyl group, and the alkynyl group is the same as the number of carbon atoms of the terminal group (details will be described later) bonded to the hetero linking group of the polymer that forms the polymer binder (B) used in combination with the compound (A). The number of carbon atoms constituting each group does not include the number of carbon atoms constituting the substituent contained in each group.

In addition, the number of groups or atoms to be combined in the group involved in the combination is not particularly limited, but for example, in a case where the compound (A) is a non-polymerizable low-molecular-weight compound, it can be set to 2 to 200 and preferably 2 to 100, and in a case where the compound (A) is a polymer, it can be set to 2 to 100. In particular, in a case where the compound (A) is a polymer of a siloxane group, the degree of polymerization n of the siloxane group is preferably an integer of 1 to 100, more preferably an integer of 5 to 50, and still more preferably an integer of 10 to 30. The terminal group of this polymer is not particularly limited, and examples thereof include R^{S1}—Si(R^{S})₂—O—. R^{S1} has the same definition as R^{S}.

In the group involved in the combination, the number of kinds of groups or atoms to be combined is not particularly limited, but for example, it can be set to 2 or more, and it is preferably set to 2 or 3.

The compound (A) may have a chemical structure different from that of the side chain (partial structure) that is branched from the main chain by being bonded to an atom forming the main chain of the binder forming polymer, but it is preferable that the compound (A) has the same chemical structure as that of the side chain. Here, in a case where the side chain in which the residue and the chemical structure of the compound (A) are different from each other does not include the following hetero linking group, the side chain is regarded as the entire side chain, and in a case where the side chain includes the following hetero linking group, the side chain is regarded as a terminal group bonded to the hetero linking group, not the entire side chain. For example, in the polymer M-1 synthesized in Examples, the styrene constitutional component is a phenyl group, and each constitutional component derived from a (meth)acrylic acid ester compound is a terminal group bonded to an ester group. The fact that the chemical structures are the same will be described later.

The hetero linking group included in the binder forming polymer may be a linking group (bond) including a heteroatom, and examples thereof include an oxygen atom (—O—), an imino group (—NR^{N}—: R^{N} represents a hydrogen atom, an alkyl group having 1 to 6 carbon atoms, or an aryl group having 6 to 10 carbon atoms), a sulfur atom (—S—), a carbonyl group (—CO—), a thiocarbonyl group (—CS—), and a group formed by a combination thereof. The number of atoms or groups constituting the combined group is not particularly limited, and can be 2 to 30, and is preferably 2 to 10. Specific examples of the hetero linking group include an oxygen atom, an imino group, a sulfur atom, an ester bond (—CO—O—), a carbonate bond (—O—CO—O—), an amide bond (—CO—NR^{N}—), a urethane bond (—NR^{N}—CO—O—), and a urea bond (—NR^{N}—C—NR^{N}). Among these, an ester bond (—CO—O—), an amide bond (—CO—NR^{N}—), a urethane bond (—NR^{N}—CO—O—), or a urea bond (—NR^{N}—CO—NR^{N}—) is preferable, and an ester bond (—CO—O—) or an amide bond (—CO—NR^{N}—) is more preferable.

In the binder forming polymer, the hetero linking group contained in the partial structure (also referred to as a side chain-forming partial structure) serving as a side chain may be one kind or two or more kinds. In addition, the total number of hetero linking groups contained in the side chain-forming partial structure is not unambiguously determined by the kind of the binder forming polymer, the kind of the constitutional component, and the like. For example, in a case of a typical constitutional component having no polymerized chain, it is preferable to have 1 to 3 hetero linking groups, and in a case of a constitutional component having a polymerized chain, the number of hetero linking groups is determined by the degree of polymerization of the polymerized chain and the molecular structure of the constitutional component forming the polymerized chain.

The constitutional component having a hetero linking group is not particularly limited, and examples thereof include the above-described functional group-containing constitutional component (I), constitutional component (AM), and other constitutional components (Z). Specific examples thereof include a constitutional component derived from an (meth)acrylic acid ester compound having an ester bond as a hetero linking group, a constitutional component derived from an (meth)acrylic acid amide compound having an amide bond as a hetero linking group, and a constitutional component including these constitutional components in the polymerized chain P^{C}.

In the present invention, in a case where the binder forming polymer has a side chain and a terminal group for determining the difference in chemical structure from the residue of the compound (A), it is preferable to employ the terminal group. That is, in the present invention, the compound (A) may have a chemical structure different from that of the terminal group to which the residue obtained by removing the functional group is bonded to the hetero linking group of the binder forming polymer, but it is more preferable that the compound (A) has the same chemical structure as that of the terminal group (the Condition (5) is satisfied).

In the inorganic solid electrolyte-containing composition according to the embodiment of the present invention, in a case where the compound (A) satisfies the Condition (5), it is considered that the interaction with the polymer that forms the polymer binder (B) is strengthened, and the action of improving the dispersibility of the polymer binder (D) with respect to the solid particles and the binding property to the solid particles can be further enhanced. As a result, it is possible to achieve the dispersion characteristics, the suppression of the increase in resistance, and the cycle characteristics at a higher level in a well-balanced manner without impairing the excellent handleability.

In the present invention, the residue obtained by removing the functional group from the compound (A) means the above-described basic skeleton. However, in a case where the residue is divalent or higher valent (in a case where the compound (A) has two or more functional groups), the chemical structure of the terminal group is determined to be different from that of the basic skeleton by adding a hydrogen atom to the above-described basic skeleton for convenience as a monovalent residue. On the other hand, the terminal group bonded to the hetero linking group of the polymer that constitutes the polymer binder (B) refers to a terminal group bonded to the hetero linking group in a case where the terminal group is a constitutional component that has one hetero linking group in a side chain-forming partial structure of one constitutional component, and in a case where the constitutional component has a plurality of hetero linking groups in the side chain-forming partial structure of one component, the terminal group bonded to the hetero linking group refers to a terminal group bonded to a hetero linking group located at a position (terminal side) farthest from a partial structure that is incorporated into the main chain of the binder forming polymer in the constitutional component. Here, in a case where a polymerized chain having a constitutional component having a hetero linking group is contained in a side chain-forming partial structure of one constitutional component, the terminal group refers to a terminal group bonded to the hetero linking group in the above-described constitutional component contained in the polymerized chain, even in a case where the hetero linking group is present other than the polymerized chain. For example, in the polymer M-1 synthesized in Examples, the terminal groups are three types of a hexyl group, a 2-hydroxyethyl group, and a methyl group, and in the polymer M-4, the terminal groups are three types of a phenyl group, a dodecyl group, and a 2-hydroxyethyl group.

The side chain and the terminal group cannot be determined unambiguously depending on the kind of the binder forming polymer, the constitutional components, and the like, but from the viewpoint of exhibiting a strong interaction with the polymer binder (B) and being able to balance the dispersion characteristics, the resistance, and the cycle characteristics at a high level, a group that does not have a group that is easily adsorbed to the solid particles, for example, a group that does not have a substituent is preferable, and an unsubstituted hydrocarbon group (alkyl group, alkenyl group, alkynyl group, or aryl group) is preferable.

On the other hand, the residue of the compound (A) is as described above, but it is preferably a substituent that does not have a halogen atom, which inhibits the interaction with the polymer binder (B), and it is preferably an unsubstituted hydrocarbon group.

In the present invention, in a case where a plurality of terminal groups are present in the polymer binder (B) as in the above-described polymer M-1, the terminal group that determines the difference in chemical structure with the residue is set to a group having no substituent (unsubstituted terminal group) in terms of interaction, and in a case where a plurality of unsubstituted terminal groups are present, the terminal group is a terminal group having the largest molecular weight among the unsubstituted terminal groups. For example, the terminal group for determining the difference from the residue is a hexyl group in the polymer M-1, a dodecyl group in the polymer M-4, and an octyl group in the polymer M-7.

Having a chemical structure in which a residue and a side chain or a terminal group are different from each other means that any one of the kind of each group (side chain), the number of carbon atoms constituting each group (side chain), or the presence or absence of a substituent is different between the chemical structure of the residue and the chemical structure of the side chain or the terminal group. For example, examples of the combination of a residue having a different chemical structure and a side chain or a terminal group include a combination in which the residue is an alkyl group and the side chain or the terminal group is an aryl group, a combination in which the residue and the side chain or the terminal group are alkyl groups having a different number of carbon atoms, and a combination in which the residue has a substituent and the side chain or the terminal group is unsubstituted. In a combination in which the chemical structures of the residue and the side chain or the terminal group are different from each other, a combination in which the residue and the side chain or the terminal group are the same type of group and have different numbers of carbon atoms is preferable.

On the other hand, the fact that a residue and a side chain or a terminal group have the same chemical structure means that the chemical structure of the residue and the chemical structure of the side chain or the terminal group are the same in terms of the kind of each group (side chain), the number of carbon atoms constituting each group (side chain), and the presence or absence of a substituent.

The compound (A) is preferably a compound different from the dispersion medium (D) described later, and more preferably a compound different from the inorganic solid electrolyte (SE), the active material (AC) described later, the conductive auxiliary agent, the lithium salt, the dispersant, and the like. Examples of the compound (A) include an aliphatic or aromatic alcohol compound or a thiol compound, an aliphatic or aromatic carboxylic acid compound, an aliphatic or aromatic sulfonic acid ester compound, an aliphatic or aromatic phosphoric acid ester compound, an aliphatic or aromatic phosphonic acid ester compound, an aliphatic or aromatic cyano compound, and an aliphatic or aromatic sulfinyl compound, where an aliphatic alcohol compound or a thiol compound, an aliphatic carboxylic acid compound, an aliphatic sulfonic acid ester compound, or an aliphatic phosphoric acid ester compound is preferable, and an aliphatic thiol compound is more preferable.

The compound (A) may have a substituent other than the functional group included in the group (a) of functional groups, and examples of the substituent which may be contained include a group selected from the above-described substituent Z, and examples thereof include a halogen atom. In a case where the hydrocarbon group that can be adopted as a residue has a halogen atom as a substituent, all hydrogen atoms contained in the hydrocarbon group may be substituted with halogen atoms, or a part of the hydrogen atoms may be substituted with halogen atoms.

In addition, the compound (A) is preferably a compound that does not contain a metal element, and more preferably an organic compound that does not contain a metal element. In the present invention, the metal element generally refers to a metal element belonging to Group 1 to Group 17 in the periodic table of elements, and the metal element that is not included in the compound (A) is preferably a metal element belonging to Group 1, Group 2, Group 12, or Group 13, and more preferably a metal element belonging to Group 1 or Group 2.

As the compound (A), a commercially available product or a synthetic product can be used. Examples of a method for synthesizing the compound (A) include various known synthesis methods. In addition, a raw material compound used for the synthesis of the binder forming polymer, for example, the (meth)acrylic compound (M1) can also be used for the synthesis.

Specific examples of the compound (A) include those prepared in Examples, but the present invention is not limited thereto.

In the inorganic solid electrolyte-containing composition according to the embodiment of the present invention, the combination of the inorganic solid electrolyte (SE), the polymer binder (B), and the compound (A) is not particularly limited and can be appropriately combined. For example, a combination of the above-described preferred ones is preferable, and a combination of the inorganic solid electrolyte (SE), the polymer binder (B) that is dissolved in the dispersion medium (D), and the compound (A) having a molecular weight of less than 600 and satisfying the above-described condition (5) is more preferable. Focusing on the kind of the compound, a combination of a sulfide-based inorganic solid electrolyte as the inorganic solid electrolyte (SE), an acrylic polymer as the polymer binder (B), and an aliphatic thiol compound as the compound (A) is more preferable. In each of the above-described preferred combinations, the content of the compound (A) is appropriately set, for example, within the following range, but it is particularly preferable to be 10 ppm or more and 2.0×10³ ppm or less with respect to 100% by mass of the solid content of the inorganic solid electrolyte-containing composition.

The compound (A) contained in the inorganic solid electrolyte-containing composition may be one kind or two or more kinds.

In the inorganic solid electrolyte-containing composition according to the embodiment of the present invention, the content of the compound (A) is not particularly limited; however, it is preferably 0.5 ppm or more and 2.0×10³ ppm or less, more preferably 10 ppm or more and 2.0×10³ ppm or less, still more preferably 10 ppm or more and 1.0×10³ ppm or less, particularly preferably 10 ppm or more and 6.0×10² ppm or less, and most preferably 10 ppm or more and 2.0×10² ppm or less, in 100% by mass of the solid content of the inorganic solid electrolyte-containing composition, from the viewpoint that the decomposition of the inorganic solid electrolyte (SE) can be suppressed, and the dispersion characteristics, the resistance, and the cycle characteristics can be balanced at a high level. The content of the compound (A) is preferably 0.5 ppm or more and 1.0×10⁴ ppm or less, more preferably 50 ppm or more and 1.0×10⁴ ppm, still more preferably 50 ppm or more and less than 5.0×10³ ppm, particularly preferably 50 ppm or more and 3.0×10³ ppm or less, and most preferably 50 ppm or more and 1.0×10³ ppm or less, with respect to the inorganic solid electrolyte (SE).

On the other hand, the content of the compound (A) in the inorganic solid electrolyte-containing composition is preferably 0.1% to 20% by mass with respect to the polymer binder (B), and from the viewpoint that the dispersion characteristics, the resistance, and the cycle characteristics can be balanced at a high level, it is preferably 0.01% to 10% by mass, more preferably 0.1% to 10% by mass, still more preferably 0.1% to 6% by mass, and particularly preferably 0.1% to 2% by mass.

The above-described content of the compound (A) can be calculated from the used amount of the compound (A) in the preparation of the inorganic solid electrolyte-containing composition, and can also be calculated using a value obtained by measuring the content of each component in the inorganic solid electrolyte-containing composition. For example, the content of the compound (A) in the inorganic solid electrolyte-containing composition can be measured by the following method and conditions using gas chromatography.

### <Dispersion Medium>

The inorganic solid electrolyte-containing composition according to the embodiment of the present invention contains a dispersion medium (D) in which each of the above-described components is dispersed or dissolved.

Such a dispersion medium may be an organic compound that is in a liquid state in the use environment, and examples of the dispersion medium include various organic solvents, and specifically include an alcohol compound, an ether compound, an amide compound, an amine compound, a ketone compound, an aromatic hydrocarbon compound, an aliphatic hydrocarbon compound, a nitrile compound, and an ester compound. Among these, an ether compound, an amide compound, a ketone compound, an aromatic hydrocarbon compound, an aliphatic hydrocarbon compound, or an ester compound is preferable.

The dispersion medium may be a non-polar dispersion medium (a hydrophobic dispersion medium) or a polar dispersion medium (a hydrophilic dispersion medium); however, a non-polar dispersion medium is preferable from the viewpoint that excellent dispersion characteristics can be exhibited. The non-polar dispersion medium generally refers to a dispersion medium having a property of a low affinity to water; however, in the present invention, examples thereof include an ester compound, a ketone compound, an ether compound, an aromatic hydrocarbon compound, and an aliphatic hydrocarbon compound.

Examples of the alcohol compound include methyl alcohol, ethyl alcohol, 1-propyl alcohol, 2-propyl alcohol, 2-butanol, ethylene glycol, propylene glycol, glycerin, 1,6-hexanediol, cyclohexanediol, sorbitol, xylitol, 2-methyl-2,4-pentanediol, 1,3-butanediol, and 1,4-butanediol.

Examples of the ether compound include an alkylene glycol (diethylene glycol, triethylene glycol, polyethylene glycol, dipropylene glycol, or the like), an alkylene glycol monoalkyl ether (ethylene glycol monomethyl ether, ethylene glycol monobutyl ether, diethylene glycol monomethyl ether, propylene glycol monomethyl ether, dipropylene glycol monomethyl ether, tripropylene glycol monomethyl ether, diethylene glycol monobutyl ether, or the like), alkylene glycol dialkyl ether (ethylene glycol dimethyl ether or the like), a dialkyl ether (dimethyl ether, diethyl ether, diisopropyl ether, dibutyl ether, or the like), and a cyclic ether (tetrahydrofuran, dioxane (including 1,2-, 1,3- or 1,4-isomer), or the like).

Examples of the amide compound include N,N-dimethylformamide, N-methyl-2-pyrrolidone, 2-pyrrolidinone, 1,3-dimethyl-2-imidazolidinone, F-caprolactam, formamide, N-methylformamide, acetamide, N-methylacetamide, N,N-dimethylacetamide, N-methylpropanamide, and hexamethylphosphoric triamide.

Examples of the amine compound include triethylamine, diisopropylethylamine, and tributylamine.

Examples of the ketone compound include acetone, methyl ethyl ketone, methyl isobutyl ketone (MIBK), cyclopentanone, cyclohexanone, cycloheptanone, dipropyl ketone, dibutyl ketone, diisopropyl ketone, diisobutyl ketone (DIBK), isobutyl propyl ketone, sec-butyl propyl ketone, pentyl propyl ketone, and butyl propyl ketone.

Examples of the aromatic hydrocarbon compound include benzene, toluene, xylene, and perfluorotoluene.

Examples of the aliphatic hydrocarbon compound include hexane, heptane, octane, nonane, decane, dodecane, cyclohexane, methylcyclohexane, ethylcyclohexane, cycloheptane, cyclooctane, decalin, paraffin, gasoline, naphtha, kerosene, and light oil.

Examples of the nitrile compound include acetonitrile, propionitrile, and isobutyronitrile.

Examples of the ester compound include ethyl acetate, propyl acetate, propyl butyrate, butyl acetate, ethyl butyrate, isopropyl butyrate, butyl butyrate, isobutyl butyrate, butyl pentanoate, pentyl pentanoate, ethyl isobutyrate, propyl isobutyrate, isopropyl isobutyrate, isobutyl isobutyrate, propyl pivalate, isopropyl pivalate, butyl pivalate, and isobutyl pivalate.

In the present invention, among them, an ether compound, a ketone compound, an aromatic hydrocarbon compound, an aliphatic hydrocarbon compound, or an ester compound is preferable, and an ester compound, a ketone compound, an aromatic hydrocarbon compound, or an ether compound is more preferable.

The number of carbon atoms of the compound that constitutes the dispersion medium is not particularly limited, and it is preferably 2 to 30, more preferably 4 to 20, still more preferably 6 to 15, and particularly preferably 7 to 12.

The dispersion medium preferably has low polarity (is preferably a low-polarity dispersion medium) in terms of dispersion characteristics of solid particles and in terms of preventing the deterioration (decomposition) of a sulfide-based inorganic solid electrolyte in a case where the sulfide-based inorganic solid electrolyte is used as the inorganic solid electrolyte.

The boiling point of the dispersion medium at normal pressure (1 atm) is not particularly limited; however, it is preferably 50° C. or higher, and it is more preferably 70° C. or higher. The upper limit thereof is preferably 250° C. or less and more preferably 220° C. or less.

The inorganic solid electrolyte-containing composition may contain one kind or two or more kinds of dispersion media. Examples of the dispersion medium including two or more types of dispersion media include xylene (a mixture of xylene isomers in which the mixing molar ratio between isomers is, ortho-isomer:para-isomer:meta-isomer=1:5:2) and mixed xylene (a mixture of o-xylene, p-xylene, m-xylene, and ethylbenzene).

The content of the dispersion medium in the inorganic solid electrolyte-containing composition is not particularly limited, and is, for example, preferably 10% to 80% by mass, more preferably 20% to 70% by mass, and still more preferably 25% to 50% by mass.

### <Active Material (AC)>

The inorganic solid electrolyte-containing composition according to the embodiment of the present invention may contain an active material capable of intercalating and deintercalating ions of a metal belonging to Group 1 or Group 2 in the periodic table. Examples of the active material, which will be described later, include a positive electrode active material and a negative electrode active material.

In the present invention, the inorganic solid electrolyte-containing composition containing an active material (a positive electrode active material or a negative electrode active material) may be referred to as an electrode composition (a positive electrode composition or a negative electrode composition).

### (Positive Electrode Active Material)

The positive electrode active material is an active material that is capable of intercalating and deintercalating an ion of a metal belonging to Group 1 or Group 2 of the periodic table, and it is preferably one capable of reversibly intercalating and deintercalating a lithium ion. The above-described material is not particularly limited as long as it has the above-described characteristics, and the material may be a transition metal oxide, an organic substance, an element capable of being complexed with Li, such as sulfur, or the like.

Among the above, as the positive electrode active material, transition metal oxides are preferably used, and transition metal oxides having a transition metal element M^{a} (one or more elements selected from Co, Ni, Fe, Mn, Cu, and V) are more preferable. In addition, an element Mb (an element of Group 1 (Ia) of the metal periodic table other than lithium, an element of Group 2 (IIa), or an element such as Al, Ga, In, Ge, Sn, Pb, Sb, Bi, Si, P, or B) may be mixed into this transition metal oxide. The mixing amount thereof is preferably 0% to 30% by mole of the amount (100% by mole) of the transition metal element M^{a}. It is more preferable that the transition metal oxide is synthesized by mixing the components such that a molar ratio Li/M^{a} is 0.3 to 2.2.

Specific examples of the transition metal oxides include transition metal oxides having a bedded salt-type structure (MA), transition metal oxides having a spinel-type structure (MB), lithium-containing transition metal phosphoric acid compounds (MC), lithium-containing transition metal halogenated phosphoric acid compounds (MD), and lithium-containing transition metal silicate compounds (ME).

Specific examples of the transition metal oxides having a bedded salt-type structure (MA) include LiCoO₂ (lithium cobalt oxide [LCO]), LiNi₂O₂ (lithium nickelate), LiNi_{0.85}Co_{0.10}Al_{0.05}O₂ (lithium nickel cobalt aluminum oxide [NCA]), LiNi_{1/3}Co_{1/3}Mn_{1/3}O₂ (lithium nickel manganese cobalt oxide [NMC]), and LiNi_{0.5}Mn_{0.5}O₂ (lithium manganese nickelate).

Specific examples of the transition metal oxides having a spinel-type structure (MB) include LiMn₂O₄ (LMO), LiCoMnO₄, Li₂FeMn₃O₈, Li₂CuMn₃O₈, Li₂CrMn₃O₈, and Li₂NiMn₃O₈.

Examples of the lithium-containing transition metal phosphoric acid compound (MC) include olivine-type iron phosphate salts such as LiFePO₄ and Li₃Fe₂(PO₄)₃, iron pyrophosphates such as LiFeP₂O₇, and cobalt phosphates such as LiCoPO₄, and a monoclinic NASICON type vanadium phosphate salt such as Li₃V₂(PO₄)₃ (lithium vanadium phosphate).

Examples of the lithium-containing transition metal halogenated phosphoric acid compound (MD) include an iron fluorophosphate such as Li₂FePO₄F, a manganese fluorophosphate such as Li₂MnPO₄F, and a cobalt fluorophosphate such as Li₂CoPO₄F.

Examples of the lithium-containing transition metal silicate compounds (ME) include Li₂FeSiO₄, Li₂MnSiO₄, and Li₂CoSiO₄.

In the present invention, the transition metal oxide having a bedded salt-type structure (MA) is preferable, and LCO or NMC is more preferable.

The shape of the positive electrode active material is not particularly limited, but it is preferable that the positive electrode active material has a particulate shape in the inorganic solid electrolyte-containing composition. In a case where the positive electrode active material has a particulate shape, the particle diameter (the volume average particle diameter) of the positive electrode active material is not particularly limited. For example, it can be set to 0.1 to 50 μm. The particle diameter of the positive electrode active material particle can be adjusted in the same manner as in the preparation of the particle diameter of the inorganic solid electrolyte, and the particle diameter thereof can be measured by the same measuring method as the method for the particle diameter of the inorganic solid electrolyte.

A positive electrode active material obtained using a baking method may be used after being washed with water, an acidic aqueous solution, an alkaline aqueous solution, or an organic solvent.

The positive electrode active material contained in the inorganic solid electrolyte-containing composition according to the embodiment of the present invention may be one kind or two or more kinds.

The content of the positive electrode active material in the inorganic solid electrolyte-containing composition is not particularly limited; however, it is preferably 10% to 97% by mass, more preferably 30% to 95% by mass, still more preferably 40% to 93% by mass, and particularly preferably 50% to 90% by mass, in 100% by mass of the solid content.

### (Negative Electrode Active Material)

The negative electrode active material is an active material that is capable of intercalating and deintercalating an ion of a metal belonging to Group 1 or Group 2 of the periodic table, and it is preferably one capable of reversibly intercalating and deintercalating a lithium ion. The material is not particularly limited as long as it has the above-described characteristics, and examples thereof include a carbonaceous material, a metal oxide, a metal composite oxide, a lithium single body, a lithium alloy, and a negative electrode active material that is capable of an alloy (capable of being alloyed) with lithium. Among the above, a carbonaceous material, a metal composite oxide, or a lithium single body is preferably used from the viewpoint of reliability. An active material that is capable of being alloyed with lithium is preferable since the capacity of the all-solid state secondary battery can be increased.

The carbonaceous material that is used as the negative electrode active material is a material substantially consisting of carbon. Examples thereof include petroleum pitch, carbon black such as acetylene black (AB), graphite (natural graphite, artificial graphite such as vapor-grown graphite), and carbonaceous material obtained by baking a variety of synthetic resins such as polyacrylonitrile (PAN)-based resins or furfuryl alcohol resins. Furthermore, examples thereof also include a variety of carbon fibers such as PAN-based carbon fibers, cellulose-based carbon fibers, pitch-based carbon fibers, vapor-grown carbon fibers, dehydrated polyvinyl alcohol (PVA)-based carbon fibers, lignin carbon fibers, vitreous carbon fibers, and activated carbon fibers, mesophase microspheres, graphite whisker, and tabular graphite.

These carbonaceous materials can be classified into non-graphitizable carbonaceous materials (also referred to as “hard carbon”) and graphitizable carbonaceous materials based on the graphitization degree. In addition, it is preferable that the carbonaceous material has the lattice spacing, density, and crystallite size described in JP1987-22066A (JP-S62-22066A), JP1990-6856A (JP-H2-6856A), and JP1991-45473A (JP-H3-45473A). The carbonaceous material is not necessarily a single material and, for example, may be a mixture of natural graphite and artificial graphite described in JP1993-90844A (JP-H5-90844A) or graphite having a coating layer described in JP1994-4516A (JP-H6-4516A).

As the carbonaceous material, hard carbon or graphite is preferably used, and graphite is more preferably used.

The oxide of a metal or a metalloid element that is applied as the negative electrode active material is not particularly limited as long as it is an oxide capable of intercalating and deintercalating lithium, and examples thereof include an oxide of a metal element (metal oxide), a composite oxide of a metal element or a composite oxide of a metal element and a metalloid element (collectively referred to as “metal composite oxide), and an oxide of a metalloid element (a metalloid oxide). The oxides are preferably noncrystalline oxides, and preferred examples thereof include chalcogenides which are reaction products between metal elements and elements in Group 16 of the periodic table. In the present invention, the metalloid element refers to an element having intermediate properties between those of a metal element and a non-metalloid element. Typically, the metalloid elements include six elements including boron, silicon, germanium, arsenic, antimony, and tellurium, and further include three elements including selenium, polonium, and astatine. In addition, “noncrystalline” represents an oxide having a broad scattering band with an apex in a range of 200 to 400 in terms of 20 value in case of being measured by an X-ray diffraction method using CuKα rays, and the oxide may have a crystalline diffraction line. The highest intensity in a crystalline diffraction line observed in a range of 40° to 70° in terms of 20 value is preferably 100 times or less and more preferably 5 times or less with respect to the intensity of a diffraction line at the apex in a broad scattering band observed in a range of 200 to 400 in terms of 20 value, and it is particularly preferable that the oxide does not have a crystalline diffraction line.

In the compound group consisting of the noncrystalline oxides and the chalcogenides, noncrystalline oxides of metalloid elements and chalcogenides are more preferable, and (composite) oxides consisting of one element or a combination of two or more elements selected from elements (for example, Al, Ga, Si, Sn, Ge, Pb, Sb, and Bi) belonging to Groups 13 (IIIB) to 15 (VB) in the periodic table or chalcogenides are particularly preferable. Specific examples of the preferred noncrystalline oxide and chalcogenide preferably include Ga₂O₃, GeO, PbO, PbO₂, Pb₂O₃, Pb₂O₄, Pb₃O₄, Sb₂O₃, Sb₂O₄, Sb₂O₈Bi₂O₃, Sb₂O₈Si₂O₃, Sb₂O₅, Bi₂O₃, Bi₂O₄, GeS, PbS, PbS₂, Sb₂S₃, and Sb₂S₅.

Suitable examples of the negative electrode active material which can be used in combination with a noncrystalline oxide containing Sn, Si, or Ge as a major component include a carbonaceous material capable of intercalating and/or deintercalating lithium ions or lithium metal, a lithium single body, a lithium alloy, and a negative electrode active material that is capable of being alloyed with lithium.

It is preferable that an oxide of a metal or a metalloid element, in particular, a metal (composite) oxide and the chalcogenide contain at least one of titanium or lithium as the constitutional component from the viewpoint of high current density charging and discharging characteristics. Examples of the metal composite oxide (lithium composite metal oxide) including lithium include a composite oxide of lithium oxide and the above metal (composite) oxide or the above chalcogenide, and specifically, Li₂SnO₂.

As the negative electrode active material, for example, a metal oxide (titanium oxide) having a titanium element is also preferable. Specifically, Li₄Ti₅O₁₂ (lithium titanium oxide [LTO]) is preferable since the volume variation during the intercalation and deintercalation of lithium ions is small, and thus the high-speed charging and discharging characteristics are excellent, and the deterioration of electrodes is suppressed, whereby it becomes possible to improve the life of the lithium ion secondary battery.

The lithium alloy as the negative electrode active material is not particularly limited as long as it is typically used as a negative electrode active material for a secondary battery, and examples thereof include a lithium aluminum alloy, and specifically, a lithium aluminum alloy, using lithium as a base metal, to which 10% by mass of aluminum is added.

The negative electrode active material capable of forming an alloy with lithium is not particularly limited as long as it is typically used as a negative electrode active material for a secondary battery. Such an active material has a large expansion and contraction due to charging and discharging of an all-solid state secondary battery, and accelerates a decrease in cycle characteristics. However, since the inorganic solid electrolyte-containing composition according to the embodiment of the present invention contains the above-described polymer binder (B) and compound (A), a decrease in cycle characteristics can be suppressed. Examples of such an active material include a (negative electrode) active material (an alloy or the like) having a silicon element or a tin element and a metal such as Al or In, a negative electrode active material (a silicon element-containing active material) having a silicon element capable of exhibiting high battery capacity is preferable, and a silicon element-containing active material in which the content of the silicon element is 50% by mole or more with respect to all the constitutional elements is more preferable.

In general, a negative electrode including the negative electrode active material (for example, a Si negative electrode including a silicon element-containing active material or an Sn negative electrode containing an active material containing a tin element) can intercalate a larger amount of Li ions than a carbon negative electrode (for example, graphite or acetylene black). That is, the amount of Li ions intercalated per unit mass increases. As a result, the battery capacity (the energy density) can be increased. As a result, there is an advantage in that the battery driving duration can be extended.

Examples of the silicon element-containing active material include a silicon-containing alloy (for example, LaSi₂, VSi₂, La—Si, Gd—Si, or Ni—Si) including a silicon material such as Si or SiOx (0<x≤1) and titanium, vanadium, chromium, manganese, nickel, copper, lanthanum, or the like or a structured active material thereof (for example, LaSi₂/Si), and an active material such as SnSiO₃ or SnSiS₃ including silicon element and tin element. It is noted that in addition, since SiOx itself can be used as a negative electrode active material (a metalloid oxide) and Si is produced along with the operation of an all-solid state secondary battery, SiOx can be used as a negative electrode active material (or a precursor material thereof) capable of being alloyed with lithium.

Examples of the negative electrode active material including the tin element include Sn, SnO, SnO₂, SnS, SnS₂, and the above-described active material including silicon element and tin element. In addition, a composite oxide with lithium oxide, for example, Li₂SnO₂ can also be used.

In the present invention, the above-described negative electrode active material can be used without any particular limitation. From the viewpoint of battery capacity, a preferred aspect as the negative electrode active material is a negative electrode active material that is capable of being alloyed with lithium. Among them, the silicon material or the silicon-containing alloy (the alloy containing a silicon element) described above is more preferable, and it is more preferable to include a negative electrode active material containing silicon (Si) or a silicon-containing alloy.

The chemical formulae of the compounds obtained by the above-described baking method can be calculated using an inductively coupled plasma (ICP) emission spectroscopy as a measuring method from the mass difference of powder before and after baking as a convenient method.

The shape of the negative electrode active material is not particularly limited, but it is preferably a particulate shape in the inorganic solid electrolyte-containing composition. In a case where the negative electrode active material has a particulate shape, the particle diameter of the negative electrode active material is not particularly limited; however, it is preferably 0.1 to 60 μm. The particle diameter of the negative electrode active material particle can be adjusted in the same manner as in the preparation of the particle diameter of the inorganic solid electrolyte, and the particle diameter thereof can be measured by the same measuring method as the method for the average particle diameter of the inorganic solid electrolyte.

The negative electrode active material contained in the inorganic solid electrolyte-containing composition according to the embodiment of the present invention may be one kind or two or more kinds.

The content of the negative electrode active material in the inorganic solid electrolyte-containing composition is not particularly limited, and it is preferably 10% to 90% by mass, more preferably 20% to 85% by mass, still more preferably 30% to 80% by mass, and even still more preferably 40% to 75% by mass, in 100% by mass of the solid content.

In the present invention, in a case where a negative electrode active material layer is formed by charging a secondary battery, ions of a metal belonging to Group 1 or Group 2 in the periodic table, generated in the all-solid state secondary battery, can be used instead of the negative electrode active material. By bonding the ions to electrons and precipitating a metal, a negative electrode active material layer can be formed.

### (Coating of Active Material)

The surfaces of the positive electrode active material and the negative electrode active material may be subjected to surface coating with another metal oxide. Examples of the surface coating agent include metal oxides and the like containing Ti, Nb, Ta, W, Zr, Al, Si, or Li. Examples thereof include titanium oxide spinel, tantalum-based oxides, niobium-based oxides, and lithium niobate-based compounds, and specific examples thereof include Li₄Ti₅O₁₂, Li₂Ti₂O₅, LiTaO₃, LiNbO₃, LiAlO₂, Li₂ZrO₃, Li₂WO₄, Li₂TiO₃, Li₂B₄O₇, Li₃PO₄, Li₂MoO₄, Li₃BO₃, LiBO₂, Li₂CO₃, Li₂SiO₃, SiO₂, TiO₂, ZrO₂, Al₂O₃, and B₂O₃.

In addition, the surface of the electrode containing the positive electrode active material or negative electrode active material may be subjected to a surface treatment with sulfur or phosphorus.

Furthermore, the particle surface of the positive electrode active material or negative electrode active material may be subjected to a surface treatment with an actinic ray or an active gas (plasma or the like) before and after the surface coating.

### <Conductive Auxiliary Agent>

The inorganic solid electrolyte-containing composition according to the embodiment of the present invention may contain a conductive auxiliary agent.

The conductive auxiliary agent is not particularly limited, and conductive auxiliary agents that are known as ordinary conductive auxiliary agents can be used. It may be, for example, graphites such as natural graphite and artificial graphite, carbon blacks such as acetylene black, Ketjen black, and furnace black, amorphous carbons such as needle cokes, carbon fibers such as a vapor-grown carbon fiber and a carbon nanotube, or carbonaceous materials such as graphene or fullerene, which are electron-conductive materials, and it may be also a metal powder or metal fiber of copper, nickel, or the like. A conductive polymer such as polyaniline, polypyrrole, polythiophene, polyacetylene, or a polyphenylene derivative may also be used.

In the present invention, in a case where the active material is used in combination with the conductive auxiliary agent, among the above-described conductive auxiliary agents, a conductive auxiliary agent that does not intercalate and deintercalate ions (preferably Li ions) of a metal belonging to Group 1 or Group 2 in the periodic table and does not function as an active material at the time of charging and discharging of the battery is classified as the conductive auxiliary agent. Therefore, among the conductive auxiliary agents, a conductive auxiliary agent that can function as the active material in the active material layer at the time of charging and discharging of the battery is classified as an active material but not as a conductive auxiliary agent. Whether or not the conductive auxiliary agent functions as the active material at the time of charging and discharging of a battery is not unambiguously determined but is determined by the combination with the active material.

The conductive auxiliary agent preferably has a particulate shape in the inorganic solid electrolyte-containing composition. In a case where the conductive auxiliary agent has a particulate shape, the particle diameter (volume average particle diameter) of the conductive auxiliary agent is not particularly limited; however, it is, for example, preferably 0.02 to 1.0 μm and more preferably 0.03 to 0.5 μm. The particle diameter of the conductive auxiliary agent can be adjusted in the same manner as in the adjustment of the particle diameter of the inorganic solid electrolyte, and the particle diameter thereof can be measured by the same measuring method as the method for the particle diameter of the inorganic solid electrolyte.

The inorganic solid electrolyte-containing composition may contain one kind or two or more kinds of conductive auxiliary agents.

In a case where the inorganic solid electrolyte-containing composition according to the embodiment of the present invention contains a conductive auxiliary agent, the content of the conductive auxiliary agent in the inorganic solid electrolyte-containing composition is preferably 0% to 10% by mass, and more preferably 1% to 5% by mass, with respect to 100% by mass of the solid content.

### <Lithium Salt>

The inorganic solid electrolyte-containing composition according to the embodiment of the present invention preferably contains a lithium salt (a supporting electrolyte) as well. Generally, the lithium salt is preferably a lithium salt that is used for this kind of product and is not particularly limited. For example, lithium salts described in paragraphs 0082 to 0085 of JP2015-088486A are preferable. In a case where the inorganic solid electrolyte-containing composition according to the embodiment of the present invention contains a lithium salt, the content of the lithium salt is preferably 0.1 part by mass or more and more preferably 5 parts by mass or more with respect to 100 parts by mass of the solid electrolyte. The upper limit thereof is preferably 50 parts by mass or less and more preferably 20 parts by mass or less.

### <Dispersant>

Since the above-described polymer binder functions as a dispersing agent as well, the inorganic solid electrolyte-containing composition according to the embodiment of the present invention may not contain a dispersing agent other than this polymer binder; however, it may contain a dispersing agent. As the dispersing agent, a dispersing agent that is generally used for an all-solid state secondary battery can be appropriately selected and used. In general, a compound intended for particle adsorption and steric repulsion and/or electrostatic repulsion is suitably used.

### <Other Additives>

As components other than the respective components described above, the inorganic solid electrolyte-containing composition according to the embodiment of the present invention may appropriately contain an ionic liquid, a thickener, a crosslinking agent (an agent causing a crosslinking reaction by radical polymerization, condensation polymerization, or ring-opening polymerization), a polymerization initiator (an agent that generates an acid or a radical by heat or light), an antifoaming agent, a leveling agent, a dehydrating agent, or an antioxidant. The ionic liquid is contained in order to further improve the ion conductivity, and the known one in the related art can be used without particular limitation. In addition, a polymer other than the binder forming polymer described above, a typically used binder, or the like may be contained.

### (Preparation of Inorganic Solid Electrolyte-Containing Composition)

The inorganic solid electrolyte-containing composition according to the embodiment of the present invention can be prepared as a mixture, preferably as a slurry, by mixing the inorganic solid electrolyte (SE), the polymer binder (B), the compound (A), the dispersion medium (D), and optionally, a conductive auxiliary agent, a lithium salt, and any other components, for example, with various mixers that are generally used. Here, in the present invention, it is preferable that the compound (A) is actively mixed with the solid particles such as the inorganic solid electrolyte (SE) and the polymer binder (B). In this manner, the adhesiveness between the solid particles and the polymer binder (B) can be reinforced. In the case of the electrode composition, an active material is further mixed.

The mixing method is not particularly limited, and it can be carried out using a publicly known mixer such as a ball mill, a beads mill, a planetary mixer, a blade mixer, a roll mill, a kneader, a disc mill, a planetary centrifugal mixer, or a narrow gap type disperser.

The mixing conditions are not particularly limited either. For example, each of the above-described components may be mixed collectively or may be mixed sequentially. The mixing conditions are not particularly limited. The mixing temperature is preferably a temperature at which at least the compound (A) does not volatilize during mixing, and it can be, for example, 15° C. to 50° C. In addition, the rotation speed of the planetary centrifugal mixer or the like can be set to 200 to 3,000 rpm. The mixing atmosphere may be any atmosphere such as atmospheric air, dry air (the dew point: −20° C. or lower), or inert gas (for example, an argon gas, a helium gas, or a nitrogen gas). Since the inorganic solid electrolyte easily reacts with moisture, the mixing is preferably carried out under dry air or in an inert gas.

Since the inorganic solid electrolyte-containing composition according to the embodiment of the present invention has excellent dispersion stability, the inorganic solid electrolyte-containing composition can be stored after preparation, and it is not necessary to prepare the inorganic solid electrolyte-containing composition each time it is used.

[Sheet for all-Solid State Secondary Battery]

A sheet for an all-solid state secondary battery according to the embodiment of the present invention is a sheet-shaped molded body with which a constitutional layer of an all-solid state secondary battery can be formed, and it includes various aspects depending on use applications thereof. Examples of thereof include a sheet that is preferably used in a solid electrolyte layer (also referred to as a solid electrolyte sheet for an all-solid state secondary battery) and a sheet that is preferably used in an electrode or a laminate of an electrode and a solid electrolyte layer (an electrode sheet for an all-solid state secondary battery). In the present invention, the variety of sheets described above will be collectively referred to as a sheet for an all-solid state secondary battery.

In the present invention, each layer that constitutes a sheet for an all-solid state secondary battery may have a monolayer structure or a multilayer structure.

In the sheet for an all-solid state secondary battery, the solid electrolyte layer or the active material layer on the base material is formed of (constituted by) the inorganic solid electrolyte-containing composition according to the embodiment of the present invention. The layer formed of the inorganic solid electrolyte-containing composition according to the embodiment of the present invention is formed of a component (excluding the dispersion medium (D)) derived from the inorganic solid electrolyte-containing composition, and is usually firmly adhered (bound) in a state where the solid particles (the inorganic solid electrolyte (SE), the active material (AC), and the conductive auxiliary agent (AC) as appropriate) and the polymer binder (B) and the compound (A) are mixed with each other.

In a case where the sheet for an all-solid state secondary battery is incorporated into an all-solid state secondary battery as it is or by appropriately peeling off a base material, the cycle characteristics and the conductivity (the lower resistance) of the all-solid state secondary battery can be improved.

The solid electrolyte sheet for an all-solid state secondary battery according to the embodiment of the present invention is only required to be a sheet having a solid electrolyte layer, and it may be a sheet in which a solid electrolyte layer is formed on a base material or may be a sheet (a sheet from which the base material has been peeled off) that is formed of a solid electrolyte layer without including a base material. The solid electrolyte sheet for an all-solid state secondary battery may include another layer in addition to the solid electrolyte layer. Examples of the other layer include a protective layer (a stripping sheet), a collector, and a coating layer. The solid electrolyte layer included in the solid electrolyte sheet for all-solid state secondary battery is preferably formed of the inorganic solid electrolyte-containing composition according to the embodiment of the present invention. The content of each component in the solid electrolyte layer is not particularly limited; however, it preferably has the same meaning as the content of each component in the solid content of the inorganic solid electrolyte-containing composition according to the embodiment of the present invention. The content of the compound (A) in the solid electrolyte layer is the same as the content of the compound (A) in the inorganic solid electrolyte-containing composition according to the embodiment of the present invention with respect to 100% by mass of the solid content and the content of the compound (A) with respect to the inorganic solid electrolyte (SE) or the polymer binder (B). The layer thickness of each layer that constitutes the solid electrolyte sheet for an all-solid state secondary battery is the same as the layer thickness of each layer described later in the all-solid state secondary battery.

The base material is not particularly limited as long as it can support the solid electrolyte layer, and examples thereof include a sheet body (plate-shaped body) formed of materials described later regarding the collector, an organic material, an inorganic material, or the like. Examples of the organic materials include various polymers, and specific examples thereof include polyethylene terephthalate, polypropylene, polyethylene, and cellulose. Examples of the inorganic materials include glass and ceramic.

The electrode sheet for an all-solid state secondary battery according to the embodiment of the present invention (simply also referred to as an “electrode sheet”) is only required to be an electrode sheet including an active material layer, and it may be a sheet in which an active material layer is formed on a base material (collector) or may be a sheet (a sheet from which the base material has been peeled off) that is formed of an active material layer without including a base material. The electrode sheet is typically a sheet including the collector and the active material layer, and examples of an aspect thereof include an aspect including the collector, the active material layer, and the solid electrolyte layer in this order and an aspect including the collector, the active material layer, the solid electrolyte layer, and the active material layer in this order. The solid electrolyte layer and the active material layer included in the electrode sheet are preferably formed of the inorganic solid electrolyte-containing composition according to the embodiment of the present invention. The content of each component in this solid electrolyte layer or active material layer is not particularly limited; however, it preferably has the same meaning as the content of each component in the solid content of the inorganic solid electrolyte-containing composition (the electrode composition) according to the embodiment of the present invention. In addition, the content of the compound (A) in each layer is the same as the content of the compound (A) in the inorganic solid electrolyte-containing composition according to the embodiment of the present invention with respect to 100% by mass of the solid content, and the content of the compound (A) with respect to the inorganic solid electrolyte (SE) or the polymer binder (B). The content of the compound (A) in each layer can be measured by a method described in Examples. The layer thickness of each of the layers forming the electrode sheet according to the embodiment of the present invention is the same as the layer thickness of each of the layers described below regarding the all-solid state secondary battery. The electrode sheet may include the above-described other layer.

It is noted that in a case where the solid electrolyte layer or the active material layer is not formed of the inorganic solid electrolyte-containing composition according to the embodiment of the present invention, it is formed of a general constitutional layer forming material.

In the sheet for an all-solid state secondary battery according to the embodiment of the present invention, at least one of the constitutional layers is formed of the inorganic solid electrolyte-containing composition according to the embodiment of the present invention. Therefore, the sheet for an all-solid state secondary battery according to the embodiment of the present invention includes a constitutional layer having a flat surface, in which solid particles which are uniformly disposed are firmly bound while an increase in the interface resistance of the solid particles is suppressed. Therefore, in a case where this constitutional layer is incorporated into an all-solid state secondary battery, it is possible to realize excellent cycle characteristics and low resistance (high conductivity) of the all-solid state secondary battery. In addition, in the electrode sheet for an all-solid state secondary battery, in which the active material layer is formed on the collector, it is possible to firmly adhere the active material layer to a collector. As described above, the sheet for an all-solid state secondary battery according to the embodiment of the present invention is suitably used as a sheet-shaped member that is incorporated as a constitutional layer of an all-solid state secondary battery.

It is noted that in a case where the solid electrolyte layer or the active material layer is not formed of the inorganic solid electrolyte-containing composition according to the embodiment of the present invention, it is formed of a general constitutional layer forming material.

[Manufacturing Method for Sheet for all-Solid State Secondary Battery]

The manufacturing method for a sheet for an all-solid state secondary battery according to the embodiment of the present invention is not particularly limited, and the sheet can be manufactured by forming the above-described constitutional layers using the inorganic solid electrolyte-containing composition according to the embodiment of the present invention. Examples thereof include a method in which the film formation (the coating and drying) is carried out preferably on a base material or a collector (the other layer may be interposed) to form a layer (a coated and dried layer) consisting of an inorganic solid electrolyte-containing composition. This method makes it possible to produce a sheet for an all-solid state secondary battery having a base material or a collector and having a coated and dried layer. In particular, in a case where the inorganic solid electrolyte-containing composition (electrode composition) according to the embodiment of the present invention is formed into a film on a collector to produce a sheet for an all-solid state secondary battery, the adhesion between the collector and the active material layer can be enhanced.

Here, the coated and dried layer refers to a layer formed by carrying out coating with the inorganic solid electrolyte-containing composition according to the embodiment of the present invention and drying the dispersion medium (D) (that is, a layer formed using the inorganic solid electrolyte-containing composition according to the embodiment of the present invention and consisting of a composition obtained by removing the dispersion medium (D) from the inorganic solid electrolyte-containing composition according to the embodiment of the present invention). In the constitutional layer and the coated and dried layer, the dispersion medium (D) may remain within a range where the effect of the present invention is not impaired, and the residual amount thereof, for example, in each of the layers may be 3% by mass or lower.

In the manufacturing method for a sheet for an all-solid state secondary battery according to the embodiment of the present invention, each of the steps such as coating and drying will be described in the following manufacturing method for an all-solid state secondary battery.

In the manufacturing method for a sheet for an all-solid state secondary battery according to the embodiment of the present invention, the coated and dried layer obtained as described above can be pressurized. The pressurizing condition and the like will be described later in the section of the manufacturing method for an all-solid state secondary battery.

In addition, in the manufacturing method for a sheet for an all-solid state secondary battery according to the embodiment of the present invention, the base material, the protective layer (particularly stripping sheet), or the like can also be stripped.

### [All-Solid State Secondary Battery]

The all-solid state secondary battery according to the embodiment of the present invention includes a positive electrode active material layer, a negative electrode active material layer facing the positive electrode active material layer, and a solid electrolyte layer disposed between the positive electrode active material layer and the negative electrode active material layer. The all-solid state secondary battery according to the embodiment of the present invention is not particularly limited in the configuration as long as it has a solid electrolyte layer between the positive electrode active material layer and the negative electrode active material layer, and for example, a publicly known configuration that relates to an all-solid state secondary battery can be employed. The positive electrode active material layer is preferably formed on a positive electrode collector to constitute a positive electrode. The negative electrode active material layer is preferably formed on a negative electrode collector to configure a negative electrode. In the present invention, each constitutional layer (including a collector and the like) that constitutes an all-solid state secondary battery may have a monolayer structure or a multilayer structure.

It is preferable that at least one of the solid electrolyte layer, the negative electrode active material layer, or the positive electrode active material layer is formed of the inorganic solid electrolyte-containing composition according to the embodiment of the present invention. In addition, one of the preferred aspects is that both the negative electrode active material layer and the positive electrode active material layer are formed of the inorganic solid electrolyte-containing composition according to the embodiment of the present invention. In addition, it is preferable that any one of the negative electrode (a laminate of a negative electrode collector and a negative electrode collector) and the positive electrode (a laminate of a positive electrode collector and a positive electrode collector), preferably the positive electrode is formed of the electrode sheet for an all-solid state secondary battery according to the embodiment of the present invention, and an aspect in which both of them are formed of the electrode sheet for an all-solid state secondary battery according to the embodiment of the present invention is also one of the preferred aspects. In the present invention, an aspect in which all of the layers are formed of the inorganic solid electrolyte-containing composition according to the aspect of the present invention is also one of the preferred aspects. In a case where the active material layer or the solid electrolyte layer is not formed of the inorganic solid electrolyte-containing composition according to the embodiment of the present invention, a known material, a composition containing the polymer binder used in the present invention, or the like can be used.

Since the all-solid state secondary battery according to the embodiment of the present invention, in which at least one of the solid electrolyte layer, the negative electrode active material layer, or the positive electrode active material layer is formed of the inorganic solid electrolyte-containing composition according to the embodiment of the present invention, exhibits low resistance and high ion conductivity, a large current can also be extracted.

### <Positive Electrode Active Material Layer, Solid Electrolyte Layer, and Negative Electrode Active Material Layer>

In the solid electrolyte layer and the active material layer formed of the inorganic solid electrolyte-containing composition according to the embodiment of the present invention, the kinds of components to be contained and the contents thereof are preferably the same as the solid content of the inorganic solid electrolyte-containing composition according to the embodiment of the present invention. In addition, the content of the compound (A) in each layer is the same as the content of the compound (A) in the inorganic solid electrolyte-containing composition according to the embodiment of the present invention with respect to 100% by mass of the solid content, and the content of the compound (A) with respect to the inorganic solid electrolyte (SE) or the polymer binder (B). The content of the compound (A) in each layer can be measured by a method described in Examples.

The thickness of each of the negative electrode active material layer, the solid electrolyte layer, and the positive electrode active material layer is not particularly limited. In case of taking a dimension of a general all-solid state secondary battery into account, the thickness of each of the layers is preferably 10 to 1,000 μm and more preferably 20 μm or more and less than 500 μm. In the all-solid state secondary battery according to the embodiment of the present invention, the thickness of at least one layer of the positive electrode active material layer or the negative electrode active material layer is still more preferably 50 μm or more and less than 500 μm.

### <Collector>

Each of the positive electrode active material layer and the negative electrode active material layer may include a collector on the side opposite to the solid electrolyte layer. The positive electrode collector and the negative electrode collector are preferably an electron conductor.

In the present invention, any one of the positive electrode collector or the negative electrode collector, or collectively both of them may be simply referred to as the collector.

As a material that forms the positive electrode collector, not only aluminum, an aluminum alloy, stainless steel, nickel, or titanium but also a material (a material on which a thin film has been formed) obtained by treating the surface of aluminum or stainless steel with carbon, nickel, titanium, or silver is preferable. Among the above, aluminum or an aluminum alloy is more preferable.

As a material that forms the negative electrode collector, aluminum, copper, a copper alloy, stainless steel, nickel, titanium, or the like, and further, a material obtained by treating the surface of aluminum, copper, a copper alloy, or stainless steel with carbon, nickel, titanium, or silver is preferable, and aluminum, copper, a copper alloy, or stainless steel is more preferable.

Regarding the shape of the collector, a film sheet shape is typically used; however, it is also possible to use a collector having a shape a net shape or a punched shape, or a collector of a lath body, a porous body, a foaming body, a molded body of a fiber group, or the like.

The thickness of the collector is not particularly limited, but it is preferably 1 to 500 μm. In addition, protrusions and recesses are preferably provided on the surface of the collector by carrying out a surface treatment.

### <Other Configurations>

In the present invention, a functional layer, a functional member, or the like may be appropriately interposed or disposed between or on the outside of the respective layers of the negative electrode collector, the negative electrode active material layer, the solid electrolyte layer, the positive electrode active material layer, and the positive electrode collector.

### <Housing>

Depending on the use application, the all-solid state secondary battery according to the embodiment of the present invention may be used as the all-solid state secondary battery having the above-described structure as it is but is preferably sealed in an appropriate housing to be used in the form of a dry cell. The housing may be a metallic housing or a resin (plastic) housing. In a case where a metallic housing is used, examples thereof include an aluminum alloy housing and a stainless steel housing. It is preferable that the metallic housing is classified into a positive electrode-side housing and a negative electrode-side housing and that the positive electrode-side housing and the negative electrode-side housing are electrically connected to the positive electrode collector and the negative electrode collector, respectively. The positive electrode-side housing and the negative electrode-side housing are preferably integrated by being joined together through a gasket for short circuit prevention.

<Preferred Embodiment of all-Solid State Secondary Battery>

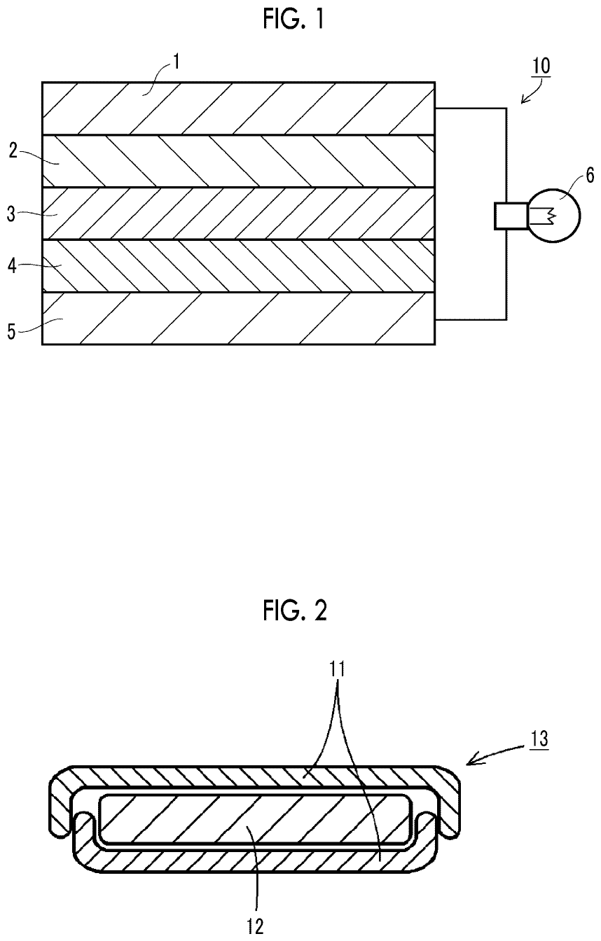

Hereinafter, the all-solid state secondary battery according to the preferred embodiment of the present invention will be described with reference to FIG. 1; however, the present invention is not limited thereto.

FIG. 1 is a cross-sectional view schematically illustrating an all-solid state secondary battery (a lithium ion secondary battery) according to a preferred embodiment of the present invention. In a case of being seen from the negative electrode side, an all-solid state secondary battery 10 of the present embodiment includes a negative electrode collector 1, a negative electrode active material layer 2, a solid electrolyte layer 3, a positive electrode active material layer 4, and a positive electrode collector 5 in this order. The respective layers are in contact with each other, and thus structures thereof are adjacent. In a case in which the above-described structure is employed, during charging, electrons (e⁻) are supplied to the negative electrode side, and lithium ions (Li⁺) are accumulated on the negative electrode side. On the other hand, during discharging, the lithium ions (Li⁺) accumulated in the negative electrode return to the positive electrode side, and electrons are supplied to an operation portion 6. In an example illustrated in the drawing, an electric bulb is employed as a model at the operation portion 6 and is lit by discharging.

In a case where the all-solid state secondary battery having a layer configuration illustrated in FIG. 1 is put into a 2032-type coin case 11 (for example, see FIG. 2), the all-solid state secondary battery will be referred to as a laminate 12 for an all-solid state secondary battery, and a battery produced by putting this laminate 12 for an all-solid state secondary battery into a 2032-type coin case 11 will be referred to as a (coin type) all-solid state secondary battery 13, thereby referring to both batteries distinctively in some cases.

### (Positive Electrode Active Material Layer, Solid Electrolyte Layer, and Negative Electrode Active Material Layer)

In the all-solid state secondary battery 10, all of the positive electrode active material layer 4, the solid electrolyte layer 3, and the negative electrode active material layer 2 are formed of the inorganic solid electrolyte-containing composition of the embodiment of the present invention. The inorganic solid electrolyte (SE), the polymer binder (B), and the compound (A) contained in the positive electrode active material layer 4, the solid electrolyte layer 3, and the negative electrode active material layer 2 may be the same as or different from each other. In addition, the types of the conductive auxiliary agents contained in the positive electrode active material layer 4 and the negative electrode active material layer 2 may be the same or different from each other.

In the present invention, any one of the positive electrode active material layer and the negative electrode active material layer, or collectively both of them may be simply referred to as the active material layer or the electrode active material layer. In addition, in the present invention, any one of the positive electrode active material and the negative electrode active material, or collectively both of them may be simply referred to as an active material or an electrode active material.

The solid electrolyte layer contains an inorganic solid electrolyte (SE) having an ion conductivity of a metal belonging to Group 1 or Group 2 in the periodic table, the above-described polymer binder (B), the above-described compound (A), and any component described above within a range where the effect of the present invention is not impaired, and typically does not contain a positive electrode active material and/or a negative electrode active material.

The positive electrode active material layer and the negative electrode active material layer each contain an inorganic solid electrolyte (SE) having an ion conductivity of a metal belonging to Group 1 or Group 2 in the periodic table, the above-described polymer binder (B), the above-described compound (A), the active material (AC), preferably a conductive auxiliary agent, and any of the above-described components within a range where the effect of the present invention is not impaired.

In the all-solid state secondary battery 10, the negative electrode active material layer can be a lithium metal layer. Examples of the lithium metal layer include a layer formed by depositing or molding a lithium metal powder, a lithium foil, and a lithium vapor deposition film. The thickness of the lithium metal layer can be, for example, 1 to 500 μm regardless of the thickness of the above-described negative electrode active material layer.

In the present invention, in a case where the constitutional layer is formed of the inorganic solid electrolyte-containing composition according to the embodiment of the present invention, it is possible to realize an all-solid state secondary battery having excellent cycle characteristics and low resistance.

### (Collector)

The positive electrode collector 5 and the negative electrode collector 1 are as described above.

In a case where the all-solid state secondary battery 10 has a constitutional layer other than the constitutional layer formed of the inorganic solid electrolyte-containing composition according to the embodiment of the present invention, a layer formed of a known constitutional layer forming material can also be applied.

In addition, each layer may be composed of a single layer or multiple layers.

[Manufacture of all-Solid State Secondary Battery]

The all-solid state secondary battery can be manufactured according to a conventional method. Specifically, the all-solid state secondary battery can be manufactured by forming each of the layers described above using the inorganic solid electrolyte-containing composition of the embodiment of the present invention or the like.

Specifically, the all-solid state secondary battery according to the embodiment of the present invention can be manufactured by carrying out a method (a manufacturing method for a sheet for an all-solid state secondary battery according to the embodiment of the present invention) which includes (is carried out through) a step of coating an appropriate base material (for example, a metal foil which serves as a collector) with the inorganic solid electrolyte-containing composition according to the embodiment of the present invention and forming a coating film (forming a film).

More specifically, an inorganic solid electrolyte-containing composition containing a positive electrode active material is applied and dried as a material for a positive electrode (a positive electrode composition) onto a metal foil which is a positive electrode collector, to form a positive electrode active material layer, thereby producing a positive electrode sheet for an all-solid state secondary battery. Next, the inorganic solid electrolyte-containing composition for forming a solid electrolyte layer is applied and dried onto the positive electrode active material layer to form the solid electrolyte layer. Furthermore, an inorganic solid electrolyte-containing composition containing a negative electrode active material is applied and dried as a negative electrode material (a negative electrode composition) onto the solid electrolyte layer, to form a negative electrode active material layer. A negative electrode collector (a metal foil) is overlaid on the negative electrode active material layer, whereby it is possible to obtain an all-solid state secondary battery having a structure in which the solid electrolyte layer is sandwiched between the positive electrode active material layer and the negative electrode active material layer. A desired all-solid state secondary battery can also be manufactured by sealing the all-solid state secondary battery in a housing.

In addition, it is also possible to manufacture an all-solid state secondary battery by carrying out the forming method of each layer in reverse order to form a negative electrode active material layer, a solid electrolyte layer, and a positive electrode active material layer on a negative electrode collector and superposing a positive electrode collector thereon.

As another method, the following method can be exemplified. That is, the positive electrode sheet for an all-solid state secondary battery is produced as described above. In addition, an inorganic solid electrolyte-containing composition containing a negative electrode active material is applied and dried as a negative electrode material (a negative electrode composition) onto a metal foil which is a negative electrode collector, to form a negative electrode active material layer, thereby producing a negative electrode sheet for an all-solid state secondary battery. Next, a solid electrolyte layer is formed on the active material layer in any one of these sheets as described above. Furthermore, the other one of the positive electrode sheet for an all-solid state secondary battery and the negative electrode sheet for an all-solid state secondary battery is laminated on the solid electrolyte layer such that the solid electrolyte layer and the active material layer come into contact with each other. In this manner, an all-solid state secondary battery can be manufactured.

As still another method, for example, the following method can be used. That is, the positive electrode sheet for an all-solid state secondary battery and the negative electrode sheet for an all-solid state secondary battery are prepared as described above. In addition, separately from the positive electrode sheet for an all-solid state secondary battery and the negative electrode sheet for an all-solid state secondary battery, an inorganic solid electrolyte-containing composition is applied onto a base material, thereby producing a solid electrolyte sheet for all-solid state secondary battery consisting of a solid electrolyte layer. Further, the positive electrode sheet for an all-solid state secondary battery and the negative electrode sheet for an all-solid state secondary battery are laminated such that the solid electrolyte layer removed from the base material is sandwiched therebetween. In this manner, an all-solid state secondary battery can be manufactured.

Furthermore, a positive electrode sheet for an all-solid state secondary battery, a negative electrode sheet for an all-solid state secondary battery, and a solid electrolyte sheet for an all-solid state secondary battery are produced as described above. Next, the positive electrode sheet for an all-solid state secondary battery or negative electrode sheet for an all-solid state secondary battery, and the solid electrolyte sheet for an all-solid state secondary battery are overlaid and pressurized into a state where the positive electrode active material layer or the negative electrode active material layer is brought into contact with the solid electrolyte layer. In this way, the solid electrolyte layer is transferred to the positive electrode sheet for an all-solid state secondary battery or the negative electrode sheet for an all-solid state secondary battery. Then, the solid electrolyte layer from which the base material of the solid electrolyte sheet for an all-solid state secondary battery has been peeled off and the negative electrode sheet for an all-solid state secondary battery or positive electrode sheet for an all-solid state secondary battery are overlaid and pressurized (into a state where the negative electrode active material layer or positive electrode active material layer is brought into contact with the solid electrolyte layer). In this way, an all-solid state secondary battery can be manufactured. The pressurizing method and the pressurizing conditions in this method are not particularly limited, and a method and pressurizing conditions described in the pressurization step, which will be described later, can be applied.

The solid electrolyte layer or the like can also be formed by, for example, forming an inorganic solid electrolyte-containing composition or the like on a base material or an active material layer by pressurization molding under pressurizing conditions described later.

In the above-described manufacturing method, the inorganic solid electrolyte-containing composition according to the embodiment of the present invention may be used in any one of the inorganic solid electrolyte-containing composition, the positive electrode composition, or the negative electrode composition, or may be used in all of the compositions.

In a case where the solid electrolyte layer or the active material layer is formed of a composition other than the inorganic solid electrolyte-containing composition according to the embodiment of the present invention, examples thereof include a typically used composition. In addition, the negative electrode active material layer can also be formed by binding ions of a metal belonging to Group 1 or Group 2 in the periodic table, which are accumulated on a negative electrode collector during initialization described later or during charging for use, without forming the negative electrode active material layer during the manufacturing of the all-solid state secondary battery to electrons and precipitating the ions on a negative electrode collector the like as a metal.

### <Formation (Film Formation) of Each Layer>

The method of applying the inorganic solid electrolyte-containing composition is not particularly limited and can be appropriately selected. Examples thereof include coating (preferably wet-type coating), spray coating, spin coating, dip coating, slit coating, stripe coating, and bar coating. The coating temperature is not particularly limited, but is preferably at least a temperature at which the compound (A) does not volatilize, and examples thereof include a temperature range (for example, 15° C. to 30° C.) of about room temperature under non-heating conditions.

The applied inorganic solid electrolyte-containing composition is subjected to a drying treatment (heating treatment). In the drying treatment, the dispersion medium (D) is usually removed (volatilized) without removing (volatilizing) the compound (A) in the coated inorganic solid electrolyte-containing composition. The heating treatment may be carried out after each of the inorganic solid electrolyte-containing compositions is applied or after the inorganic solid electrolyte-containing compositions are applied in multiple layers.

The drying conditions are not particularly limited as long as the dispersion medium (D) can be removed without removing the compound (A), and can be appropriately selected in consideration of the boiling points and contents of the compound (A) and the dispersion medium (D), the adsorptivity of the compound (A) with respect to the polymer binder (B) and the solid particles, and the like. For example, the drying temperature is preferably 30° C. or higher, more preferably 60° C. or higher, and still more preferably 80° C. or higher. The upper limit thereof is preferably 200° C. or less, more preferably 150° C. or less, and still more preferably 120° C. or less. By heating in such a temperature range, the dispersion medium (D) can be removed without removing the compound (A), and the solid state (coated and dried layer) can be obtained. The temperature range is preferable since the temperature is not excessively increased and each member of the all-solid state secondary battery is not impaired. As a result, excellent overall performance is exhibited in the all-solid state secondary battery, and it is possible to obtain good binding properties and good ion conductivity.

After applying the inorganic solid electrolyte-containing composition, it is preferable to pressurize each layer or the all-solid state secondary battery after superimposing the constitutional layers or producing the all-solid state secondary battery. In addition, each of the layers is also preferably pressurized together in a state of being laminated. Examples of the pressurizing methods include a method using a hydraulic cylinder press machine. The pressurizing force is not particularly limited; however, it is generally preferably in a range of 5 to 1,500 MPa.

In addition, the applied inorganic solid electrolyte-containing composition may be heated at the same time with the pressurization. The heating temperature is not particularly limited, and is generally in a range of 30° C. to 300° C.; however, it is set to a temperature at which the compound (A) is not removed in consideration of the boiling point of the compound (A), the pressure force, and the like. The press can also be applied at a temperature higher than the glass transition temperature of the inorganic solid electrolyte. It is also possible to carry out the press at a temperature higher than the glass transition temperature of the polymer contained in the polymer binder. However, in general, the temperature does not exceed the melting point of this polymer.

The pressurization may be carried out in a state where the coating solvent or dispersion medium has been dried in advance or in a state where the solvent or the dispersion medium remains.

The respective compositions may be applied at the same time, and the application, the drying, and the pressing may be carried out simultaneously and/or sequentially. Each of the compositions may be applied onto each of the separate base materials and then laminated by carrying out the transfer.

The atmosphere in the film forming method (coating, drying, and pressurization (under heating) is not particularly limited and may be any atmosphere such as atmospheric air, dry air (the dew point: −20° C. or less), or inert gas (for example, an argon gas, a helium gas, or a nitrogen gas).

The pressurization time may be a short time (for example, within several hours) under the application of a high pressure or a long time (one day or longer) under the application of an intermediate pressure. In case of members other than the sheet for an all-solid state secondary battery, for example, the all-solid state secondary battery, it is also possible to use a restraining tool (screw fastening pressure or the like) of the all-solid state secondary battery in order to continuously apply an intermediate pressure. The pressing pressure may be a pressure that is uniform or varies with respect to a portion under pressure such as a sheet surface. The pressing pressure may be changed according to the area or the film thickness of the portion under pressure. In addition, the pressure may also be variable stepwise for the same portion. A pressing surface may be flat or roughened.

### <Initialization>

The all-solid state secondary battery manufactured as described above is preferably initialized after the manufacturing or before use. The initialization is not particularly limited, and it is possible to initialize the all-solid state secondary battery by, for example, carrying out initial charging and discharging in a state where the pressing pressure is increased and then releasing the pressure until it reaches a general working pressure of the all-solid state secondary battery.

[Use Application of all-Solid State Secondary Battery]

The all-solid state secondary battery according to the embodiment of the present invention can be applied to a variety of usages. The application aspect thereof is not particularly limited, and in a case of being mounted in an electronic apparatus, examples thereof include a notebook computer, a pen-based input personal computer, a mobile personal computer, an e-book player, a mobile phone, a cordless phone handset, a pager, a handy terminal, a portable fax, a mobile copier, a portable printer, a headphone stereo, a video movie, a liquid crystal television, a handy cleaner, a portable CD, a mini disc, an electric shaver, a transceiver, an electronic notebook, a calculator, a memory card, a portable tape recorder, a radio, and a backup power supply. Additionally, examples of consumer usages include automobiles (electric vehicles and the like), electric vehicles, motors, lighting equipment, toys, game devices, road conditioners, watches, strobes, cameras, medical devices (pacemakers, hearing aids, and shoulder massage devices, and the like). Furthermore, the all-solid state secondary battery can be used for a variety of military usages and universe usages. In addition, the all-solid state secondary battery can also be combined with a solar battery.

### EXAMPLES

Hereinafter, the present invention will be described in more detail based on Examples; however, the present invention is not limited thereto be interpreted. “Parts”, “%”, and “ppm” representing compositions in Examples below are based on mass unless otherwise specified. In the present invention, “room temperature” means 25° C.

### 1. Polymer Synthesis

Polymers M-1 to M-8 shown in the following chemical formulae were synthesized as follows, and a binder solution or a dispersion liquid containing each polymer was prepared.

### [Synthesis Example M-1] Synthesis of Polymer M-1 and Preparation of Binder Solution M-1

A polymer M-1 (a (meth)acrylic polymer) was synthesized in the same manner as in Synthesis Example M-2 described later to obtain a xylene solution M-1 of the polymer M-1 (concentration: 30% by mass), except that in Synthesis Example M-1, a compound from which each constitutional component was derived was used so that the polymer M-2 had the composition (the kind and the content of the constitutional component) shown by the following chemical formula, and the polymerization concentration and the amount of the polymerization initiator were appropriately adjusted so that the mass average molecular weights shown in Table 2 was obtained.

### [Synthesis Example M-2] Synthesis of Polymer M-2 and Preparation of Binder Solution M-2

To a 200 mL volumetric flask, 21.6 g of methyl methacrylate (manufactured by FUJIFILM Wako Pure Chemical Corporation), 46.1 g of dodecyl acrylate (manufactured by Tokyo Chemical Industry Co., Ltd.), 3.6 g of 2-hydroxyethyl acrylate (manufactured by FUJIFILM Wako Pure Chemical Corporation), 0.8 g of monomethyl maleate (manufactured by Tokyo Chemical Industry Co., Ltd.), and 0.05 g of a polymerization initiator V-601 (product name, manufactured by FUJIFILM Wako Pure Chemical Corporation) were added and dissolved in 27.0 g of butyl butyrate to prepare a monomer solution.

43.0 g of butyl butyrate was added to a 500 mL three-neck flask and heated to 80° C. Then, a solution obtained by dissolving 0.03 g of a polymerization initiator V-601 (product name) in 2.0 g of butyl butyrate was added to the flask under a nitrogen atmosphere, and was stirred at 80° C. The above-described monomer solution was added dropwise thereto over 2 hours. After completion of the dropwise addition, stirring was carried out at 80° C. for 2 hours, and then the temperature was raised to 90° C., followed by stirring for 2 hours. The obtained polymerization solution was poured into 960 g of methanol, stirred for 10 minutes, and allowed to stand for 10 minutes. The precipitate obtained after removing the supernatant was dissolved in 120 g of xylene, and the solvent was distilled off at 30 hPa and 60° C. Further, 80 g of xylene was added thereto, and a step of distilling off the solvent under the above-described conditions was repeated until the methanol was not contained (equal to or lower than the detection limit by measurement with gas chromatography).

In this way, a polymer M-2 ((meth)acrylic polymer) was synthesized to obtain a xylene solution M-2 of the polymer M-2 (concentration: 30% by mass).

In addition, a butyl butyrate solution (concentration: 30% by mass) of the polymer M-2 was obtained using butyl butyrate instead of xylene as a solvent for dissolving the precipitate.

### [Synthesis Example M-3] Synthesis of Polymer M-3 and Preparation of Binder Solution M-3

A polymer M-3 (a (meth)acrylic polymer) was synthesized in the same manner as in Synthesis Example M-2 to obtain a xylene solution M-3 of the polymer M-3 (concentration: 30% by mass), except that in the above-described Synthesis Example M-2, a compound from which each constitutional component was derived was used so that the polymer M-3 had the composition (the kind and the content of the constitutional component) shown by the following chemical formula, and the polymerization concentration and the amount of the polymerization initiator were appropriately adjusted so that the mass average molecular weights shown in Table 2 was obtained.

### [Synthesis Example M-4] Synthesis of Polymer M-4 and Preparation of Binder Solution M-4

150 parts by mass of toluene, 30 parts by mass of styrene, and 70 parts by mass of 1,3-butadiene were added to an autoclave, and 1 part by mass of a polymerization initiator V-601 (manufactured by FUJIFILM Wako Pure Chemical Corporation) were added thereto. Then, the temperature was raised to 80° C., and stirring was carried out for 3 hours. Then, the temperature was raised to 90° C., and the reaction was carried out until the conversion rate reached 100%. The obtained solution was reprecipitated in methanol and dried to obtain a solid, and 3 parts by mass of 2,6-di-t-butyl-p-cresol and 2.2 parts by mass of maleic acid anhydride were added with respect to 100 parts by mass of the obtained polymer, and then the reaction was carried out at 180° C. for 5 hours. The obtained solution was reprecipitated in acetonitrile, and the obtained solid was dried at 80° C. to obtain a polymer (a dry solid product). The mass average molecular weight of this polymer was 90,000. Then, after 50 parts by mass of the polymer (the dry solid product) obtained as described above was dissolved in 50 parts by mass of cyclohexane and 150 parts by mass of THF, the solution was brought to 70° C., 3 parts by mass of n-butyl lithium, 3 parts by mass of 2,6-di-t-butyl-p-cresol, 1 part by mass of bis(cyclopentadienyl)titanium dichloride, and 2 parts by mass of diethyl aluminum chloride were added thereto. The resultant mixture was reacted at a hydrogen pressure of 10 kg/cm² for 1 hour, and then the solvent was distilled off, and drying was carried out to obtain a hydrocarbon polymer precursor A (mass average molecular weight: 90,000).

On the other hand, 100 parts by mass of xylene (manufactured by FUJIFILM Wako Pure Chemical Corporation) was added to a 2 L three-neck flask equipped with a reflux condenser and a gas introduction cock, nitrogen gas was introduced at a flow rate of 100 mL/min for 10 minutes, and then the temperature was raised to 80° C. A mixed liquid of 12.2 parts by mass of 2-aminoethanethiol hydrochloride (manufactured by Tokyo Chemical Industry Co., Ltd.) and 100 parts by mass of ethanol (manufactured by FUJIFILM Wako Pure Chemical Corporation) and a mixed liquid of 400 parts by mass of lauryl acrylate (manufactured by FUJIFILM Wako Pure Chemical Corporation), 100 parts by mass of hydroxyethyl acrylate (manufactured by FUJIFILM Wako Pure Chemical Corporation), 170 parts by mass of xylene (manufactured by FUJIFILM Wako Pure Chemical Corporation), and 10 parts by mass of azobisbutyronitrile (manufactured by FUJIFILM Wako Pure Chemical Corporation) were each separately added dropwise into the above three-neck flask over 2 hours. After the dropwise addition, the mixture was further stirred at 80° C. for 2 hours. Then, it was added dropwise to methanol to obtain a macromonomer having a terminal amino group (hydrochloride) as a precipitate. The mass average molecular weight of the macromonomer was 3,000.

Next, 450 parts by mass of xylene (manufactured by FUJIFILM Wako Pure Chemical Corporation) and 50 parts by mass of the hydrocarbon polymer precursor A were added and dissolved in a 1 L three-neck flask equipped with a reflux condenser and a gas introduction cock. Then, 68 parts by mass of the macromonomer having a terminal amino group and 1.6 parts by mass of 1,8-diazabicycloundecene (DBU, manufactured by FUJIFILM Wako Pure Chemical Corporation) were added thereto, the temperature was 130° C., and stirring was continued for 10 hours. Then, a 1 N hydrochloric acid aqueous solution was added and separated to extract the organic layer, and the organic layer was added dropwise to acetone to obtain the polymer M-4 as a precipitate. After drying under reduced pressure at 60° C. for 5 hours, the precipitate was redissolved in butyl butyrate. In this way, a polymer M-4 (a hydrocarbon polymer, mass average molecular weight: 130,000) was synthesized to obtain a butyl butyrate solution (concentration: 15% by mass) of the polymer M-4.

In addition, a xylene solution (concentration: 15% by mass) of the polymer M-4 was obtained using xylene instead of butyl butyrate as a solvent for redissolving the polymer M-4 after drying.

### [Synthesis Example M-5] Synthesis of Polymer M-5 and Preparation of Binder Solution M-5

200 parts by mass of ion exchange water, 80 parts by mass of vinylidene fluoride, 98 parts by mass of hexafluoropropylene, 20 parts by mass of 2-hydroxyethyl acrylate, and 2 parts by mass of acrylic acid were added to an autoclave, 1.5 parts by mass of diisopropyl peroxydicarbonate was further added thereto, and the mixture was stirred at 30° C. for 24 hours. After completion of the polymerization, the precipitate was filtered and dried at 100° C. for 10 hours to obtain a polymer (fluoropolymer) M-5. The obtained polymer was a random copolymer, and its mass average molecular weight was 230,000. The obtained polymer M-5 was dissolved in butyl butyrate to obtain a butyl butyrate solution of the polymer M-5 (concentration: 15% by mass).

### [Synthesis Example M-6] Synthesis of Polymer M-6 and Preparation of Binder Dispersion Liquid M-6

269.0 g of toluene was charged into a 1 L three-neck flask equipped with a stirrer, a thermometer, a reflux cooling pipe, and a nitrogen gas introduction pipe and was heated to 80° C. under a nitrogen stream. Next, a monomer solution consisting of 150.2 g of methyl methacrylate, 381.6 g of lauryl methacrylate, 5.3 g of V-601 (manufactured by FUJIFILM Wako Pure Chemical Corporation), and 4.7 g of mercaptopropionic acid was added dropwise to the three-neck flask at a constant speed such that the dropwise addition was completed in 2 hours. After completion of the dropwise addition of the monomer solution, the solution was subsequently stirred for 2 hours, was heated to 95° C., and was further stirred for 2 hours. Subsequently, 0.3 g of p-methoxyphenol, 31.8 g of glycidyl methacrylate, and 6.4 g of tetrabutylammonium bromide were added to the obtained reaction mixture, and the temperature was raised to 120° C., followed by stirring for 3 hours. Thereafter, the reaction solution was cooled to room temperature, was poured into 2 L of methanol under stirring, and was allowed to stand for a while. The solid obtained by decanting the supernatant solution was dissolved in 1,200 g of xylene, and the solvent was distilled off under reduced pressure to a solid content of 40% to obtain a macromonomer solution. The mass average molecular weight of the macromonomer was 20,000.

Next, 167 g of butyl butyrate and 112.5 g of the macromonomer solution (solid content: 40.0%) were charged into a 1 L three-neck flask equipped with a stirrer, a thermometer, a reflux cooling pipe, and a nitrogen gas introduction pipe, and then the temperature was raised to 80° C. under a nitrogen stream. Next, a monomer solution consisting of 105.0 g of mono(2-acryloyloxyethyl) succinate, 115.5 g of xylene, and 1.5 g of V-601 was added dropwise to the three-neck flask at a constant speed such that the dropwise addition was completed in 2 hours. After completion of the dropwise addition of the monomer solution, the solution was subsequently stirred for 2 hours, was heated to 90° C., and was further stirred for 2 hours. The obtained reaction mixture was filtered through a mesh having a pore size of 50 μm. In this way, a butyl butyrate dispersion liquid M-6 (concentration: 30% by mass) of the polymer M-6 ((meth)acrylic polymer) was obtained. The average particle diameter of the binder consisting of the polymer M-6 was 250 nm.

### [Synthesis Example M-7] Synthesis of Polymer M-7 and Preparation of Binder Solution M-7

A polymer M-7 (a (meth)acrylic polymer) was synthesized in the same manner as in Synthesis Example M-2 to obtain a xylene solution M-7 of the polymer M-7 (concentration: 30% by mass), except that in the above-described Synthesis Example M-2, a compound from which each constitutional component was derived was used so that the polymer M-7 had the composition (the kind and the content of the constitutional component) shown by the following chemical formula and in Table 2, and the polymerization concentration and the amount of the polymerization initiator were appropriately adjusted so that the mass average molecular weights shown in Table 2 was obtained.

### [Synthesis Example M-8] Synthesis of Polymer M-8 and Preparation of Binder Solution M-8

A polymer M-8 (a (meth)acrylic polymer) was synthesized in the same manner as in Synthesis Example M-2 to obtain a xylene solution M-8 of the polymer M-8 (concentration: 30% by mass), except that in the above-described Synthesis Example M-2, a compound from which each constitutional component was derived was used so that the polymer M-8 had the composition (the kind and the content of the constitutional component) shown by the following chemical formula and in Table 2, and the polymerization concentration and the amount of the polymerization initiator were appropriately adjusted so that the mass average molecular weights shown in Table 2 was obtained.

Each of the polymers synthesized is shown below. The numerical value at the bottom right of each constitutional component indicates the content (% by mass). In the following polymer, Me represents a methyl group, MMA represents methyl methacrylate, LMA represents lauryl methacrylate, and “wt %” means % by mass.

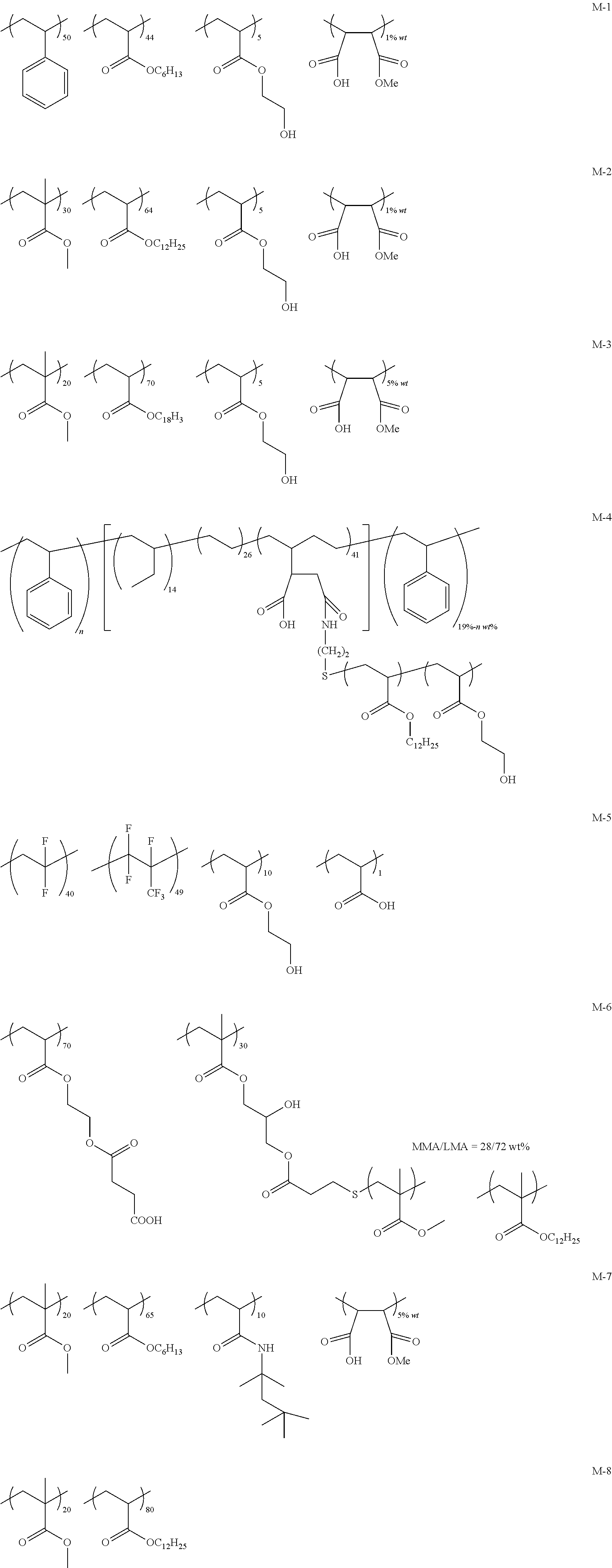

For each of the synthesized polymers, the kind and the mass average molecular weight of the polymer are shown in the column of “Polymer binder (B)” in Table 2 below. The mass average molecular weight was measured by the above-described method. In addition, in each polymer, the terminal group for determining the difference from the residue of the compound (A) is shown in the column of “Terminal group” in Table 2.

### 2. Preparation of Compound (A)

As the compounds A-1 to A-11 shown in the following chemical formulae, commercially available products were used.
Compound A-1: manufactured by FUJIFILM Wako Pure Chemical Corporation
Compound A-2: manufactured by FUJIFILM Wako Pure Chemical Corporation
Compound A-3: manufactured by FUJIFILM Wako Pure Chemical Corporation
Compound A-4: manufactured by FUJIFILM Wako Pure Chemical Corporation
Compound A-5: manufactured by FUJIFILM Wako Pure Chemical Corporation
Compound A-6: manufactured by FUJIFILM Wako Pure Chemical Corporation
Compound A-7: X-22-176DX, manufactured by Shin-Etsu Chemical Co., Ltd.
Compound A-8: manufactured by FUJIFILM Wako Pure Chemical Corporation
Compound A-9: manufactured by FUJIFILM Wako Pure Chemical Corporation
Compound A-10: manufactured by FUJIFILM Wako Pure Chemical Corporation
Compound A-11: manufactured by FUJIFILM Wako Pure Chemical Corporation

The respective compounds are shown below. In the compound A-7, R^{S1}, R^{S2}, and R^{S3} represent a substituent.

Regarding each compound, the kind of the functional group (a) and the (number-average) molecular weight are shown in Table 2 below. The number average molecular weight of the compound A-7 was measured by the above-described method. In addition, the residues in each compound are shown in the column of “Residue” in Table 2.

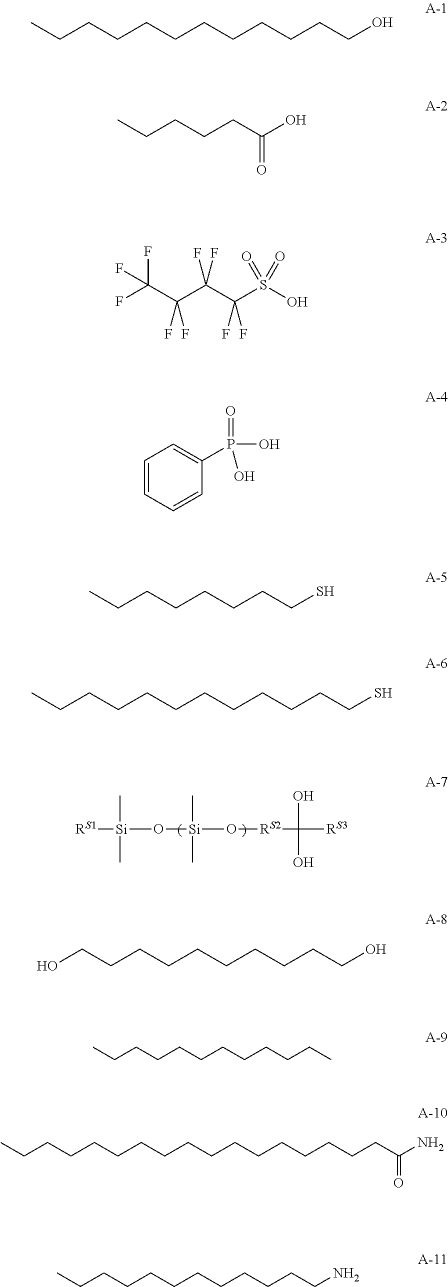

### 3. Synthesis of Sulfide-Based Inorganic Solid Electrolyte

### Synthesis Example A

A sulfide-based inorganic solid electrolyte was synthesized with reference to a non-patent document of T. Ohtomo, A. Hayashi, M. Tatsumisago, Y. Tsuchida, S. Hama, K. Kawamoto, Journal of Power Sources, 233, (2013), pp. 231 to 235 and A. Hayashi, S. Hama, H. Morimoto, M. Tatsumisago, T. Minami, Chem. Lett., (2001), pp. 872 and 873.

Specifically, in a globe box in an argon atmosphere (dew point: −70° C.), lithium sulfide (Li₂S, manufactured by Sigma-Aldrich Co., LLC Co., LLC Co., LLC, purity: >99.98%) (2.42 g) and diphosphorus pentasulfide (P₂S₅, manufactured by Sigma-Aldrich Co., LLC Co., LLC Co., LLC, purity: >99%) (3.90 g) each were weighed, put into an agate mortar, and mixed using an agate pestle for five minutes. The mixing ratio between Li₂S and P₂S₅(Li₂S:P₂S₅) was set to 75:25 in terms of molar ratio.

Next, 66 g of zirconia beads having a diameter of 5 mm were put into a 45 mL container made of zirconia (manufactured by Fritsch Japan Co., Ltd.), the entire amount of the mixture of the above-described lithium sulfide and the diphosphorus pentasulfide was put thereinto, and the container was completely sealed in an argon atmosphere. The container was set in a planetary ball mill P-7 (product name, manufactured by FRITSCH), mechanical milling was carried out at a temperature of 25° C. and a rotation speed of 510 rpm for 20 hours, thereby obtaining a yellow powder (6.20 g) of a sulfide-based inorganic solid electrolyte (Li—P—S-based glass, hereinafter, may be denoted as LPS). The particle diameter of the Li—P—S-based glass was 15 μm.

### Example 1

Each of the compositions shown in Table 1-1 to Table 1-4 (collectively referred to as Table 1) was prepared as follows.

### <Preparation of Inorganic Solid Electrolyte-Containing Composition>

In a container for a planetary centrifugal mixer (ARE-310, manufactured by Thinky Corporation), 2.8 g of the inorganic solid electrolyte LPS synthesized in Synthesis Example A, 0.08 g (solid content by mass) of the binder solution or the binder dispersion liquid, a compound (A) shown in Table 1 with a content with respect to 100 mass % of the solid content as indicated in the “Content *** (ppm)” column of Table 1, and a dispersion medium (D) shown in Table 1 such that the content of the dispersion medium (D) in the negative electrode composition is 48 mass % were added. Then, this container was set in a planetary centrifugal mixer ARE-310 (product name). The components were mixed together for 5 minutes under the conditions of 25° C. and a rotation speed of 2,000 rpm to prepare each of inorganic solid electrolyte-containing compositions (slurries) S-1 to S-21 and Kc1 to Kc3.

The solution of the polymer M-2 and the solution of the polymer M-4 were prepared using a solution of the same solvent as the dispersion medium (D) used. The same applies to the positive electrode composition and the negative electrode composition.

### <Preparation of Positive Electrode Composition>

2.8 g of the inorganic solid electrolyte LPS synthesized in Synthesis Example A and the dispersion medium (D) shown in Table 1 were put into a container for a planetary centrifugal mixer (ARE-310, manufactured by Thinky Corporation) so that the content of the dispersion medium (D) in the positive electrode composition was 30% by mass. Then, this container was set in the planetary centrifugal mixer ARE-310 (product name), and mixing was carried out for 2 minutes at a temperature of 25° C. and a rotation speed of 2,000 rpm. Thereafter, LiNi_{1/3}Co_{1/3}Mn_{1/3}O₂ (NMC, manufactured by Sigma-Aldrich Co., LLC) as a positive electrode active material, acetylene black (AB) as a conductive auxiliary agent, 0.133 g (solid content mass) of the binder solution or polymer binder (B) shown in Table 1, and the compound (A) shown in Table 1 were put into the container at a proportion such that the content thereof became the content shown in the column of “Content *** (ppm)” of Table 1 (for the compound (A), the content shown in the column of “Content *** (ppm)” of Table 1), the container was set in a planetary centrifugal mixer ARE-310 (product name), and the mixture was mixed for 2 minutes under the conditions of 25° C. and a rotation speed of 2,000 rpm, thereby preparing each of positive electrode compositions (slurries) PK-1 to PK-21 and PKc21 to PKc23.

### <Preparation of Negative Electrode Composition>

In a container for a planetary centrifugal mixer (ARE-310), 2.8 g of the inorganic solid electrolyte LPS synthesized in Synthesis Example A, 0.062 g (solid content by mass) of a binder solution or polymer binder (B) shown in Table 1 below, a compound (A) shown in Table 1 with a content with respect to 100 mass % of the solid content as indicated in the “Content *** (ppm)” column of Table 1, and a dispersion medium (D) shown in Table 1 such that the content of the dispersion medium (D) in the negative electrode composition is 48 mass % were added. Then, this container was set in the planetary centrifugal mixer ARE-310 (product name) manufactured by THINKY CORPORATION, and mixing was carried out for 2 minutes under the conditions of 25° C. and the rotation speed of 2,000 rpm. Then, 3.11 g of silicon (Si, manufactured by Sigma-Aldrich Co., LLC) as a negative electrode active material shown in Table 1 and 0.25 g of carbon nanotube (VGCF) as a conductive auxiliary agent were put into the container, the container was set in the same manner in the planetary centrifugal mixer ARE-310 (product name), and mixing was carried out for 2 minutes under the conditions of 25° C. and the rotation speed of 2,000 rpm to prepare each of negative electrode compositions (slurries) NK-1, NK-21, and NKc21 to NKc23.

In Table 1, the composition content is the content (% by mass) with respect to the total mass of the composition, and the solid content is the content (% by mass) with respect to 100% by mass of the solid content of the composition. The unit is omitted in the table. In addition, as the content of the compound (A) in each composition, the content with respect to the inorganic solid electrolyte (SE), the content with respect to the polymer binder (B), and the content with respect to 100% by mass of the solid content are respectively shown in the column of “Content* (ppm)”, the column of “Content** (% by mass)”, and the column of “Content*** (ppm)” in Table 1. Furthermore, the “State” column of Table 1 shows the states of the polymer binder (B) and the compound (A) in each composition (dissolved (referred to as “Dissolved” in Table 1) or insoluble and dispersed in a particulate shape (referred to as “Particulate” in Table 1)) as a result of the evaluation by the above-described solubility measurement.

TABLE 1

| | | Inorganic solid | | | | | | | | | | Dispersion medium | | | | |
|---|---|---|---|---|---|---|---|---|---|---|---|---|---|---|---|---|
| | | electrolyte (SE) | | | Polymer binder (B) | | | Compound (A) | | | | (D) | | State | | |
| | | | Composition | Solid | | Composition | Solid | | Content* | Content** | Content*** | | Composition | Binder | Compound | |
| | No. | | content | content | | content | content | | (ppm) | (ppm) | (ppm) | | content | (B) | (A) | Note |
| Inorganic solid | S-1 | LPS | 50.5 | 97.2 | M-2 | 1.5 | 2.8 | A-1 | 2.0 × 10² | 1.0 | 2.0 × 10² | Xylene | 48.0 | Dissolved | Dissolved | Present |
| electrolyte- | | | | | | | | | | | | | | | | invention |
| containing | S-2 | LPS | 50.5 | 97.2 | M-2 | 1.5 | 2.8 | A-2 | 2.0 × 10² | 1.0 | 2.0 × 10² | Xylene | 48.0 | Dissolved | Dissolved | Present |
| composition | | | | | | | | | | | | | | | | invention |
| | S-3 | LPS | 50.5 | 97.2 | M-2 | 1.5 | 2.8 | A-3 | 2.0 × 10² | 1.0 | 2.0 × 10² | Xylene | 48.0 | Dissolved | Dissolved | Present |
| | | | | | | | | | | | | | | | | invention |
| | S-4 | LPS | 50.5 | 97.2 | M-2 | 1.5 | 2.8 | A-4 | 2.0 × 10² | 1.0 | 2.0 × 10² | Xylene | 48.0 | Dissolved | Dissolved | Present |
| | | | | | | | | | | | | | | | | invention |
| | S-5 | LPS | 50.5 | 97.2 | M-2 | 1.5 | 2.3 | A-5 | 2.0 × 10² | 1.0 | 2.0 × 10² | Xylene | 48.0 | Dissolved | Dissolved | Present |
| | | | | | | | | | | | | | | | | invention |
| | S-6 | LPS | 50.5 | 97.2 | M-2 | 1.5 | 2.5 | A-6 | 2.0 × 10² | 1.0 | 2.0 × 10² | Xylene | 48.0 | Dissolved | Dissolved | Present |
| | | | | | | | | | | | | | | | | invention |
| | S-7 | LPS | 50.5 | 97.2 | M-2 | 1.5 | 2.8 | A-6 | 2.0 × 10² | 0.04 | 2.0 × 10² | Xylene | 48.0 | Dissolved | Dissolved | Present |
| | | | | | | | | | | | | | | | | invention |
| | S-S | LPS | 50.5 | 97.2 | M-2 | 1.5 | 2.8 | A-6 | 2.0 × 10² | 2.0 | 2.0 × 10² | Xylene | 4S.0 | Dissolved | Dissolved | Present |
| | | | | | | | | | | | | | | | | invention |
| | S-9 | LPS | 50.5 | 97.2 | M-2 | 1.5 | 2.8 | A-6 | 2.0 × 10² | 7.0 | 2.0 × 10² | Xylene | 48.0 | Dissolved | Dissolved | Present |
| | | | | | | | | | | | | | | | | invention |
| | S-10 | LPS | 50.5 | 97.2 | M-2 | 1.5 | 2.8 | A-7 | 2.0 × 10² | 1.0 | 2.0 × 10² | Xylene | 43.0 | Dissolved | Dissolved | Present |
| | | | | | | | | | | | | | | | | invention |
| | S-11 | LPS | 50.5 | 97.2 | M-1 | 1.5 | 2.8 | A-6 | 2.0 × 10² | 1.0 | 2.0 × 10² | Xylene | 43.0 | Dissolved | Dissolved | Present |
| | | | | | | | | | | | | | | | | invention |
| | S-12 | LPS | 50.5 | 97.2 | M-3 | 1.5 | 2.8 | A-6 | 2.0 × 10² | 1.0 | 2.0 × 10² | Xylene | 48.0 | Dissolved | Dissolved | Present |
| | | | | | | | | | | | | | | | | invention |
| | S-13 | LPS | 50.5 | 97.2 | M-4 | 1.5 | 2.8 | A-6 | 2.0 × 10² | 1.0 | 2.0 × 10² | Xylene | 48.0 | Dissolved | Dissolved | Present |
| | | | | | | | | | | | | | | | | invention |
| | S-14 | LPS | 50.5 | 97.2 | M-4 | 1.5 | 2.8 | A-6 | 2.0 × 10² | 1.0 | 2.0 × 10² | Butyl | 48.0 | Dissolved | Dissolved | Present |
| | | | | | | | | | | | | butyrate | | | | invention |
| | S-15 | LPS | 50.5 | 97.2 | M-5 | 1.5 | 2.8 | A-6 | 2.0 × 10² | 1.0 | 2.0 × 10² | Butyl | 48.0 | Dissolved | Dissolved | Present |
| | | | | | | | | | | | | butyrate | | | | invention |
| | S-16 | LPS | 50.5 | 97.2 | M-6 | 1.5 | 2.8 | A-6 | 2.0 × 10² | 7.0 | 2.0 × 10³ | Butyl | 48.0 | Particulate | Dissolved | Present |
| | | | | | | | | | | | | butyrate | | | | invention |
| | S-17 | LPS | 50.5 | 97.2 | M-2 | 1.5 | 2.8 | A-6 | 5.0 | 0.02 | 5.0 | Butyl | 48.0 | Dissolved | Dissolved | Present |
| | | | | | | | | | | | | butyrate | | | | invention |
| | S-18 | LPS | 50.5 | 97.2 | M-2 | 1.5 | 2.8 | A-8 | 2.0 × 10² | 1.0 | 2.0 × 10² | Xylene | 48.0 | Dissolved | Dissolved | Present |
| | | | | | | | | | | | | | | | | invention |
| | S-19 | LPS | 50.5 | 97.2 | M-7 | 1.5 | 2.8 | A-6 | 2.0 × 10² | 1.0 | 2.0 × 10² | Xylene | 48.0 | Dissolved | Dissolved | Present |
| | | | | | | | | | | | | | | | | invention |
| | S-20 | LPS | 50.5 | 97.2 | M-8 | 1.5 | 2.8 | A-1 | 2.0 × 10² | 1.0 | 2.0 × 10² | Xylene | 48.0 | Dissolved | Dissolved | Present |
| | | | | | | | | | | | | | | | | invention |
| | S-21 | LPS | 50.5 | 97.2 | M-2 | 1.5 | 2.8 | A-11 | 2.0 × 10² | 1.0 | 2.0 × 10² | Xylene | 48.0 | Dissolved | Dissolved | Present |
| | | | | | | | | | | | | | | | | invention |

| | | |
|---|---|---|
| Inorganic solid electrolyte (SE) | Polymer binder (B) | Compound (A) |

| | | | Composition | Solid | | Composition | Solid- | | Content* | Content** | Content*** | |
|---|---|---|---|---|---|---|---|---|---|---|---|---|
| | No. | | content | content | | content | content | | (ppm) | (% by mass) | (ppm) | Dispersion medium (D) |
| Positive | PK-1 | LPS | 14.7 | 21.0 | M-2 | 0.7 | 1.0 | A-1 | 1.0 × 10 [symbol] | [symbol] | 1.0 × 10 [symbol] | Xylene |
| electrode | | | | | | | | | | | | |
| composition | PK-2 | LPS | 14.7 | 21.0 | M-2 | 0.7 | 1.0 | A-2 | 1.0 × 10 [symbol] | [symbol] | 1.0 × 10 [symbol] | Xylene |
| | PK-3 | LPS | 14.7 | 21.0 | M-2 | 0.7 | 1.0 | A-3 | 1.0 × 10 [symbol] | [symbol] | 1.0 × 10 [symbol] | Xylene |
| | PK-4 | LPS | 14.7 | 21.0 | M-2 | 0.7 | 1.0 | A-4 | 1.0 × 10 [symbol] | [symbol] | 1.0 × 10 [symbol] | Xylene |
| | PK-5 | LPS | 14.7 | 21.0 | M-2 | 0.7 | 1.0 | A-5 | 1.0 × 10 [symbol] | [symbol] | 1.0 × 10 [symbol] | Xylene |
| | PK-6 | LPS | 14.7 | 21.0 | M-2 | 0.7 | 1.0 | A-6 | 1.0 × 10 [symbol] | [symbol] | 1.0 × 10 [symbol] | Xylene |
| | PK-7 | LPS | 14.7 | 21.0 | M-2 | 0.7 | 1.0 | A-6 | 1.0 × 10 [symbol] | [symbol] | 1.0 × 10 [symbol] | Xylene |
| | PK-8 | LPS | 14.7 | 21.0 | M-2 | 0.7 | 1.0 | A-6 | 1.0 × 10 [symbol] | [symbol] | 1.0 × 10 [symbol] | Xylene |
| | PK-9 | LPS | 14.7 | 21.0 | M-2 | 0.7 | 1.0 | A-7 | 1.0 × 10 [symbol] | [symbol] | 1.0 × 10 [symbol] | Xylene |
| | PK-10 | LPS | 14.7 | 21.0 | M-2 | 0.7 | 1.0 | A-8 | 1.0 × 10 [symbol] | [symbol] | 1.0 × 10 [symbol] | Xylene |
| | PK-11 | LPS | 14.7 | 21.0 | M-1 | 0.7 | 1.0 | A-6 | 1.0 × 10 [symbol] | [symbol] | 1.0 × 10 [symbol] | Xylene |
| | PK-12 | LPS | 14.7 | 21.0 | M-3 | 0.7 | 1.0 | A-6 | 1.0 × 10 [symbol] | [symbol] | 1.0 × 10 [symbol] | Xylene |
| | PK-13 | LPS | 14.7 | 21.0 | M-4 | 0.7 | 1.0 | A-6 | 1.0 × 10 [symbol] | [symbol] | 1.0 × 10 [symbol] | Xylene |
| | PK-14 | LPS | 14.7 | 21.0 | M-4 | 0.7 | 1.0 | A-6 | 1.0 × 10 [symbol] | [symbol] | 1.0 × 10 [symbol] | Butyl |
| | | | | | | | | | | | | [symbol] |
| | PK-15 | LPS | 14.7 | 21.0 | M-5 | 0.7 | 1.0 | A-6 | 1.0 × 10 [symbol] | [symbol] | 1.0 × 10 [symbol] | Butyl |
| | | | | | | | | | | | | [symbol] |
| | PK-16 | LPS | 14.7 | 21.0 | M-6 | 0.7 | 1.0 | A-6 | 1.0 × 10 [symbol] | [symbol] | 1.0 × 10 [symbol] | Butyl |
| | | | | | | | | | | | | [symbol] |
| | PK-17 | LPS | 14.7 | 21.0 | M-2 | 0.7 | 1.0 | A-6 | 1.0 × 10 [symbol] | [symbol] | 1.0 × 10 [symbol] | Butyl |
| | | | | | | | | | | | | [symbol] |
| | PK-18 | LPS | 14.7 | 21.0 | M-2 | 0.7 | 1.0 | A-8 | 1.0 × 10 [symbol] | [symbol] | 1.0 × 10 [symbol] | Xylene |
| | PK-19 | LPS | 14.7 | 21.0 | M-7 | 0.7 | 1.0 | A-8 | 1.0 × 10 [symbol] | [symbol] | 1.0 × 10 [symbol] | Xylene |
| | PK-20 | LPS | 14.7 | 21.0 | M-8 | 0.7 | 1.0 | A-1 | 1.0 × 10 [symbol] | [symbol] | 1.0 × 10 [symbol] | Xylene |
| | PK-21 | LPS | 14.7 | 21.0 | M-2 | 0.7 | 1.0 | A-11 | 1.0 × 10 [symbol] | [symbol] | 1.0 × 10 [symbol] | Xylene |

| | | Dispersion medium (D) | Active material (AC). | | | | Conductive auxiliary agent | | State | | |
|---|---|---|---|---|---|---|---|---|---|---|---|
| | | Composition | | Composition | Solid | | Composition | | Binder | Compound | |
| | No. | content | | content | content | | content | Solid | (B) | (A) | Note |
| Positive | PK-1 | 30.0 | NMC | 52.5 | 75.0 | AB | 2.1 | 3.0 | Dissolved | Dissolved | Present |
| electrode | | | | | | | | | | | invention |
| composition | PK-2 | 30.0 | NMC | 52.5 | 75.0 | AB | 2.1 | 3.0 | Dissolved | Dissolved | Present |
| | | | | | | | | | | | invention |
| | PK-3 | 30.0 | NMC | 52.5 | 75.0 | AB | 2.1 | 3.0 | Dissolved | Dissolved | Present |
| | | | | | | | | | | | invention |
| | PK-4 | 30.0 | NMC | 52.5 | 75.0 | AB | 2.1 | 3.0 | Dissolved | Dissolved | Present |
| | | | | | | | | | | | invention |
| | PK-5 | 30.0 | NMC | 52.5 | 75.0 | AB | 2.1 | 3.0 | Dissolved | Dissolved | Present |
| | | | | | | | | | | | invention |
| | PK-6 | 30.0 | NMC | 52.5 | 75.0 | AB | 2.1 | 3.0 | Dissolved | Dissolved | Present |
| | | | | | | | | | | | invention |
| | PK-7 | 30.0 | NMC | 52.5 | 75.0 | AB | 2.1 | 3.0 | Dissolved | Dissolved | Present |
| | | | | | | | | | | | invention |
| | PK-8 | 30.0 | NMC | 52.5 | 75.0 | AB | 2.1 | 3.0 | Dissolved | Dissolved | Present |
| | | | | | | | | | | | invention |
| | PK-9 | 30.0 | NMC | 52.5 | 75.0 | AB | 2.1 | 3.0 | Dissolved | Dissolved | Present |
| | | | | | | | | | | | invention |
| | PK-10 | 30.0 | NMC | 52.5 | 75.0 | AB | 2.1 | 3.0 | Dissolved | Dissolved | Present |
| | | | | | | | | | | | invention |
| | PK-11 | 30.0 | NMC | 52.5 | 75.0 | AB | 2.1 | 3.0 | Dissolved | Dissolved | Present |
| | | | | | | | | | | | invention |
| | PK-12 | 30.0 | NMC | 52.5 | 75.0 | AB | 2.1 | 3.0 | Dissolved | Dissolved | Present |
| | | | | | | | | | | | invention |
| | PK-13 | 30.0 | NMC | 52.5 | 75.0 | AB | 2.1 | 3.0 | Dissolved | Dissolved | Present |
| | | | | | | | | | | | invention |
| | PK-14 | 30.0 | NMC | 52.5 | 75.0 | AB | 2.1 | 3.0 | Dissolved | Dissolved | Present |
| | | | | | | | | | | | invention |
| | PK-15 | 30.0 | NMC | 52.5 | 75.0 | AB | 2.1 | 3.0 | Dissolved | Dissolved | Present |
| | | | | | | | | | | | invention |
| | PK-16 | 30.0 | NMC | 52.5 | 75.0 | AB | 2.1 | 3.0 | Dissolved | Dissolved | Present |
| | | | | | | | | | | | invention |
| | PK-17 | 30.0 | NMC | 52.5 | 75.0 | AB | 2.1 | 3.0 | Dissolved | Dissolved | Present |
| | | | | | | | | | | | invention |
| | PK-18 | 30.0 | NMC | 52.5 | 75.0 | AB | 2.1 | 3.0 | Dissolved | Dissolved | Present |
| | | | | | | | | | | | invention |
| | PK-19 | 30.0 | NMC | 52.5 | 75.0 | AB | 2.1 | 3.0 | Dissolved | Dissolved | Present |
| | | | | | | | | | | | invention |
| | PK-20 | 30.0 | NMC | 52.5 | 75.0 | AB | 2.1 | 3.0 | Dissolved | Dissolved | Present |
| | | | | | | | | | | | invention |
| | PK-21 | 30.0 | NMC | 52.5 | 75.0 | AB | 2.1 | 3.0 | Dissolved | Dissolved | Present |
| | | | | | | | | | | | invention |

| | | [symbol] solid electrolyte | | | | | | | | | | |
|---|---|---|---|---|---|---|---|---|---|---|---|---|
| | | (SE) | | | Polymer binder (B) | | | Compound (A) | | | | Dispersion |
| | | | Composition | Solid | | Composition | Solid | | Content* | Content** | Content*** | medium |
| | No. | | content | content | | content | content | | (ppm) | (% by mass) | (ppm) | (D) |
| Negative | NK-1 | LPS | 23.4 | 45.0 | M-2 | 0.5 | 1.0 | A-1 | 4.0 × 10 [symbol] | 2.0 | 2.0 × 10 [symbol] | Xylene |
| electrode | | | | | | | | | | | | |
| composition | NK-2 | LPS | 23.4 | 45.0 | M-2 | 0.5 | 1.0 | A-2 | 4.0 × 10 [symbol] | 2.0 | 2.0 × 10 [symbol] | Xylene |
| | NK-3 | LPS | 23.4 | 45.0 | M-2 | 0.5 | 1.0 | A-3 | 4.0 × 10 [symbol] | 2.0 | 2.0 × 10 [symbol] | Xylene |
| | NK-4 | LPS | 23.4 | 45.0 | M-2 | 0.5 | 1.0 | A-4 | 4.0 × 10 [symbol] | 2:0 | 2.0 × 10 [symbol] | Xylene |
| | NK-5 | LPS | 23.4 | 45.0 | M-2 | 0.5 | 1.0 | A-5 | 4.0 × 10 [symbol] | 2.0 | 2.0 × 10 [symbol] | Xylene |
| | NK-6 | LPS | 23.4 | 45.0 | M-2 | 0.5 | 1.0 | A-6 | 4.0 × 10 [symbol] | 2.0 | 2.0 × 10 [symbol] | Xylene |
| | NK-7 | LPS | 23.4 | 45.0 | M-2 | 0.5 | 1.0 | A-6 | 4.0 × 10 [symbol] | 0.10 | 2.0 × 10 [symbol] | Xylene |
| | NK-8 | LPS | 23.4 | 45.0 | M-2 | 0.5 | 1.0 | A-6 | 4.0 × 10 [symbol] | 6.0 | 2.0 × 10 [symbol] | Xylene |
| | NK-9 | LPS | 23.4 | 45.0 | M-2 | 0.5 | 1.0 | A-6 | 4.0 × 10 [symbol] | 20 | 2.0 × 10 [symbol] | Xylene |
| | NK-10 | LPS | 23.4 | 45.0 | M-2 | 0.5 | 1.0 | A-7 | 4.0 × 10 [symbol] | 2.0 | 2.0 × 10 [symbol] | Xylene |
| | NK-11 | LPS | 23.4 | 45.0 | M-1 | 0.5 | 1.0 | A-6 | 4.0 × 10 [symbol] | 2.0 | 2.0 × 10 [symbol] | Xylene |
| | NK-12 | LPS | 23.4 | 45.0 | M-3 | 0.5 | 1.0 | A-6 | 4.0 × 10 [symbol] | 2.0 | 2.0 × 10 [symbol] | Xylene |
| | NK-13 | LPS | 23.4 | 45.0 | M-4 | 0.5 | 1.0 | A-6 | 4.0 × 10 [symbol] | [symbol] | 2.0 × 10 [symbol] | Xylene |
| | NK-14 | LPS | 23.4 | 45.0 | M-4 | 0.5 | 1.0 | A-6 | 4.0 × 10 [symbol] | 2.0 | 2.0 × 10 [symbol] | [symbol] |
| | NK-15 | LPS | 23.4 | 45.0 | M-5 | 0.5 | 1.0 | A-6 | 4.0 × 10 [symbol] | 2.0 | 2.0 × 10 [symbol] | [symbol] |
| | NK-16 | LPS | 23.4 | 45.0 | M-6 | 0.5 | 1.0 | A-6 | 4.0 × 10 [symbol] | 20 | 2.0 × 10 [symbol] | [symbol] |
| | NK-17 | LPS | 23.4 | 45.0 | M-2 | 0.5 | 1.0 | A-6 | 11 | [symbol] | [symbol] | [symbol] |
| | NK-18 | LPS | 23.4 | 45.0 | M-2 | 0.5 | 1.0 | A-#Z,899 | 4.0 × 10 [symbol] | 2.0 | 2.0 × 10 [symbol] | Xylene |
| | NK-19 | LPS | 23.4 | 45.0 | M-7 | 0.5 | 1.0 | A-6 | 4.0 × 10 [symbol] | 2.0 | 2.0 × 10 [symbol] | Xylene |
| | NK-20 | LPS | 23.4 | 45.0 | M-8 | 0.5 | 1.0 | A-1 | 4.0 × 10 [symbol] | 2.0 | 2.0 × 10 [symbol] | Xylene |
| | NK-21 | LPS | 23.4 | 45.0 | M-2 | 0.5 | 1.0 | A-11 | 4.0 × 10 [symbol] | 2.0 | 2.0 × 10 [symbol] | Xylene |

| | | Dispersion medium (D) | Active material (AC) | | | Conductive auxiliary agent | | | State | | |
|---|---|---|---|---|---|---|---|---|---|---|---|
| | | Composition | | Composition | Solid | | Composition | Solid | Binder | Compound | |
| | No. | content | | content | content | | content | content | (B) | (A) | Note |
| Negative | NK-1 | [symbol] | Si | 26.0 | 50.0 | VGCF | 2.1 | 4.0 | Dissolved | Dissolved | Present |
| electrode | | | | | | | | | | | invention |
| composition | NK-2 | [symbol] | Si | 26.0 | 50.0 | VGCF | 2.1 | 4.0 | Dissolved | Dissolved | Present |
| | | | | | | | | | | | invention |
| | NK-3 | [symbol] | Si | 26.0 | 50.0 | VGCF | 2.1 | 4.0 | Dissolved | Dissolved | Present |
| | | | | | | | | | | | invention |
| | NK-4 | [symbol] | Si | 26.0 | 50.0 | VGCF | 2.1 | 4.0 | Dissolved | Dissolved | Present |
| | | | | | | | | | | | invention |
| | NK-5 | [symbol] | Si | 26.0 | 50.0 | VGCF | 2.1 | 4.0 | Dissolved | Dissolved | Present |
| | | | | | | | | | | | invention |
| | NK-6 | [symbol] | Si | 26.0 | 50.0 | VGCF | 2.1 | 4.0 | Dissolved | Dissolved | Present |
| | | | | | | | | | | | invention |
| | NK-7 | [symbol] | Si | 26.0 | 50.0 | VGCF | 2.1 | 4.0 | Dissolved | Dissolved | Present |
| | | | | | | | | | | | invention |
| | NK-8 | [symbol] | Si | 26.0 | 50.0 | VGCF | 2.1 | 4.0 | Dissolved | Dissolved | Present |
| | | | | | | | | | | | invention |
| | NK-9 | [symbol] | Si | 26.0 | 50.0 | VGCF | 2.1 | 4.0 | Dissolved | Dissolved | Present |
| | | | | | | | | | | | invention |
| | NK-10 | [symbol] | Si | 26.0 | 50.0 | VGCF | 2.1 | 4.0 | Dissolved | Dissolved | Present |
| | | | | | | | | | | | invention |
| | NK-11 | [symbol] | Si | 26.0 | 50.0 | VGCF | 2.1 | 4.0 | Dissolved | Dissolved | Present |
| | | | | | | | | | | | invention |
| | NK-12 | [symbol] | Si | 26.0 | 50.0 | VGCF | 2.1 | 4.0 | Dissolved | Dissolved | Present |
| | | | | | | | | | | | invention |
| | NK-13 | [symbol] | Si | 26.0 | 50.0 | VGCF | 2.1 | 4.0 | Dissolved | Dissolved | Present |
| | | | | | | | | | | | invention |
| | NK-14 | [symbol] | Si | 26.0 | 50.0 | VGCF | 2.1 | 4.0 | Dissolved | Dissolved | Present |
| | | | | | | | | | | | invention |
| | NK-15 | [symbol] | Si | 26.0 | 50.0 | VGCF | 2.1 | 4.0 | Dissolved | Dissolved | Present |
| | | | | | | | | | | | invention |
| | NK-16 | [symbol] | Si | 26.0 | 50.0 | VGCF | 2.1 | 4.0 | Dissolved | Dissolved | Present |
| | | | | | | | | | | | invention |
| | NK-17 | [symbol] | Si | 26.0 | 50.0 | VGCF | 2.1 | 4.0 | Dissolved | Dissolved | Present |
| | | | | | | | | | | | invention |
| | NK-18 | [symbol] | Si | 26.0 | 50.0 | VGCF | 2.1 | 4.0 | Dissolved | Dissolved | Present |
| | | | | | | | | | | | invention |
| | NK-19 | [symbol] | Si | 26.0 | 50.0 | VGCF | 2.1 | 4.0 | Dissolved | Dissolved | Present |
| | | | | | | | | | | | invention |
| | NK-20 | [symbol] | Si | 26.0 | 50.0 | VGCF | 2.1 | 4.0 | Dissolved | Dissolved | Present |
| | | | | | | | | | | | invention |
| | NK-21 | [symbol] | Si | 26.0 | 50.0 | VGCF | 2.1 | 4.0 | Dissolved | Dissolved | Present |
| | | | | | | | | | | | invention |

| | | | |
|---|---|---|---|
| Inorganic solid | | | |
| electrolyte (SE) | Polymer binder (B) | Compound (A) | Dispersion medium |

| | | | Composition | Solid | | Composition | Solid | | Content* | Content** | Content*** | | Composition |
|---|---|---|---|---|---|---|---|---|---|---|---|---|---|
| | No. | | content | content | | content | content | | (ppm) | (% by mass) | (ppm) | | content |
| Inorganic | Kc1 | LPS | 50.5 | 97.2 | M-6 | 1.5 | | | — | — | — | Butyl | 48.0 |
| sold | | | | | | | | | | | | butyrate | |
| electrolyte- | Kc2 | LPS | 50.5 | 97.2 | M-2 | 1.5 | 2.8 | A-9 | [symbol] | 1.0 | [symbol] | Xylene | 48.0 |
| containing | | | | | | | | | | | | | |
| composition | Kc3 | LPS | 50.5 | 97.2 | M-2 | 1.5 | 2.8 | A-10 | [symbol] | [symbol] | [symbol] | Xylene | 48.0 |
| Positive | PKc21 | LPS | [symbol] | 21.0 | M-6 | 0.7 | 1.0 | — | — | — | — | Butyl | 30.0 |
| electrode | | | | | | | | | | | | butyrate | |
| composition | PKc22 | LPS | [symbol] | 21.0 | M-2 | 0.7 | 1.0 | A-9 | 1.0 × 10 [symbol] | 2.0 | 2.0 × 10 [symbol] | Xylene | 30.0 |
| | PKc23 | LPS | [symbol] | 21.0 | M-2 | 0.7 | 1.0 | A-10 | 1.0 × 10 [symbol] | 2.0 | 2.0 × 10 [symbol] | Xylene | 30.0 |
| Negative | NKc21 | LPS | 23.4 | 45.0 | M-6 | [symbol] | 1.0 | — | — | — | — | Butyl | 48.0 |
| electrode | | | | | | | | | | | | butyrate | |
| composition | NKc22 | LPS | 23.4 | 45.0 | M-2 | [symbol] | 1.0 | A-9 | [symbol] | 2.0 | 2.0 × 10 [symbol] | Xylene | 48.0 |
| | NKc23 | LPS | [symbol] | 45.0 | M-2 | [symbol] | 1.0 | A-10 | [symbol] | 2.0 | 2.0 × 10 [symbol] | Xylene | [symbol] |

| | | Active material | | | Conductive auxiliary agent | | | | | |
|---|---|---|---|---|---|---|---|---|---|---|
| | | | Composition | Solid | | Composition | Solid | State | | |
| | No. | | content | content | | content | content | Binder (B) | Compound (A) | Note |
| Inorganic | Kc1 | — | — | — | — | — | — | Particulate | — | Comparative |
| sold | | | | | | | | | | Example |
| electrolyte- | Kc2 | — | — | — | — | — | — | Dissolved | Dissolved | Comparative |
| containing | | | | | | | | | | Example |
| composition | Kc3 | — | — | — | — | — | — | Dissolved | Dissolved | Comparative |
| | | | | | | | | | | Example |
| Positive | PKc21 | NMC | [symbol] | 75.0 | AB | 2.1 | [symbol] | Particulate | — | Comparative |
| electrode | | | | | | | | | | Example |
| composition | PKc22 | NMC | [symbol] | 75.0 | AB | 2.1 | [symbol] | Dissolved | Dissolved | Comparative |
| | | | | | | | | | | Example |
| | PKc23 | NMC | [symbol] | 75.0 | AB | 2.1 | [symbol] | Dissolved | Dissolved | Comparative |
| | | | | | | | | | | Example |
| Negative | NKc21 | Si | 26.0 | 50.0 | VGCF | 2.1 | 4.0 | Particulate | — | Comparative |
| electrode | | | | | | | | | | Example |
| composition | NKc22 | Si | 26.0 | 50.0 | VGCF | 2.1 | 4.0 | Dissolved | Dissolved | Comparative |
| | | | | | | | | | | Example |
| | NKc23 | Si | [symbol] | [symbol] | VGCF | 2.1 | 4.0 | Dissolved | Dissolved | Comparative |
| | | | | | | | | | | Example |

<Abbreviations in Table 1>
LPS: LPS synthesized in Synthesis Example A
NMC: LiNi_{1/3}Co_{1/3}Mn_{1/3}O₂
Si: Silicon (APS of 1 to 5 μm, manufactured by Alfa Aesar)
AB: Acetylene black
VGCF: Carbon nanotube [symbol]
indicates data missing or illegible when filed

Table 2 shows the combination of the polymer binder (B) and the compound (A) in each of the prepared compositions, and also shows the kind of the polymer binder (B), the terminal group for determining the difference between the residues, the mass average molecular weight, the kind of the functional group (a) of the compound (A), the residue, and the (number average) molecular weight, respectively. However, since the compound A-9 has no residue, the molecular formula is shown in the column of “Residue”. In Table 2, “Composition No.” indicates the No. of the extracted inorganic solid electrolyte-containing composition.

TABLE 2

| | Polymer binder (B) | | | | Compound (A) | | | |
|---|---|---|---|---|---|---|---|---|
| Composition | | | Terminal | Mass average | | | | Molecular |
| No. | | Kind | group | molecular weight | | Functional group (a) | Residue | weight |
| S-1 | M-2 | (Meth)acryl polymer | C₁₂H₂₅ | 400,000 | A-1 | Hydroxy group | C [symbol] H [symbol] | 186 |
| S-2 | M-2 | (Meth)acryl polymer | C₁₂H₂₅ | 400,000 | A-2 | Carboxy group | C [symbol] H [symbol] | 116 |
| S-3 | M-2 | (Meth)acryl polymer | C₁₂H₂₅ | 400,000 | A-3 | Sulfonic acid group | (CF [symbol] ) [symbol] CF [symbol] | 300 |
| S-4 | M-2 | (Meth)acryl polymer | C₁₂H₂₅ | 400,000 | A-4 | Phosphonic acid group | C [symbol] H [symbol] | 158 |
| S-5 | M-2 | (Meth)acryl polymer | C₁₂H₂₅ | 400,000 | A-5 | Thiol group | C [symbol] H [symbol] | 118 |
| S-6 | M-2 | (Meth)acryl polymer | C₁₂H₂₅ | 400,000 | A-6 | Thiol group | C [symbol] H [symbol] | 202 |
| S-7 | M-2 | (Meth)acryl polymer | C₁₂H₂₅ | 400,000 | A-6 | Thiol group | C [symbol] H [symbol] | 202 |
| S-S | M-2 | (Meth)acryl polymer | C₁₂H₂₅ | 400,000 | A-6 | Thiol group | C [symbol] H [symbol] | 202 |
| S-9 | M-2 | (Meth)acryl polymer | C₁₂H₂₅ | 400,000 | A-6 | Thiol group | C [symbol] H [symbol] | 202 |
| S-10 | M-2 | (Meth)acryl polymer | C₁₂H₂₅ | 400,000 | A-7 | Hydroxy group | Polysiloxane | 1600 |
| S-11 | M-1 | (Meth)acryl polymer | C₁₂H₂₅ | 300,000 | A-6 | Thiol group | C [symbol] H [symbol] | 202 |
| S-12 | M-3 | (Meth)acryl polymer | C₁₂H₂₅ | 200,000 | A-6 | Thiol group | C [symbol] H [symbol] | 202 |
| S-13 | M-4 | SEBS | C₁₂H₂₅ | 130,000 | A-6 | Thiol group | C [symbol] H [symbol] | 202 |
| S-14 | M-4 | SEBS | C₁₂H₂₅ | 130,000 | A-6 | Thiol group | C [symbol] H [symbol] | 202 |
| S-15 | M-5 | PVDF-HFP | C₂H₄OH | 230,000 | A-6 | Thiol group | C [symbol] H [symbol] | 202 |
| S-16 | M-6 | (Meth)acryl polymer | C₁₂H₂₅ | 300,000 | A-6 | Thiol group | C [symbol] H [symbol] | 202 |
| S-17 | M-2 | (Meth)acryl polymer | C₁₂H₂₅ | 400,000 | A-6 | Thiol group | C [symbol] H [symbol] | 202 |
| S-18 | M-2 | (Meth)acryl polymer | C₁₂H₂₅ | 400,000 | A-8 | Hydroxy group | C [symbol] H [symbol] | 174 |
| S-19 | M-7 | (Meth)acryl polymer | C₁₂H₂₅ | 400,000 | A-6 | Thiol group | C [symbol] H [symbol] | 202 |
| S-20 | M-8 | (Meth)acryl polymer | C₁₂H₂₅ | 300,000 | A-1 | Hydroxy group | C [symbol] H [symbol] | 186 |
| S-21 | M-2 | (Meth)acryl polymer | C₁₂H₂₅ | 400,000 | A-11 | Amino group | C [symbol] H [symbol] | 185 |
| Kc1 | M-6 | (Meth)acryl polymer | C₁₂H₂₅ | 300,000 | — | — | — | — |
| Kc2 | M-2 | (Meth)acryl polymer | C₁₂H₂₅ | 400,000 | A-9 | — | C [symbol] H [symbol] | 170 |
| Kc3 | M-2 | (Meth)acryl polymer | C₁₂H₂₅ | 400,000 | A-10 | Amide group | C [symbol] H [symbol] | 284 |

<Abbreviations in Table 2>
SEBS: styrene-ethylene-butylene-styrene block copolymer (hydrocarbon polymer)
PVDF-HFP: copolymer of polyvinylidene difluoride and hexafluoropropylene (fluoropolymer) [symbol]
indicates data missing or illegible when filed

Next, a sheet for an all-solid state secondary battery was produced as follows.

<Production of Solid Electrolyte Sheet for all-Solid State Secondary Battery>

Each of the inorganic solid electrolyte-containing compositions obtained above, which is shown in the column of “Solid electrolyte composition No.” of Table 3-1 or Table 3-4, was applied onto an aluminum foil (base material) having a thickness of 20 m using a Baker type applicator (product name: SA-201, manufactured by Tester Sangyo Co., Ltd.), and heated at 80° C. for 2 hours to dry the inorganic solid electrolyte-containing composition (removing the dispersion medium (D) without removing the compound (A)). Then, using a heat press machine, the inorganic solid electrolyte-containing composition which had been dried at a temperature of 120° C. and a pressure of 10 MPa for 10 seconds was heated and pressurized to produce each of solid electrolyte sheets 101 to 121, and c11 to c13 for an all-solid state secondary battery (in Table 3-1 and Table 3-4, it is described as “Solid electrolyte sheet”). The film thickness of the solid electrolyte layer was 50 μm.

<Production of Positive Electrode Sheet for all-Solid State Secondary Battery>

Each of the positive electrode compositions obtained above, which is shown in the column of “Electrode composition No.” of Table 3-2 or Table 3-4, was applied onto an aluminum foil (base material) having a thickness of 20 μm using a baker type applicator (product name: SA-201), heated at 80° C. for 1 hour, and further heated at 100° C. for 1 hour to dry the positive electrode composition (removing the dispersion medium (D) without removing the compound (A)). Then, using a heat press machine, the dried positive electrode composition was pressurized (10 MPa, 1 minute) at 25° C. to produce each of positive electrode sheets 201 to 221, and c21 to c23 for an all-solid state secondary battery, having a positive electrode active material layer having a film thickness of 100 μm (in Table 3-2 and Table 3-4, it is described as “Positive electrode sheet”).

<Production of Negative Electrode Sheet for all-Solid State Secondary Battery>

Each of the negative electrode compositions obtained above, which is shown in the column of “Electrode composition No.” of Table 3-3 or Table 3-4, was applied onto a copper foil (base material) having a thickness of 20 μm using a baker type applicator (product name: SA-201), heated at 80° C. for 1 hour, and further heated at 100° C. for 1 hour to dry the negative electrode composition (to remove the dispersion medium (D) without removing the compound (A)). Then, using a heat press machine, the dried negative electrode composition was pressurized (10 MPa, 1 minute) at 25° C. to produce each of negative electrode sheets 301 to 321, and c31 to c33 for an all-solid state secondary battery, having a negative electrode active material layer having a film thickness of 70 μm (in Table 3-3 and Table 3-4, it is described as “Negative electrode sheet”).

### <Evaluation 1: Dispersion Stability Test (Redispersibility)>

For each of the compositions prepared as described above, the LPS, the polymer binder (B), the compound (A), the dispersion medium (D), and further the active material (AC) and the conductive auxiliary agent were mixed in the same manner as the preparation conditions of each composition at the same proportion as the proportion of each content shown in Table 1, thereby preparing a composition (slurry) for evaluating dispersibility. Regarding each of the prepared compositions, the generation (the presence or absence) of aggregates of solid particles was checked using a grind meter (manufactured by ASAHISOUKEN CORPORATION). The size of the aggregate at this time was denoted as X (μm) and used as an indicator of the initial dispersibility.

On the other hand, each of the prepared compositions was left to stand at 25° C. for 24 hours and then mixed again at a temperature of 25° C. using a planetary ball mill P-7 (product name). The rotation speed and the time at the time of the remixing were set to the same conditions as the preparation conditions of each composition. Regarding the remixed composition, the generation (the presence or absence) of aggregates of solid particles was checked using the above-described grind meter. The size of the aggregate at this time was denoted as Y (μm) and used as an indicator of the redispersibility after storage.

It is noted that the size of the aggregate was set to a point at which remarkable spots appeared on the coating material applied to the grind meter (see JIS K-5600-2-5 6.6).

The ease of the generation of the aggregates (the aggregating property or the sedimentation property) was evaluated as the dispersion stability of the composition by determining which of the following evaluation standards the sizes X and Y of the aggregates belong to. In this test, it is indicated that the smaller the size X of the aggregate is, the more excellent the initial dispersibility is, and the smaller the size Y is, the more excellent the dispersion stability is.

In this test, an evaluation standard of “D” or higher is the pass level, and in a case where the size Y is 8 μm or less (the evaluation standard is “C” or higher), the size Y of the aggregate is also included in the evaluation. The results are shown in Tables 3-1 to Table 3-4 (collectively referred to as Table 3).

### —Evaluation Standards—

A: Y≤5 μm and X≤5 μm
B: 5 μm<Y≤8 μm, and 5 μm<X≤8 μm
C: 5 μm<Y≤8 μm, and 8 μm<X≤12 μm
D: 8 μm<Y≤10 μm
E: 10 μm<Y≤20 μm
F: 20 μm<Y

### <Evaluation 2: Handling Test>

In the same manner as in each of the prepared compositions, the same mixing ratio was used except for the dispersion medium, and the amount of the dispersion medium was reduced, whereby a slurry having a concentration of solid contents of 75% by mass was prepared. A 2 mL poly dropper (manufactured by atect Corporation) was disposed vertically so that 10 mm of the tip thereof was positioned below the slurry interface, and the slurry was aspirated at 25° C. for 10 seconds, and the mass W of the poly dropper containing the aspirated slurry was measured. In a case where the tare weight (the empty weight) of the poly dropper is denoted by W₀, it was determined that the slurry cannot be aspirated by the dropper in a case where the slurry mass W−W₀ is less than 0.1 g. In a case where the slurry could not be aspirated with a dropper, the upper limit of the concentration of solid contents at which the slurry can be aspirated with a dropper was estimated while gradually adding the dispersion medium. The handleability (the extent to which an appropriate viscosity suitable that forms a flat constitutional layer having a good surface property can be obtained) of each of the composition was evaluated by determining where the obtained upper limit of concentration of solid contents is included in any one of the following evaluation standards. 0.30 g of the prepared slurry was placed on an aluminum cup and heated at 120° C. for 2 hours to distill off the dispersion medium, and the concentration of solid contents was calculated.

In this test, it is indicated that the higher the upper limit of concentration of solid contents is, the better the handleability is, and the evaluation standard “D” or higher is the pass level. The results are shown in Table 3.

### —Evaluation Standards—

A: Upper limit of concentration of solid contents ≥70%
B: 70%>upper limit of concentration of solid contents ≥60%
C: 60%>upper limit of concentration of solid contents ≥50%
D: 50%>upper limit of concentration of solid contents ≥40%
E: 40%>upper limit of concentration of solid contents ≥30%
F: 30%>upper limit of concentration of solid contents

### <Evaluation 3: Adhesiveness Test>

Each of the adhesiveness of the solid particles and the adhesiveness between the solid electrolyte layer and the base material in the solid electrolyte layer of each of the obtained sheets, and the adhesiveness of the solid particles and the adhesiveness between the active material layer and the base material in the active material layer of each of the electrode sheet was evaluated.

The produced sheet was cut out into a rectangle having a width of 3 cm and a length of 14 cm. Using a cylindrical mandrel tester (product code: 056, mandrel diameter: 10 mm, manufactured by Allgood Co., Ltd.), one end part of the cut-out sheet test piece in the length direction was fixed to the tester and disposed so that the cylindrical mandrel touched to the central portion of the sheet test piece, and then the sheet test piece was bent by 180° along the peripheral surface of the mandrel (with the mandrel as an axis) while pulling the other end part of the sheet test piece in the length direction with a force of 5N along the length direction. It is noted that the sheet test piece was set so that the solid electrolyte layer or active material layer thereof was placed on a side opposite to the mandrel (the base material was placed on the side of the mandrel) and the width direction was parallel to the axis line of the mandrel. The test was carried out by gradually reducing the diameter of the mandrel from 32 mm.

In a state of being wound around the mandrel and a state of being restored to a sheet shape by releasing the winding, the minimum diameter at which the occurrence of defects (cracking, breakage, chipping, and the like) due to the disintegration of binding of solid particles in the solid electrolyte layer or the active material layer, and the peeling between the solid electrolyte layer and the base material or the peeling between the active material layer and the base material could not be confirmed was measured, and the evaluation was carried out by determining which evaluation standard below is satisfied by the minimum diameter. The results are shown in Table 3.

In this test, it is indicated that the smaller the minimum diameter is, the more firm the adhesive force of the solid electrolyte layer or the solid particles that constitute the active material layer is, and the stronger the binding force between the solid particles and the base material is, and an evaluation standard “F” or higher is the pass level.

### —Evaluation Standards—

A: Minimum diameter <5 mm
B: 5 mm≤minimum diameter <6 mm
C: 6 mm≤minimum diameter <8 mm
D: 8 mm≤minimum diameter <10 mm
E: 10 mm≤minimum diameter

### <Evaluation 4: Measurement of Content of Compound (A)>

The content of the compound (A) contained in the solid electrolyte layer or the active material layer of each of the obtained sheets was measured as follows, and the content in the solid electrolyte layer or the active material layer was calculated. In addition, from the obtained content, the content of the compound (A) with respect to the inorganic solid electrolyte (SE) and the content of the compound (A) with respect to the polymer binder (B) were calculated. The obtained results were substantially consistent with each content in the inorganic solid electrolyte-containing composition described in the column of “Content *** (ppm)”, the column of “Content * (ppm)”, and the column of “Content ** (mass %)” in Table 1.

### (Method of Measuring Content of Compound (A) in Solid Electrolyte Layer or Active Material Layer)

The mass of the solid electrolyte layer or the active material layer was precisely weighed (10 to 100 mg), immersed in 4 mL of xylene, and subjected to vibration for 1 hour with an ultrasonic cleaner, and the content of the compound (A) in the supernatant solution of the obtained eluent was quantified by gas chromatography.

TABLE 3-1

| | | | | | | | | |
|---|---|---|---|---|---|---|---|---|
| Sheet | Solid electrolyte | Binder | Compound | Dispersion | | | | |
| No. | composition No. | No. | (A) No. | stability | Handleability | Adhesiveness | Note 1 | Note 2 |

| | | | | | | | |
|---|---|---|---|---|---|---|---|
| 101 | S-1 | M-2 | A-1 | B | C | C | Example |
| 102 | S-2 | M-2 | A-2 | C | B | C | Example |
| 103 | S-3 | M-2 | A-3 | D | D | C | Example |
| 104 | S-4 | M-2 | A-4 | C | C | C | Example |
| 105 | S-5 | M-2 | A-5 | B | B | C | Example |
| 106 | S-6 | M-2 | A-6 | A | A | A | Example |
| 107 | S-7 | M-2 | A-6 | B | B | A | Example |
| 108 | 5-8 | M-2 | A-6 | A | A | A | Example |
| 109 | S-9 | M-2 | A-6 | B | B | B | Example |
| 110 | S-10 | M-2 | A- [symbol] | D | D | C | Example |
| 111 | S-11 | M-1 | A-6 | B | B | C | Example |
| 112 | S-12 | M-3 | A-6 | B | B | C | Example |
| 113 | S-13 | M-4 | A-6 | C | C | A | Example |
| 114 | S-14 | M-4 | A-6 | B | B | A | Example |
| 115 | S-15 | M-5 | A-6 | 3 | B | A | Example |
| 116 | S-16 | M-6 | A-6 | D | D | C | Example |
| 117 | S-17 | M-2 | A-6 | C | C | C | Example |
| 118 | S-18 | M-2 | A-8 | C | C | C | Example |
| 119 | S-19 | M-7 | A-6 | C | B | C | Example |
| 120 | S-20 | M-8 | A-1 | D | D | C | Example |
| 123 | S-21 | M-2 | A-11 | D | D | C | Example |

[symbol]

indicates data missing or illegible when filed

TABLE 3-2

| Sheet | Electrode | Binder | Composition | Dispersion | | | | |
|---|---|---|---|---|---|---|---|---|
| No. | composition No. | No. | (A) No. | stability | Handleability | Adhesiveness | Note 1 | Note 2 |
| 201 | PK-1 | M-2 | A-1 | B | C | C | Positive | Present invention |
| 202 | PK-2 | M-2 | A-2 | C | B | C | electrode | Present invention |
| 203 | PK-3 | M-2 | A-3 | D | D | C | sheet | Present invention |
| 204 | PK-4 | M-2 | A-4 | C | C | C | | Present invention |
| 205 | PK-5 | M-2 | A-5 | B | B | C | | Present invention |
| 206 | PK-6 | M-2 | A-6 | A | A | A | | Present invention |
| 207 | PK-7 | M-2 | A-6 | B | B | A | | Present invention |
| 208 | PK-8 | M-2 | A-6 | A | A | A | | Present invention |
| 209 | PK-9 | M-2 | A-6 | B | B | B | | Present invention |
| 210 | PK-10 | M-2 | A-7 | D | D | C | | Present invention |
| 211 | PK-11 | M-1 | A-6 | B | B | C | | Present invention |
| 212 | PK-12 | M-3 | A-6 | B | B | C | | Present invention |
| 213 | PK-13 | M-4 | A-6 | C | C | A | | Present invention |
| 214 | PK-14 | M-4 | A-6 | B | B | A | | Present invention |
| 215 | PK-15 | M-5 | A-6 | B | B | A | | Present invention |
| 216 | PK-16 | M-6 | A-6 | D | D | C | | Present invention |
| 217 | PK-17 | M-2 | A-6 | C | C | C | | Present invention |
| 218 | PK-18 | M-2 | A-8 | C | C | C | | Present invention |
| 219 | PK-19 | M-7 | A-6 | C | B | C | | Present invention |
| 220 | PK-20 | M-8 | A-1 | D | D | C | | Present invention |
| 221 | PK-21 | M-2 | A-11 | D | D | C | | Present invention |

TABLE 3-3

| Sheet | Electrode | Binder | Composition | Dispersion | | | | |
|---|---|---|---|---|---|---|---|---|
| No. | composition No. | No. | (A) No. | stability | Handleability | Adhesiveness | Note 1 | Note 2 |
| 301 | NK-1 | M-2 | A-1 | B | C | C | Negative | Present |
| | | | | | | | electrode | invention |
| 302 | NK-2 | M-2 | A-2 | C | B | C | sheet | Present |
| | | | | | | | | invention |
| 303 | NK-3 | M-2 | A-3 | D | D | C | | Present |
| | | | | | | | | invention |
| 304 | NK-4 | M-2 | A-4 | C | C | C | | Present |
| | | | | | | | | invention |
| 305 | NK-5 | M-2 | A-5 | B | B | C | | Present |
| | | | | | | | | invention |
| 306 | NK-6 | M-2 | A-6 | A | A | A | | Present |
| | | | | | | | | invention |
| 307 | NK-7 | M-2 | A-6 | B | B | A | | Present |
| | | | | | | | | invention |
| 308 | NK-8 | M-2 | A-6 | A | 4 | A | | Present |
| | | | | | | | | invention |
| 309 | NK-9 | M-2 | A-6 | B | B | B | | Present |
| | | | | | | | | invention |
| 310 | NK-10 | M-2 | A-7 | D | D | C | | Present |
| | | | | | | | | invention |
| 311 | NI-11 | M-1 | A-6 | B | B | C | | Present |
| | | | | | | | | invention |
| 312 | NK-12 | M-3 | A-6 | B | B | C | | Present |
| | | | | | | | | invention |
| 313 | NK-13 | M-4 | A-6 | C | C | A | | Present |
| | | | | | | | | invention |
| 314 | NK-14 | M-4 | A-6 | B | B | A | | Present |
| | | | | | | | | invention |
| 315 | NK-15 | M-5 | A-6 | B | B | A | | Present |
| | | | | | | | | invention |
| 316 | NK-16 | M-6 | A-6 | D | D | C | | Present |
| | | | | | | | | invention |
| 317 | NK-17 | M-2 | A-6 | C | C | C | | Present |
| | | | | | | | | invention |
| 318 | NK-18 | M-2 | A-8 | C | C | C | | Present |
| | | | | | | | | invention |
| 319 | NK-19 | M-7 | A-6 | C | B | C | | Present |
| | | | | | | | | invention |
| 320 | NK-20 | M-8 | A-1 | D | D | C | | Present |
| | | | | | | | | invention |
| 321 | NK-21 | M-2 | A-11 | D | D | C | | Present |
| | | | | | | | | invention |

TABLE 3-4

| | Electrode | | Composition | Dispersion | | | | | |
|---|---|---|---|---|---|---|---|---|---|
| Sheet No. | composition No. | Binder No. | (A) No. | stability | Handleability | Adhesiveness | Note 1 | Note 2 | Sheet No. |
| C11 | Kc11 | — | M-6 | — | F | F | E | Solid | Comparative |
| C12 | Kc12 | — | M-2 | A-9 | E | E | D | electrolyte | Comparative |
| C13 | Kc13 | — | M-2 | A-10 | E | E | D | sheet | Comparative |
| C21 | — | PKc21 | M-6 | — | F | F | E | Positive | Comparative |
| C22 | — | PKc22 | M-2 | A-9 | E | E | D | electrode | Comparative |
| C23 | — | PKc23 | M-2 | A-10 | E | E | D | sheet | Comparative |
| C31 | — | NKc21 | M-6 | — | F | F | E | Negative | Comparative |
| C32 | — | NKc22 | M-2 | A-9 | E | E | D | electrode | Comparative |
| C33 | — | NKc23 | M-2 | A-10 | E | E | D | sheet | Comparative |

<Manufacturing of all-Solid State Secondary Battery>

First, each of a positive electrode sheet for an all-solid state secondary battery, including a solid electrolyte layer, and a negative electrode sheet for an all-solid state secondary battery, including a solid electrolyte layer, which would be used for manufacturing an all-solid state secondary battery, was produced.

—Production of Positive Electrode Sheet for all-Solid State Secondary Battery, which Includes Solid Electrolyte Layer—

The solid electrolyte sheet shown in the column of “Solid electrolyte layer (sheet No.)” of Table 4-1, prepared as described above, was overlaid on the positive electrode active material layer of each of the positive electrode sheets for an all-solid state secondary battery shown in the column of “Electrode active material layer (sheet No.)” of Table 4-1 so that it came into contact with the positive electrode active material layer, transferred (laminated) by being pressurized at 50 MPa and 25° C. using a press machine, and then pressurized at 600 MPa and at 25° C., whereby each of positive electrode sheet Nos. 201 to 221, and c21 to c23 for an all-solid state secondary battery having a thickness of 25 μm (thickness of positive electrode active material layer: 50 μm) was produced.

—Production of Negative Electrode Sheet for all-Solid State Secondary Battery, which Includes Solid Electrolyte Layer—

Next, the solid electrolyte sheet shown in the column of “Solid electrolyte layer (sheet No.)” of Table 4-2, prepared as described above, was overlaid on the negative electrode active material layer of each of the negative electrode sheets for an all-solid state secondary battery shown in the column of “Electrode active material layer (sheet No.)” of Table 4-2 so that it came into contact with the negative electrode active material layer, transferred (laminated) by being pressurized at 50 MPa and 25° C. using a press machine, and then pressurized at 600 MPa and at 25° C., whereby each of negative electrode sheets 301 to 321, and c31 to c33 for an all-solid state secondary battery having a thickness of 25 μm (thickness of negative electrode active material layer: 40 μm) was produced.

An all-solid state secondary battery No. 101 having a layer configuration illustrated in FIG. 1 was manufactured as follows.

The positive electrode sheet No. 201 for an all-solid state secondary battery (the aluminum foil of the solid electrolyte-containing sheet had been peeled off), which included the solid electrolyte layer obtained as described above, was cut out into a disk shape having a diameter of 14.5 mm and placed, as illustrated in FIG. 2, in a stainless 2032-type coin case 11 into which a spacer and a washer (not illustrated in FIG. 2) had been incorporated. Next, a lithium foil cut out in a disk shape having a diameter of 15 mm was overlaid on the solid electrolyte layer. After further overlaying a stainless steel foil thereon, the 2032-type coin case 11 was crimped to manufacture an all-solid state secondary battery 13 (No. 101), illustrated in FIG. 2.

The all-solid state secondary battery manufactured in this way has a layer configuration shown in FIG. 1 (corresponding to the laminate 12 for an all-solid state secondary battery; however, the lithium foil corresponds to the negative electrode active material layer 2 and the negative electrode collector 1).

Each of all-solid state secondary batteries Nos. 102 to 121 and c101 to c103 was manufactured in the same manner as in the manufacturing of the all-solid state secondary battery No. 101, except that in the manufacturing of the all-solid state secondary battery No. 101, a positive electrode sheet for an all-solid state secondary battery, which includes a solid electrolyte layer and is indicated by No. shown in the column of “Electrode active material layer (sheet No.)” of Table 4-1, was used instead of the positive electrode sheet No. 201 for an all-solid state secondary battery, which has a solid electrolyte layer.

An all-solid state secondary battery No. 201 having a layer configuration illustrated in FIG. 1 was manufactured as follows.

The negative electrode sheet No. 301 for an all-solid state secondary battery (the aluminum foil of the solid electrolyte-containing sheet had been peeled off), which included the solid electrolyte obtained as described above, was cut out into a disk shape having a diameter of 14.5 mm and placed, as illustrated in FIG. 2, in a stainless 2032-type coin case 11 into which a spacer and a washer (not illustrated in FIG. 2) had been incorporated. Next, a positive electrode sheet (a positive electrode active material layer) punched out from the positive electrode sheet for an all-solid state secondary battery produced below into a disk shape having a diameter of 14.0 mm was overlaid on the solid electrolyte layer. A stainless steel foil (a positive electrode collector) was further layered thereon to form a laminate 12 for an all-solid state secondary battery (a laminate consisting of stainless steel foil—aluminum foil—positive electrode active material layer—solid electrolyte layer—negative electrode active material layer—copper foil). Then, the 2032-type coin case 11 was crimped to manufacture an all-solid state secondary battery No. 201 illustrated in FIG. 2.

A positive electrode sheet for an all-solid state secondary battery to be used in the manufacturing of the all-solid state secondary battery No. 201 was prepared as follows.

### —Preparation of Positive Electrode Composition—

180 beads of zirconia beads having a diameter of 5 mm were put into a 45 mL container made of zirconia (manufactured by FRITSCH), 2.7 g of the LPS synthesized in the above-described Synthesis Example A, and 0.3 g of KYNAR FLEX 2500-20 (product name, PVDF-HFP: polyvinylidene fluoride—hexafluoropropylene copolymer, manufactured by Arkema S.A.) in terms of solid content mass and 22 g of butyl butyrate were put into the above container. The container was set in a planetary ball mill P-7 (product name, manufactured by FRITSCH) and the components were stirred for 60 minutes at 25° C. and a rotation speed of 300 rpm. Then, 7.0 g of LiNi_{1/3}Co_{1/3}Mn_{1/3}O₂ (NMC) was put into the container as the positive electrode active material, and similarly, the container was set in a planetary ball mill P-7, mixing was continued at 25° C. and a rotation speed of 100 rpm for 5 minutes to prepare a positive electrode composition.

—Preparation of Positive Electrode Sheet for all-Solid State Secondary Battery—

The positive electrode composition obtained as described above was applied onto an aluminum foil (a positive electrode collector) having a thickness of 20 μm with a Baker type applicator (product name: SA-201, manufactured by Tester Sangyo Co., Ltd.), heating was carried out at 100° C. for 2 hours to dry (to remove the dispersion medium) the positive electrode composition. Then, using a heat press machine, the dried positive electrode composition was pressurized (10 MPa, 1 minute) at 25° C. to produce each of positive electrode sheets for an all-solid state secondary battery, having a positive electrode active material layer having a film thickness of 80 μm.

Each of all-solid state secondary batteries Nos. 202 to 221 and c201 to c203 was manufactured in the same manner as in the manufacturing of the all-solid state secondary battery No. 201, except that in the manufacturing of the all-solid state secondary battery No. 201, a negative electrode sheet for an all-solid state secondary battery, which includes a solid electrolyte layer and is indicated by No. shown in the column of “Electrode active material layer (sheet No.)” of Table 4-2, was used instead of the positive electrode sheet No. 301 for an all-solid state secondary battery, which has a solid electrolyte layer.

### <Evaluation 5: Measurement of Resistance>

The ion conductivity of each of the manufactured all-solid state secondary batteries was measured to evaluate the resistance. Specifically, the alternating-current impedance of each of the all-solid state secondary batteries was measured in a constant-temperature tank (25° C.) using a 1255B FREQUENCY RESPONSE ANALYZER (product name, manufactured by SOLARTRON Analytical) at a voltage magnitude of 5 mV and a frequency of 1 MHz to 1 Hz. From the measurement result, the resistance of the sample for measuring ion conductivity in the layer thickness direction was determined, and the ion conductivity was determined by the calculation according to Expression (C1). The results are shown in Table 4-1 and Table 4-2 (collectively referred to as Table 4).

$$Ion conductivity σ ( mS / cm ) = 1 , 000 \times sample layer thickness ( cm ) / [ resistance ( Ω ) \times sample area ( {cm}^{2} ) ] \qquad Expression ( C1 )$$

In Expression (C1), the thickness of the sample layer is a value obtained by measuring the thickness of the sample layer before the laminate 12 for an all-solid state secondary battery is put into the 2032-type coin case 11 and by subtracting the thickness of the current collector (the total thickness of the solid electrolyte layer and the electrode active material layer). The sample area is the area of the disk-shaped sheet having a diameter of 14.5 mm.

It was determined where the obtained ion conductivity a was included in any of the following evaluation standards.

In this test, in a case where the evaluation standard is “D” or higher, the ion conductivity a is the pass level. It is noted that a large ion conductivity a means a small resistance, which is evident from Expression (C1).

### —Evaluation Standards—

A: 0.30≤σ
B: 0.25≤σ<0.30
C: 0.20≤σ<0.25
D: 0.15≤σ<0.20
E: σ<0.15

### <Evaluation 6: Cycle Characteristics>

The discharge capacity retention rate of each of the manufactured all-solid state secondary batteries was measured using a charging and discharging evaluation device TOSCAT-3000 (product name, manufactured by Toyo System Corporation).

Specifically, each of the all-solid state secondary batteries was charged in an environment of 25° C. at a current density of 0.1 mA/cm² until the battery voltage reached 4.3 V. Then, the battery was discharged at a current density of 0.1 mA/cm² until the battery voltage reached 2.5 V. One charging operation and one discharging operation were set as one cycle of charging and discharging, and 3 cycles of charging and discharging were repeated under the same conditions to carry out initialization. Then, the above-described charging and discharging cycle was repeated, and the discharge capacity of each of the all-solid state secondary batteries was measured at each time after the charging and discharging cycle was carried out with a charging and discharging evaluation device: TOSCAT-3000 (product name).

In a case where the discharge capacity (the initial discharge capacity) of the first charging and discharging cycle after initialization is set to 100%, the battery characteristics (cycle characteristics) were evaluated by determining whether the number of charging and discharging cycles in a case where the discharge capacity retention rate (the discharge capacity with respect to the initial discharge capacity) reaches 80% was included in any of the following evaluation standards. In this test, the higher the evaluation standard is, the better the battery characteristics (cycle characteristics) are, and the initial battery characteristics can be maintained even in a case where a plurality of times of charging and discharging are repeated (even in a case of the long-term use). Regarding the cycle characteristics in this test, an evaluation standard “C” or higher is the pass level. The results are shown in Table 4.

All of the all-solid state secondary batteries Nos. 101 to 121 and 201 to 221 exhibited initial discharge capacity values sufficient for functioning as an all-solid state secondary battery.

### —Evaluation Standards—

A: 600 cycles or more
B: 450 cycles or more and less than 600 cycles
C: 300 cycles or more and less than 450 cycles
D: 150 cycles or more and less than 300 cycles
E: Less than 150 cycles

### <Evaluation 7: Measurement of Content of Compound (A)>

The content of the compound (A) contained in the solid electrolyte layer or the active material layer in the all-solid state secondary battery was measured in the same manner as in <Evaluation 4> described above using the solid electrolyte layer or the active material layer peeled off or scraped off from the all-solid state secondary battery, and the content in the solid electrolyte layer or the active material layer was calculated. In addition, from the obtained content, the content of the compound (A) with respect to the inorganic solid electrolyte (SE) and the content of the compound (A) with respect to the polymer binder (B) were calculated. The obtained results were substantially consistent with each content in the inorganic solid electrolyte-containing composition described in the column of “Content *** (ppm)”, the column of “Content*(ppm)”, and the column of “Content ** (% by mass)” in Table 1.

TABLE 4-1

| | Layer configuration | | | | |
|---|---|---|---|---|---|
| | Electrode | Solid | | | |
| | active | elec- | | | |
| | material | trolyte | | Cycle | |
| | layer | layer | Re- | char- | |
| Battery | (Sheet | (Sheet | sist- | acter- | |
| No. | No.) | No.) | ance | istics | Note |
| 101 | 201 | 101 | C | C | Present invention |
| 102 | 202 | 102 | C | C | Present invention |
| 103 | 203 | 103 | C | C | Present invention |
| 104 | 204 | 104 | C | C | Present invention |
| 105 | 205 | 105 | B | C | Present invention |
| 106 | 206 | 106 | A | A | Present invention |
| 107 | 207 | 107 | A | A | Present invention |
| 108 | 208 | 108 | A | B | Present invention |
| 109 | 209 | 109 | B | B | Present invention |
| 110 | 210 | 110 | D | C | Present invention |
| 111 | 211 | 111 | B | C | Present invention |
| 112 | 212 | 112 | B | C | Present invention |
| 113 | 213 | 113 | B | C | Present invention |
| 114 | 214 | 114 | C | C | Present invention |
| 115 | 215 | 115 | B | C | Present invention |
| 116 | 216 | 116 | C | C | Present invention |
| 117 | 217 | 117 | C | C | Present invention |
| 118 | 218 | 118 | C | C | Present invention |
| 119 | 219 | 119 | C | C | Present invention |
| 120 | 220 | 120 | C | C | Present invention |
| 121 | 221 | 121 | C | C | Present invention |
| c101 | c21 | c11 | E | E | Comparative Example |
| c102 | c22 | c12 | D | D | Present invention |
| c103 | c23 | c13 | D | D | Present invention |

| | Layer configuration | | | | |
|---|---|---|---|---|---|
| | Electrode | | | | |
| | active | Solid | | | |
| | material | electrolyte | | Cycle | |
| | layer | layer | Re- | char- | |
| Battery | (Sheet | (Sheet | sist- | acter- | |
| No. | No.) | No.) | ance | istics | Note |
| 201 | 301 | 101 | C | C | Present invention |
| 202 | 302 | 102 | C | C | Present invention |
| 203 | 303 | 103 | C | C | Present invention |
| 204 | 304 | 104 | C | C | Present invention |
| 205 | 305 | 105 | B | C | Present invention |
| 206 | 306 | 106 | A | A | Present invention |
| 207 | 307 | 107 | A | A | Present invention |
| 208 | 308 | 108 | A | B | Present invention |
| 209 | 309 | 109 | B | B | Present invention |
| 210 | 310 | 110 | D | C | Present invention |
| 211 | 311 | 111 | B | C | Present invention |
| 212 | 312 | 112 | B | C | Present invention |
| 213 | 313 | 113 | B | C | Present invention |
| 214 | 314 | 114 | C | C | Present invention |
| 215 | 315 | 115 | B | C | Present invention |
| 216 | 316 | 116 | C | C | Present invention |
| 217 | 317 | 117 | C | C | Present invention |
| 218 | 318 | 118 | C | C | Present invention |
| 210 | 319 | 119 | C | C | Present invention |
| 220 | 320 | 120 | C | C | Present invention |
| 221 | 321 | 121 | C | C | Present invention |
| c201 | c33 | c11 | E | E | Comparative Example |
| c202 | c32 | c12 | D | D | Comparative Example |
| c203 | c33 | c13 | D | D | Comparative Example |

The following findings can be seen from the results of Table 3 and Table 4.

The inorganic solid electrolyte-containing compositions (electrode compositions) of Comparative Examples, which do not contain the compound (A) defined in the present invention with respect to the inorganic solid electrolyte and the polymer binder, are inferior in dispersion characteristics (storage stability and handleability) and adhesiveness. As a result, it can be seen that the all-solid state secondary batteries of Comparative Examples, which include the inorganic solid electrolyte layer or the active material layer formed of this composition, are at least inferior in cycle characteristics, and it is not possible to achieve both the suppression of the increase in resistance and the improvement of the cycle characteristics.

On the other hand, in the inorganic solid electrolyte-containing composition (electrode composition) in which the compound (A) defined in the present invention is used in combination with the inorganic solid electrolyte (SE) and the polymer binder (B) in the dispersion medium (D), the dispersion characteristics are excellent, and the adhesiveness of the solid particles can be enhanced. The all-solid state secondary battery according to the embodiment of the present invention, which includes the inorganic solid electrolyte layer or the active material layer formed of these compositions, exhibits high ion conductivity (low resistance) and can also realize excellent cycle characteristics. In particular, it can be seen that in each of the compositions (S-1, S-6 to S-9, S-13, S-14, S-16, S-17, S-20, and S-21) shown in the column of “Composition No.” in Table 2, in which the compound (A) having a chemical structure that matches the residue (in the column of “Residue” in Table 2) is used in combination with the terminal group (in the column of “Terminal group” in Table 2) that is bonded to the hetero linking group of the polymer that constitutes the polymer binder (B), the dispersion characteristics, the resistance, and the cycle characteristics can be achieved at a high level.

The present invention has been described with the embodiments thereof, any details of the description of the present invention are not limited unless described otherwise, and it is obvious that the present invention is widely construed without departing from the gist and scope of the present invention described in the accompanying claims.

### EXPLANATION OF REFERENCES

1: negative electrode collector
2: negative electrode active material layer
3: solid electrolyte layer
4: positive electrode active material layer
5: positive electrode collector
6: operation portion
10: all-solid state secondary battery
11: 2032-type coin case
12: laminate for all-solid state secondary battery
13: coin-type all-solid state secondary battery

What is claimed is:

1. An inorganic solid electrolyte-containing composition comprising:
an inorganic solid electrolyte (SE) having an ion conductivity of a metal belonging to Group 1 or Group 2 in a periodic table;
a polymer binder (B);
a compound (A); and
a dispersion medium (D),
wherein the inorganic solid electrolyte-containing composition satisfies Conditions (1) to (4),
Condition (1): a mass average molecular weight of a polymer constituting the polymer binder (B) is 2,000 or more,
Condition (2): the compound (A) has at least one functional group selected from the following Group (a) of functional groups,
Condition (3): a molecular weight of the compound (A) is less than 2,000, and
Condition (4): the compound (A) is dissolved in the dispersion medium (D),
[Group (a) of functional groups] hydroxy group, amino group, carboxy group, sulfonic acid group, phosphoric acid group, phosphonic acid group, cyano group, thiol group, and sulfinyl group.

2. The inorganic solid electrolyte-containing composition according to claim 1,
wherein a content of the compound (A) is 10 ppm or more and 2.0×10³ ppm or less with respect to 100% by mass of a solid content of the inorganic solid electrolyte-containing composition.

3. The inorganic solid electrolyte-containing composition according to claim 1,
wherein the polymer binder (B) is dissolved in the dispersion medium (D).

4. The inorganic solid electrolyte-containing composition according to claim 1,
wherein a molecular weight of the compound (A) is less than 600.

5. The inorganic solid electrolyte-containing composition according to claim 1,
wherein the compound (A) satisfies Condition (5),
Condition (5): a residue obtained by removing the functional group from the compound (A) has the same chemical structure as a terminal group bonded to a hetero linking group in the polymer constituting the polymer binder (B).

6. The inorganic solid electrolyte-containing composition according to claim 2,
wherein the polymer binder (B) is dissolved in the dispersion medium (D),
the molecular weight of the compound (A) is less than 600, and
the compound (A) satisfies Condition (5),
Condition (5): a residue obtained by removing the functional group from the compound (A) has the same chemical structure as a terminal group bonded to a hetero linking group of the polymer constituting the polymer binder (B).

7. The inorganic solid electrolyte-containing composition according to claim 1,
wherein the polymer binder (B) is a (meth)acrylic polymer.

8. The inorganic solid electrolyte-containing composition according to claim 1, further comprising:
an active material (AC).

9. A sheet for an all-solid state secondary battery, comprising:
a layer formed of the inorganic solid electrolyte-containing composition according to claim 1.

10. An all-solid state secondary battery comprising, in the following order:
a positive electrode active material layer;
a solid electrolyte layer; and
a negative electrode active material layer,
wherein at least one of the positive electrode active material layer, the solid electrolyte layer, or the negative electrode active material layer is a layer formed of the inorganic solid electrolyte-containing composition according to claim 1.

11. A manufacturing method for a sheet for an all-solid state secondary battery, the manufacturing method comprising:
forming a film of the inorganic solid electrolyte-containing composition according to claim 1.

12. A manufacturing method for an all-solid state secondary battery, the manufacturing method comprising:
manufacturing an all-solid state secondary battery through the manufacturing method according to claim 11.
